(19) United States
(12) Patent Application Publication
(10) Pub. No.: US 2013/0189516 A1
(43) Pub. Date: Jul. 25, 2013

(54) FLAME-RETARDANT POLYMER MEMBER WITH ENVIRONMENTAL RESISTANCE AND FLAME-RETARDANT POLYMER MEMBER WITH HYGIENIC PROPERTY

(71) Applicants: Yusuke Sugino, Ibaraki-shi (JP); Kunio Nagasaki, Ibaraki-shi (JP); Kohei Doi, Ibaraki-shi (JP); Takafumi Hida, Ibaraki-shi (JP)

(72) Inventors: Yusuke Sugino, Ibaraki-shi (JP); Kunio Nagasaki, Ibaraki-shi (JP); Kohei Doi, Ibaraki-shi (JP); Takafumi Hida, Ibaraki-shi (JP)

(73) Assignee: NITTO DENKO CORPORATION, Osaka (JP)

(21) Appl. No.: 13/877,600

(22) PCT Filed: Jun. 17, 2011
(86) PCT No.: PCT/JP2011/063876

§ 371 Date: Apr. 3, 2013

(30) Foreign Application Priority Data
Oct. 12, 2010 (JP) 2010-229540
Nov. 17, 2010 (JP) 2010-256678
Nov. 26, 2010 (JP) 2010-263781
Nov. 26, 2010 (JP) 2010-263782
Jan. 11, 2011 (JP) 2011-002851
Jan. 11, 2011 (JP) 2011-002852
Jan. 11, 2011 (JP) 2011-002853
Jan. 11, 2011 (JP) 2011-002854
Jan. 28, 2011 (JP) 2011-015865
Jan. 28, 2011 (JP) 2011-015866
Jan. 28, 2011 (JP) 2011-016073

(51) Int. Cl. B32B 27/18; B32B 27/08

(52) U.S. Cl. CPC B32B 27/18; B32B 27/08
USPC 428/339; 428/688

(57) ABSTRACT

The present invention aims to provide a flame-retardant member having environment-resistant functionality or hygienic functionality, flexibility, and a high degree of flame retardancy. An environment-resistant functional flame-retardant polymer member of the present invention is an environment-resistant functional flame-retardant polymer member including a polymer layer (B), a flame-retardant layer (A), and an environment-resistant functional layer (L) in the stated order, in which the flame-retardant layer (A) is a layer containing a layered inorganic compound (f) in a polymer. A hygienic functional flame-retardant polymer member of the present invention is a hygienic functional flame-retardant polymer member including a polymer layer (B), a flame-retardant layer (A), and a hygienic functional layer (L) in the stated order, in which the flame-retardant layer (A) is a layer containing a layered inorganic compound (f) in a polymer.

### TECHNICAL FIELD

The present invention relates to an environment-resistant functional flame-retardant polymer member and a hygienic functional flame-retardant polymer member. The environment-resistant functional flame-retardant polymer member of the present invention is excellent in environment-resistant functionality, transparency, and flexibility, and can impart environment-resistant functionality to various adherends and make the various adherends flame-retardant by being attached to the various adherends. In addition, the hygienic functional flame-retardant polymer member of the present invention is excellent in hygienic functionality, transparency, and flexibility, and can impart hygienic functionality to various adherends and make the various adherends flame-retardant by being attached to the various adherends.

### BACKGROUND ART

Criteria for combustibility are classified into five stages, i.e., noncombustible, extremely flame-retardant, flame-retardant, slow-burning, and combustible in order of decreasing difficulty in combustion. In a printed matter to be attached to a buildingmaterial such as an interior material, exterior material, or decorative laminate for a building or housing, or to an interior material or glass portion in a carrier such as a railway vehicle, a ship, or an aircraft, flame retardancy that can be adopted is specified for each of its applications.

A printed matter to be attached to a wall surface in an ordinary shop or the like, a wall surface in a railway vehicle, or a glass portion inside or outside the railway vehicle is as described below. A pattern to be displayed is printed on one surface of a base material sheet such as paper or a film, a pressure-sensitive adhesive layer is provided on the other surface thereof, and the printed matter is attached through the pressure-sensitive adhesive layer. However, such printed matter is combustible and hence most of the printed matter burns out when its combustion is left.

Accordingly, a possible approach to imparting flame retardancy to the base material sheet is to use a flame-retardant resin sheet as the base material sheet. A halogen-based resin such as a fluorine-based resin or a vinyl chloride resin has been conventionally used as such flame-retardant resin sheet (Patent Literature 1). However, the use of a halogen-based flame-retardant sheet has started to be regulated because of such problems of a halogen-containing substance as described below. The substance produces a toxic gas or produces dioxin when burnt. Accordingly, in recent years, the following method has been widely known for imparting flame retardancy to the resin material of a resin sheet (Patent Literature 2). A non-halogen-based flame retardant such as a phosphate or a metal hydrate is added to the resin. In this case, however, a large amount of the flame retardant must be added, with the result that a problem in that the transparency of the resin sheet reduces or a problem such as a defect in the external appearance of the resin sheet is induced.

To laminate, from above the printed matter on which the pattern has been printed, the flame-retardant resin sheet through the pressure-sensitive adhesive layer is also conceivable. In this case, however, a problem in that the clarity of the pattern on the printed matter reduces arises because the resin sheet is laminated on the printed matter through the pressure-sensitive adhesive layer, though flame retardancy is obtained as in the foregoing.

In addition, a material for the flame-retardant resin sheet is a resin. Accordingly, the sheet shows some degree of flame retardancy but does not have such flame retardancy as to be capable of blocking a flame, and hence its flame retardancy when the sheet is in direct contact with the flame is not sufficient.

Further, in recent years, the flame-retardant sheet has been required to have performance such as environment-resistant functionality or hygienic functionality.

When the flame-retardant sheet is used for, for example, a building member such as glass or an outer wall or inner wall of a building, a side mirror of an automobile or an automobile coating, a sound-proof wall for an expressway, an antibacterial tile, or an air cleaner, the sheet is required to have performance such as antifouling property, dust-proof property, cleaning property, antibacterial property, or organic matter degradability.

In addition, depending on a place where the flame-retardant sheet is used, the sheet may be exposed to such a situation that its surface is liable to have a stain. When the surface of the flame-retardant sheet has a stain, there arises a problem in that its quality in external appearance is impaired, for example. As a result, it becomes difficult to apply the sheet to an application requiring a satisfactory external appearance.

In addition, the conventional flame-retardant sheet does not have moisture-conditioning property or is not sufficient in moisture-conditioning property in some cases. In those cases, for example, there arises a problem in that when the sheet is used for an inner wall surface of a housing or the like, dew condensation occurs.

In addition, the conventional flame-retardant sheet does not have moisture-preventing property or is not sufficient in moisture-preventing property in some cases. In those cases, for example, there arises a problem in that when the sheet is used for an inner wall surface of a housing or the like, dew condensation occurs.

In addition, the conventional flame-retardant sheet does not have water resistance or is not sufficient in water resistance in some cases. In those cases, there arises a problem in that its surface deteriorates when exposed to moisture.

In addition, the conventional flame-retardant sheet does not have water repellency or is not sufficient in water repellency in some cases. In those cases, for example, there arises a problem in that when its surface is stainedwith a contaminant, the contaminant cannot be easily removed with water.

In addition, the conventional flame-retardant sheet does not have hydrophilicity or is not sufficient in hydrophilicity in some cases. In those cases, for example, there arises a problem in that when its surface is stained with a contaminant, the contaminant cannot be easily removed with water.

In addition, the conventional flame-retardant sheet does not have oil repellency or is not sufficient in oil repellency in some cases. In those cases, for example, there arises a problem in that when its surface is stained with an oily contaminant, the oily contaminant cannot be easily removed.

In addition, depending on a place where the flame-retardant sheet is used, various bacteria may grow on its surface. In such situation, when antibacterial property can be imparted to the flame-retardant sheet, the growth of the various bacteria can be effectively suppressed even in the case of using the sheet under such an environment that these bacteria easily grow.

In addition, depending on a place where the flame-retardant sheet is used, various fungi may grow on its surface. In such situation, when antifungal property can be imparted to the flame-retardant sheet, the growth of the various fungi: can be effectively suppressed even in the case of using the sheet under such an environment that these fungi easily grow.

In addition, when deodorant property can be imparted to the flame-retardant sheet, the sheet can make various adherends flame-retardant, and at the same time, can reduce an odor in the vicinity of the adherends, by being flexibly attached to the adherends.

### CITATION LIST

### Patent Literature

[PTL 1] Japanese Patent Application Laid-open No. 2005-015620
[PTL 2] Japanese Patent Application Laid-open No. 2001-040172

### SUMMARY OF INVENTION

### Technical Problem

An object of the present invention is to provide a flame-retardant member having environment-resistant functionality or hygienic functionality, flexibility, and a high degree of flame retardancy.

### Solution to Problem

The inventors of the present invention have made extensive studies to solve the problems, and as a result, have found that the problems can be solved with the following flame-retardant polymer member. Thus, the inventors have completed the present invention.

An environment-resistant functional flame-retardant polymer member of the present invention is an environment-resistant functional flame-retardant polymer member, including a polymer layer (B), a flame-retardant layer (A), and an environment-resistant functional layer (L) in the stated order, in which the flame-retardant layer (A) is a layer containing a layered inorganic compound (f) in a polymer.

In a preferred embodiment, the environment-resistant functional layer (L) has a thickness of 0.1 to 100 μm.

In a preferred embodiment, in a horizontal firing test involving horizontally placing the environment-resistant functional flame-retardant polymer member of the present invention with its side of the environment-resistant functional layer (L) as a lower surface so that the lower surface is in contact with air, placing a Bunsen burner so that a flame port of the Bunsen burner is positioned at a lower portion distant from the lower surface on the side of the environment-resistant functional layer (L) by 45 mm, and bringing a flame of the Bunsen burner having a height of 55 mm from the flame port into contact with the lower surface of the environment-resistant functional layer (L) for 30 seconds while preventing the flame from being in contact with an end portion of the flame-retardant polymer member, the flame-retardant polymer member has flame retardancy capable of blocking the flame.

In a preferred embodiment, the environment-resistant functional layer (L) is a photocatalyst layer (L).

In a preferred embodiment, the photocatalyst layer (L) contains photocatalyst particles.

In a preferred embodiment, the photocatalyst particles have an average particle diameter of 0.005 to 0.1 μm.

In a preferred embodiment, the photocatalyst particles are each titanium oxide.

In a preferred embodiment, the environment-resistant functional layer (L) is an antifouling layer (L).

In a preferred embodiment, the antifouling layer (L) is a layer containing at least one kind selected from a fluorine-based resin and a silicone-based resin.

In a preferred embodiment, the environment-resistant functional layer (L) is a moisture-bonditioning layer (L).

In a preferred embodiment, the moisture-conditioning layer (L) contains a porous substance.

In a preferred embodiment, the porous substance is at least one kind selected from silica, alumina, magnesia, titania, zirconia, a silica-alumina composite oxide, zeolite, and activated carbon.

In a preferred embodiment, the environment-resistant functional layer (L) is a moisture-preventing layer (L).

In a preferred embodiment, the moisture-preventing layer (L) contains at least one kind selected from a polyvinylidene chloride-based resin and a polyolefin-based resin.

In a preferred embodiment, the environment-resistant functional layer (L) is a water-resistant layer (L).

In a preferred embodiment, the water-resistant layer (L) contains a water-resistant resin.

In a preferred embodiment, the water-repellent resin is at least one kind selected froman epoxy-based resin, a phenol-based resin, a silicone-based resin, and a fluorine-based resin.

In a preferred embodiment, the environment-resistant functional layer (L) is a water-repellent layer (L).

In a preferred embodiment, the water-repellent layer (L) contains a water-repellent compound.

In a preferred embodiment, the water-repellent compound is at least one kind selected from a silicone-based compound and a fluorine-based compound.

In a preferred embodiment, the environment-resistant functional layer (L) is a hydrophilic layer (L).

In a preferred embodiment, the hydrophilic layer (L) contains a hydrophilic inorganic compound.

In a preferred embodiment, the hydrophilic inorganic compound is at least one kind selected from titanium oxide, silica, and aluminum.

In a preferred embodiment, the hydrophilic layer (L) contains a hydrophilic resin.

In a preferred embodiment, the hydrophilic resin is at least one kind selected from a cationic polymer, a non-ionic polymer, and an anionic polymer.

In a preferred embodiment, the environment-resistant functional layer (L) is an oil-repellent layer (L).

In a preferred embodiment, the oil-repellent layer (L) contains an oil-repellent compound.

In a preferred embodiment, the oil-repellent compound is at least one kind selected from a silicone-based compound and a fluorine-based compound.

The hygienic functional flame-retardant polymer member of the present invention is a hygienic functional flame-retardant polymer member, including a polymer layer (B), a flame-retardant layer (A), and a hygienic functional layer (L) in the stated order, in which the flame-retardant layer (A) is a layer containing a layered inorganic compound (f) in a polymer.

In a preferred embodiment, the hygienic functional layer (L) has a thickness of 0.1 to 100 μm.

In a preferred embodiment, in a horizontal firing test involving horizontally placing the hygienic functional flame-retardant polymer member of the present invention with its side of the hygienic functional layer (L) as a lower surface so that the lower surface is in contact with air, placing a Bunsen burner so that a flame port of the Bunsen burner is positioned at a lower portion distant from the lower surface on the side of the hygienic functional layer (L) by 45 mm, and bringing a flame of the Bunsen burner having a height of 55 mm from the flame port into contact with the lower surface of the hygienic functional layer (L) for 30 seconds while preventing the flame from being in contact with an end portion of the flame-retardant polymer member, the flame-retardant polymer member has flame retardancy capable of blocking the flame.

In a preferred embodiment, the hygienic functional layer (L) is an antibacterial layer (L).

In a preferred embodiment, the antibacterial layer (L) contains an antibacterial agent.

In a preferred embodiment, the antibacterial agent is such that a metal component is carried on an inorganic powder.

In a preferred embodiment, the inorganic powder is at least one kind selected from zeolite, silica gel, titanium oxide, and aluminum oxide.

In a preferred embodiment, the metal component is at least one kind selected from silver, copper, zinc, tin, bismuth, cadmium, chromium, and mercury.

In a preferred embodiment, the hygienic functional layer (L) is an antifungal layer (L).

In a preferred embodiment, the antifungal layer (L) contains an antifungal agent.

In a preferred embodiment, the antifungal agent is at least one kind selected from an organic antifungal agent and an inorganic antifungal agent.

In a preferred embodiment, the organic antifungal agent is at least one kind selected from a thiocarbamate-based compound, a dithiocarbamate-based compound, an allylamine-based compound, an imidazole-based compound, a triazole-based compound, a thiazolone-based compound, a tropolone-based compound, and an organic acid-based compound.

In a preferred embodiment, the inorganic antifungal agent is at least one kind selected from a metal ion-based antifungal agent obtained by causing an inorganic compound to carry a metal ion, and a photocatalyst.

In a preferred embodiment, the hygienic functional layer (L) is a deodorant layer (L).

In a preferred embodiment, the deodorant layer (L) contains a deodorant.

In a preferred embodiment, the deodorant is such that a metal component is carried on an inorganic powder.

In a preferred embodiment, the inorganic powder is at least one kind selected from zeolite, silica gel, titanium oxide, aluminum oxide, and activated carbon.

In a preferred embodiment, the metal component is at least one kind selected from silver, copper, zinc, tin, lead, bismuth, cadmium, chromium, and mercury.

### Advantageous Effects of Invention

The environment-resistant functional flame-retardant polymer member of the present invention has the polymer layer (B), the flame-retardant layer (A), which is a layer containing the layered inorganic compound (f) in a polymer, and the environment-resistant functional layer (L). As the environment-resistant functional flame-retardant polymer member of the present invention has the environment-resistant functional layer (L), the member can effectively express environment-resistant functionality.

When the environment-resistant functional layer (L) is the photocatalyst layer (L), the environment-resistant functional flame-retardant polymer member of the present invention can effectively express photocatalyst performance such as antifouling property, dust-proof property, cleaning property, antibacterial property, or organic matter degradability.

When the environment-resistant functional layer (L) is the antifouling layer (L), the environment-resistant functional flame-retardant polymer member of the present invention can effectively express excellent antifouling performance.

When the environment-resistant functional layer (L) is the moisture-conditioning layer (L), the environment-resistant functional flame-retardant polymer member of the present invention can effectively express excellent moisture-conditioning property.

When the environment-resistant functional layer (L) is the moisture-preventing layer (L), the environment-resistant functional flame-retardant polymer member of the present invention can effectively express excellent moisture-preventing property.

When the environment-resistant functional layer (L) is the water-resistant layer (L), the environment-resistant functional flame-retardant polymer member of the present invention can effectively express excellent water resistance, and hence its surface hardly deteriorates even when exposed to moisture.

When the environment-resistant functional layer (L) is the water-repellent layer (L), the environment-resistant functional flame-retardant polymer member of the present invention can effectively express excellent water repellency, and hence when its surface is stained with a contaminant, the contaminant can be easily removed with water.

When the environment-resistant functional layer (L) is the hydrophilic layer (L), the environment-resistant functional flame-retardant polymer member of the present invention can effectively express excellent hydrophilicity, and hence when its surface is stained with a contaminant, the contaminant can be easily washed out.

When the environment-resistant functional layer (L) is the oil-repellent layer (L), the environment-resistant functional flame-retardant polymer member of the present invention can effectively express excellent oil repellency, and hence when its surface is stained with an oily contaminant, the oily contaminant can be easily removed.

The hygienic functional flame-retardant polymer member of the present invention has the polymer layer (B), the flame-retardant layer (A), which is a layer containing the layered inorganic compound (f) in a polymer, and the hygienic functional layer (L). As the hygienic functional flame-retardant polymer member of the present invention has the hygienic functional layer (L), the member can effectively express hygienic functionality.

When the hygienic functional layer (L) is the antibacterial layer (L), the hygienic functional flame-retardant polymer member of the present invention can effectively express excellent antibacterial performance.

When the hygienic functional layer (L) is the antifungal layer (L), the hygienic functional flame-retardant polymer member of the present invention can effectively express excellent antifungal performance.

When the hygienic functional layer (L) is the deodorant layer (L), the hygienic functional flame-retardant polymer member of the present invention can effectively express excellent deodorant property, and hence can reduce an odor in the vicinity of an adherend.

The flame-retardant layer (A) exerts a high degree of flame retardancy by virtue of the fact that the layer is a layer containing the layered inorganic compound (f) in the polymer. Despite the fact that the environment-resistant functional flame-retardant polymer member of the present invention or the hygienic functional flame-retardant polymer member of the present invention has the polymer, the member does not burn and can block a flame for some time even when the member is in direct contact with the flame.

As the flame-retardant layer (A) has the polymer, the member can favorably maintain its flexibility, and has so wide a scope of applications as to be applicable to various applications.

There is no need to incorporate any halogen-based resin into the environment-resistant functional flame-retardant polymer member of the present invention or the hygienic functional flame-retardant polymer member of the present invention.

In addition, the member is excellent in transparency because the ratio of the layered inorganic compound (f) in the polymer in the flame-retardant layer (A) can be controlled so as to be relatively small. In particular, the member can exert flame retardancy even when the content of ash in the flame-retardant layer (A) is a content as small as less than 70 wt %. As described above, the environment-resistant functional flame-retardant polymer member of the present invention or the hygienic functional flame-retardant polymer member of the present invention can effectively exert its flame retardancy while satisfying its environment-resistant functionality or hygienic functionality, flexibility, and transparency.

In addition, the environment-resistant functional flame-retardant polymer member of the present invention or the hygienic functional flame-retardant polymer member of the present invention is excellent in flame retardancy particularly when the environment-resistant functional flame-retardant polymer member of the present invention or the hygienic functional flame-retardant polymer member of the present invention is obtained by a production method including the step of laminating a syrupy polymerizable composition layer (a) formed of a polymerizable composition (α) containing a polymerizable monomer (m) and the layered inorganic compound (f), and a solid monomer-absorbing layer (b) containing a polymer (p) and capable of absorbing the polymerizable monomer (m), followed by the performance of polymerization, and the step of producing the environment-resistant functional layer or the hygienic functional layer or when the member is obtained by a production method including the step of laminating a syrupy polymerizable composition layer (a′) formed of a polymerizable composition (α) containing a polymerizable monomer (m1) and the layered inorganic compound (f), and a syrupy polymerizable composition layer (b′) containing a polymerizable monomer (m2) and a polymer (p2), followed by performance of polymerization and the step of producing the environment-resistant functional layer or the hygienic functional layer.

The environment-resistant functional flame-retardant polymer member of the present invention or the hygienic functional flame-retardant polymer member of the present invention is environmentally advantageous because there is no need to remove a volatile component (such as an organic solvent or an organic compound) in the polymerizable composition (α) through evaporation upon its production and hence a load on an environment can be reduced.

### BRIEF DESCRIPTION OF DRAWINGS

FIG. 1 is an example of a schematic sectional view of an environment-resistant functional flame-retardant polymer member of the present invention or a hygienic functional flame-retardant polymer member of the present invention.

FIG. 2 is a schematic view of a method for a horizontal firing test for evaluating the environment-resistant functional flame-retardant polymer member of the present invention or the hygienic functional flame-retardant polymer member of the present invention for its flame retardancy.

FIG. 3 is an example of a schematic sectional view of the environment-resistant functional flame-retardant polymer member of the present invention or the hygienic functional flame-retardant polymer member of the present invention and a production method therefor.

FIG. 4 is an example of a schematic sectional view of the environment-resistant functional flame-retardant polymer member of the present invention or the hygienic functional flame-retardant polymer member of the present invention and the production method therefor.

### DESCRIPTION OF EMBODIMENTS

<<1. Environment-Resistant Functional Flame-Retardant Polymer Member and Hygienic Functional Flame-Retardant Polymer Member>>

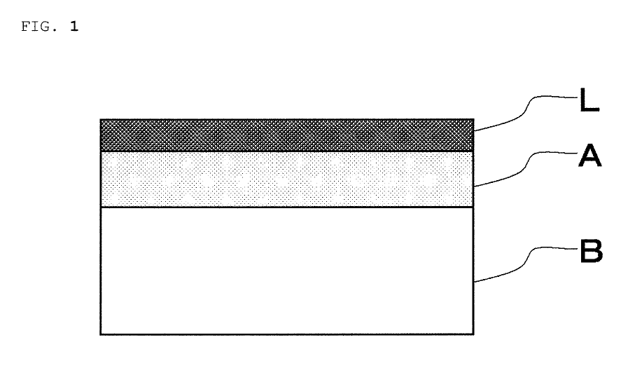

An environment-resistant functional flame-retardant polymer member of the present invention includes a polymer layer (B), a flame-retardant layer (A), and an environment-resistant functional layer (L) in the stated order. A hygienic functional flame-retardant polymer member of the present invention includes the polymer layer (B), the flame-retardant layer (A), and a hygienic functional layer (L) in the stated order. The flame-retardant layer (A) is a layer containing a layered inorganic compound (f) in a polymer. FIG. 1 illustrates a schematic view of each of the environment-resistant functional flame-retardant polymer member of the Present invention and the hygienic functional flame-retardant polymer member of the present invention. Although the flame-retardant layer (A) is provided on one surface of the polymer layer (B) in FIG. 1, the flame-retardant layer (A) can be provided on each of both surfaces of the polymer layer (B). When the flame-retardant layer (A) is provided on each of both surfaces of the polymer layer (B), the environment-resistant functional layer (L) or the hygienic functional layer (L) is provided on a surface of at least one of the two polymer layers (B).

<1-1. Polymer Layer (B)>

The polymer layer (B) contains various polymers at preferably 80 wt % or more, more preferably 90 wt % or more, still more preferably 95 wt % or more, particularly preferably 98 wt % or more, most preferably substantially 100 wt %.

Examples of the polymer in the polymer layer (B) include: an acrylic resin; an urethane-based resin; an olefin-based resin containing an α-olefin as a monomer component such as a polyethylene (PE), a polypropylene (PP), an ethylene-propylene copolymer, or an ethylene-vinyl acetate copolymer (EVA); a polyester-based resin such as a polyethylene terephthalate (PET), a polyethylene naphthalate (PEN), or a polybutylene terephthalate (PBT); a vinyl acetate-based resin; a polyphenylene sulfide (PPS); an amide-based resin such as a polyamide (nylon) or an all-aromatic polyamide (aramid); a polyimide-based resin; a polyether ether ketone (PEEK); an epoxy resin; an oxetane-based resin; a vinyl ether-based resin; a natural rubber; and a synthetic rubber. The polymer in the polymer layer (B) is preferably an acrylic resin.

The number of kinds of polymers in the polymer layer (B) may be only one, or may be two or more.

The number of kinds of polymerizable monomers that can be used for obtaining the polymer in the polymer layer (B) may be only one, or may be two or more.

Any appropriate polymerizable monomer can be adopted as a polymerizable monomer that can be used for obtaining the polymer in the polymer layer (B).

Examples of the polymerizable monomer that can be used for obtaining the polymer in the polymer layer (B) include a monofunctional monomer, a polyfunctional monomer, a polar group-containing monomer, and any other copolymerizable monomer. Any appropriate content can be adopted as the content of each monomer component such as the monofunctional monomer, the polyfunctional monomer, the polar group-containing monomer, or the other copolymerizable monomer in the polymerizable monomer that can be used for obtaining the polymer in the polymer layer (B) depending on target physical properties of the polymer to be obtained.

Any appropriate monofunctional monomer can be adopted as the monofunctional monomer as long as the monomer is a polymerizable monomer having only one polymerizable group. The number of kinds of the monofunctional monomers may be only one, or may be two or more.

The monofunctional monomer is preferably an acrylic monomer. The acrylic monomer is preferably an alkyl(meth)acrylate having an alkyl group. The number of kinds of the alkyl(meth)acrylates each having an alkyl group may be only one, or may be two or more. It should be noted that the term “(meth)acryl” refers to “acryl” and/or “methacryl.”

Examples of the alkyl(meth)acrylate having an alkyl group include an alkyl(meth)acrylate having a linear or branched alkyl group, and an alkyl(meth)acrylate having a cyclic alkyl group. It should be noted that the alkyl(meth)acrylate as used herein means a monofunctional alkyl(meth)acrylate.

Examples of the alkyl(meth)acrylate having a linear or branched alkyl group include alkyl(meth)acrylates each having an alkyl group having 1 to 20 carbon atoms such as methyl(meth)acrylate, ethyl meth(acrylate), propyl(meth)acrylate, isopropyl(meth)acrylate, butyl(meth)acrylate, isobutyl(meth)acrylate, s-butyl(meth)acrylate, t-butyl(meth)acrylate, pentyl(meth)acrylate, isopentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, nonadecyl(meth)acrylate, and eicosyl(meth)acrylate. Of those, an alkyl(meth)acrylate having an alkyl group having 2 to 14 carbon atoms is preferred, and an alkyl(meth)acrylate having an alkyl group having 2 to 10 carbon atoms is more preferred.

Examples of the alkyl(meth)acrylate having a cyclic alkyl group include cyclopentyl(meth)acrylate, cyclohexyl(meth)acrylate, and isobornyl(meth)acrylate.

Any appropriate polyfunctional monomer can be adopted as the polyfunctional monomer. By adopting the polyfunctional monomer, a cross-linked structure may be given to the polymer in the polymer layer (B). The number of kinds of the polyfunctional monomers may be only one, or may be two or more.

Examples of the polyfunctional monomer include 1,9-nonanedioldi(meth)acrylate,1,6-hexanedioldi(meth)acrylate, 1,4-butanediol di(meth)acrylate, (poly)ethylene glycol di(meth)acrylate, (poly)propylene glycol di(meth)acrylate, neopentylglycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl(meth)acrylate, vinyl(meth)acrylate, divinylbenzene, epoxy acrylate, polyester acrylate, and urethane acrylate. Of those, an acrylate-based polyfunctional monomer is preferred, and 1,9-nonanediol di(meth)acrylate and 1,6-hexanediol di(meth)acrylate are more preferred in terms of having high reactivity and possibly expressing excellent cigarette resistance.

Any appropriate polar group-containing monomer can be adopted as the polar group-containing monomer. The adoption of the polar group-containing monomer can improve the cohesive strength of the polymer in the polymer layer (B), or can increase the adhesive strength of the polymer layer (B). The number of kinds of the polar group-containing monomers may be only one, or may be two or more.

Examples of the polar group-containing monomer include: carboxyl group-containing monomers such as (meth)acrylic acid, itaconic acid, maleic acid, fumalic acid, crotonic acid, and isocrotonic acid, or anhydrides thereof (for example, maleic anhydride); hydroxy group-containing monomers such as a hydroxyalkyl(meth)acrylate such as hydroxyethyl(meth)acrylate, hydroxypropyl(meth)acrylate, or hydroxybutyl(meth)acrylate, vinyl alcohol, and allyl alcohol; amide group-containing monomers such as (meth)acrylamide, N,N-dimethyl(meth)acrylamide, N-methylol(meth)acrylamide, N-methoxymethyl(meth)acrylamide, and N-butoxymethyl(meth)acrylamide; amino group-containing monomers such as aminoethyl(meth)acrylate, dimethylaminoethyl(meth)acrylate, and t-butylaminoethyl(meth)acrylate; glycidyl group-containing monomers such as glycidyl(meth)acrylate and methylglycidyl(meth)acrylate; cyano group-containing monomers such as acrylonitrile and methacrylonitrile; heterocycle-containing vinyl-based monomers such as N-vinyl-2-pyrrolidone and (meth)acryloyl morpholine, as well as N-vinylpyridine, N-vinylpiperidone, N-vinylpyrimidine, N-vinylpiperazine, N-vinylpyrrole, N-vinylimidazole, and N-vinyloxazole; alkoxyalkyl(meth)acrylate-based monomers such as methoxyethyl(meth)acrylate and ethoxyethyl(meth)acrylate; sulfonate group-containing monomers such as sodium vinyl sulfonate; phosphate group-containing monomers such as 2-hydroxyethyl acryloyl phosphate; imide group-containing monomers such as cyclohexyl maleimide and isopropyl maleimide; and isocyanate group-containing monomers such as 2-methacryloyloxyethyl isocyanate. The polar group-containing monomer is preferably a carboxyl group-containing monomer or an anhydride thereof, more preferably acrylic acid.

Any appropriate other copolymerizable monomer can be adopted as the other copolymerizable monomer. The adoption of the other copolymerizable monomer can improve the cohesive strength of the polymer in the polymer layer (B), or can increase the adhesive strength of the polymer layer (B). The number of kinds of the other copolymerizable monomers may be only one, or may be two or more.

Examples of the other copolymerizable monomer include: an alkyl(meth)acrylate such as a (meth)acrylate having an aromatic hydrocarbon group such as phenyl(meth)acrylate; vinyl esters such as vinyl acetate and vinyl propionate; aromatic vinyl compounds such as styrene and vinyl toluene; olefins and dienes such as ethylene, butadiene, isoprene, and isobutylene; vinyl ethers such as a vinyl alkyl ether; vinyl chloride; alkoxyalkyl(meth)acrylate-based monomers such as methoxyethyl(meth)acrylate and ethoxyethyl(meth)acrylate; sulfonate group-containing monomers such as sodium vinyl sulfonate; phosphate group-containing monomers such as 2-hydroxyethyl acryloyl phosphate; imide group-containing monomers such as cyclohexylmaleimide and isopropylmaleimide; isocyanate group-containing monomers such as 2-methacryloyloxyethyl isocyanate; fluorine atom-containing (meth)acrylates; and silicon atom-containing (meth)acrylates.

The polymer layer (B) may contain a flame retardant. Any appropriate flame retardant can be adopted as the flame retardant. Examples of such flame retardant include: organic flame retardants such as a phosphorus-based flame retardant; and inorganic flame retardants such as magnesium hydroxide, aluminum hydroxide, and a layered silicate.

The polymer layer (B) may contain the layered inorganic compound (f) as a flame retardant as in the flame-retardant layer (A). In this case, the ratio at which the layered inorganic compound (f) is filled into the polymer layer (B) is preferably set so as to be lower than the ratio at which the layered inorganic compound (f) is filled into the flame-retardant layer (A). Thus, the flame-retardant layer (A) and the polymer layer (B) are differentiated from each other in terms of degree of flame retardancy.

Any appropriate thickness can be adopted as the thickness of the polymer layer (B). The thickness of the polymer layer (B) is, for example, preferably 1 to 3,000 μm, more preferably 2 to 2,000 μm, still more preferably 5 to 1,000 μm. In addition, the polymer layer (B) may be a single layer, or may be a laminate formed of a plurality of layers.

Pressure-sensitive adhesive property can be imparted to the polymer layer (B) through the selection of a polymer that is a material for forming the layer. For example, an acrylic resin, an epoxy resin, an oxetane-based resin, a vinyl ether-based resin, a urethane-based resin, and a polyester-based resin function as a base polymer for an acrylic pressure-sensitive adhesive, a base polymer for an epoxy-based pressure-sensitive adhesive, a base polymer for an oxetane-based pressure-sensitive adhesive, a base polymer for a vinyl ether-based pressure-sensitive adhesive, abase polymer for a urethane-based pressure-sensitive adhesive, and a base polymer for a polyester-based pressure-sensitive adhesive, respectively.

<1-2. Flame-Retardant Layer (A)>

The same examples as those of the polymer that can be incorporated into the polymer layer (B) can be given as examples of the polymer in the flame-retardant layer (A).

<1-3. Layered Inorganic Compound (f)>

Examples of the layered inorganic compound (f) to be incorporated into the flame-retardant layer (A) include a layered inorganic substance and an organically treated product thereof. The layered inorganic compound (f) may be a solid, or may have flowability. The number of kinds of the layered inorganic compounds may be only one, or may be two or more.

Examples of inorganics which can form a layered inorganic substance include a silicate and a clay mineral. Of those, a layered clay mineral is preferred as the layered inorganic substance.

Examples of the layered clay mineral include: a smectite such as montmorillonite, beidellite, hectorite, saponite, nontronite, or stevensite; vermiculite; bentonite; and a layered sodium silicate such as kanemite, kenyaite, or makatite. Such layered clay mineral may be yielded as a natural mineral, or may be produced by a chemical synthesis method.

The organically treated product of the layered inorganic substance is a product obtained by treating the layered inorganic substance with an organic compound. An example of the organic compound is an organic cationic compound. Examples of the organic cationic compound include cationic surfactants each having a cation group such as a quarternary ammonium salt or a quarternary phosphonium salt. The cationic surfactant has a cationic group such as a quarternary ammonium salt or a quarternary phosphonium salt on a propylene oxide skeleton, an ethylene oxide skeleton, an alkyl skeleton, or the like. Such cationic group preferably forms a quarternary salt with, for example, a halide ion (such as a chloride ion).

Examples of the cationic surfactant which has a quarternary ammonium salt include lauryltrimethylammonium salt, stearyltrimethylammonium salt, trioctylammonium salt, distearyldimethylammonium salt, distearyldibenzylammonium salt, and an ammonium salt having a methyldiethylpropylene oxide skeleton.

Examples of the cationic surfactant which has a quarternary phosphonium salt include dodecyltriphenyl phosphonium salt, methyltriphenylphosphonium salt, lauryltrimethyl phosphonium salt, stearyltrimethyl phosphonium salt, distearyldimethyl phosphonium salt, and distearylbenzyl phosphonium salt.

The layered inorganic substance such as the layered clay mineral is treated with the organic cationic compound. As a result, a cation between layers can undergo ion exchange with a cationic group of a quaternary salt or the like. Examples of the cation of the clay mineral include metal cations such as a sodium ion and a calcium ion. The layered clay mineral treated with the organic cationic compound is easily swollen and dispersed in the polymer or the polymerizable monomer. An example of the layered clay mineral treated with the organic cationic compound is LUCENTITE series (Co-op Chemical Co., Ltd.). As LUCENTITE series (Co-op Chemical Co., Ltd.), more specifically, LUCENTITE SPN, LUCENTITE SAN, LUCENTITE SEN, and LUCENTITE STN are given.

Examples of the organically treated product of the layered inorganic substance include products obtained by subjecting the surface of the layered inorganic substance to surface treatments with various organic compounds (such as a surface tension-lowering treatment with a silicone-based compound or a fluorine-based compound).

The ratio of the organic compound to the layered inorganic substance in the organically treated product of the layered inorganic substance varies depending on the cation-exchange capacity (“CEC”) of the layered inorganic substance. The CEC relates to the ion-exchange capacity of the layered inorganic compound (f) or the total quantity of positive charge that can be caused to adsorb on the surface of the layered inorganic substance, and is represented by positive charge per unit mass of colloid particles, that is, “coulomb(s) per unit mass” in an SI unit. The CEC may be represented by milliequivalent(s) per gram (meq/g) or milliequivalent(s) per 100 grams (meq/100 g). A CEC of 1 meq/g corresponds to 96.5 C/g in the SI unit. Several CEC values concerning representative clay minerals are as described below. The CEC of montmorillonite falls within the range of 70 to 150 meq/100 g, the CEC of halloysite falls within the range of 40 to 50 meq/100 g, and the CEC of kaolin falls within the range of 1 to 10 meq/100 g.

The ratio of the organic compound to the layered inorganic substance in the organically treated product of the layered inorganic substance is such that the amount of the organic compound is preferably 1,000 parts by weight or less, more preferably 3 to 700 parts by weight, more preferably 5 to 500 parts by weight with respect to 100 parts by weight of the layered inorganic substance.

With regard to the particle diameter (average particle diameter) of the layered inorganic compound (f), its particles are preferably packed as densely as possible in a portion in the flame-retardant layer (A) where the layered inorganic compound (f) is distributed from such a viewpoint that good flame retardancy is obtained. For example, the average of primary particle diameters when the layered inorganic compound (f) is dispersed in a dilute solution is preferably 5 nm to 10 μm, more preferably 6 nm to 5 μm, still more preferably 7 nm to 1 μm in terms of a median diameter in a laser scattering method or a dynamic light scattering method. It should be noted that a combination of two or more kinds of particles having different particle diameters may be used as the particles.

The shape of each of the particles may be any shape, e.g., a spherical shape such as a true spherical shape or an ellipsoidal shape, an amorphous shape, a needle-like shape, a rod-like shape, a flat plate-like shape, a flaky shape, or a hollow tubular shape. The shape of each of the particles is preferably a flat plate-like shape or a flaky shape. In addition, the surface of each of the particles may have a pore, a protrusion, or the like.

The average of maximum primary particle diameters is preferably 5 μm or less, more preferably 5 nm to 5 μm because the transparency of the flame-retardant polymer member may be problematic as the particle diameter of the layered clay mineral increases.

It should be noted that the Lucentite SPN (manufactured by Co-op Chemical Co., Ltd.) is obtained by subjecting the layered clay mineral to an organizing treatment with an organic compound having a quaternary ammonium salt, and the ratio of the organic compound is 62 wt %. With regard to its particle diameter, the Lucentite SPN has a 25% average primary particle diameter of 19 nm, a 50% average primary particle diameter of 30 nm, and a 99% average primary particle diameter of 100 nm. The Lucentite SPN has a thickness of 1 nm and an aspect ratio of about 30.

When particles are used as the layered inorganic compound (f), the layered inorganic compound (f) can contribute to, for example, the formation of surface unevenness by the particles in the surface of the flame-retardant layer (A) in some cases.

In addition, when the product obtained by treating the layered clay mineral with the organic cationic compound is used as the layered inorganic compound (f), the surface resistance value of the flame-retardant layer (A) can be preferably set to 1×10¹⁴ (Ω/□) or less, and hence antistatic property can be imparted to the flame-retardant layer (A). The antistatic property can be controlled to desired antistatic property by controlling, for example, the kind, shape, size, and content of the layered inorganic compound (f), and the composition of the polymer component of the flame-retardant layer (A).

As the layered inorganic compound (f) and the polymer are mixed in the flame-retardant layer (A), the layer can exert a characteristic based on the polymer, and at the same time, can exert a characteristic of the layered inorganic compound (f).

The content of ash in the flame-retardant layer (A) (the content of the layered inorganic compound (f) with respect to the total amount of the formation materials for the flame-retardant layer (A), provided that when the layered inorganic compound (f) is an organically treated product of a layered inorganic substance, the content of the layered inorganic substance that has not been subjected to any organic treatment) can be appropriately set depending on the kind of the layered inorganic compound (f). The content is preferably 3 wt % or more and less than 70 wt %. When the content is 70 wt % or more, the layered inorganic compound (f) may not be favorably dispersed. As a result, a lump is apt to be produced and hence it becomes difficult to produce the flame-retardant layer (A) in which the layered inorganic compound (f) has been uniformly dispersed in some cases. When the content is 70 wt % or more, the transparency and flexibility of the flame-retardant polymer member may reduce. On the other hand, when the content is less than 3 wt %, the flame-retardant layer (A) does not have flame retardancy in some cases. The content of the layered inorganic compound (f) in the flame-retardant layer (A) is preferably 3 to 60 wt %, more preferably 5 to 50 wt %.

<1-4. Additive>

Any appropriate additive may be incorporated into the flame-retardant layer (A). Examples of such additive include a surfactant (such as an ionic surfactant, a silicone-based surfactant, or a fluorine-based surfactant), a cross-linking agent (such as a polyisocyanate-based cross-linking agent, a silicone-based cross-linking agent, an epoxy-based cross-linking agent, or an alkyl-etherified melamine-based cross-linking agent), a plasticizer, a filler, an age resister, an antioxidant, a colorant (such as a pigment or a dye), and a solvent (such as an organic solvent).

Any appropriate pigment (coloring pigment) may be incorporated into the flame-retardant layer (A) from the viewpoints of, for example, design and optical characteristics. When a black color is desired, carbon black is preferably used as the coloring pigment. The usage of the pigment (coloring pigment) is, for example, preferably 0.15 part by weight or less, more preferably 0.001 to 0.15 part by weight, still more preferably 0.02 to 0.1 part by weight with respect to 100 parts by weight of the polymer in the flame-retardant layer (A) from such a viewpoint that the degree of coloring and the like are not inhibited.

The flame-retardant layer (A) has a thickness of preferably 3 to 1,000 μm, more preferably 4 to 500 μm, still more preferably 5 to 200 μm. When the thickness of the flame-retardant layer (A) deviates from the range, its flame retardancy may be problematic.

<1-5. Environment-Resistant Functional Layer (L)>

Any appropriate layer can be adopted as the environment-resistant functional layer (L) as long as the layer can express environment-resistant functionality. Preferred examples of such environment-resistant functional layer (L) include a photocatalyst layer (L), an antifouling layer (L), a moisture-conditioning layer (L), a moisture-preventing layer (L), a water-resistant layer (L), a water-repellent layer (L), a hydrophilic layer (L), and an oil-repellent layer (L).

The thickness of the environment-resistant functional layer (L) is preferably 0.1 to 100 μm, more preferably 1 to 100 μm. As long as the thickness of the environment-resistant functional layer (L) falls within the range, the layer can express sufficient environment-resistant functionality without impairing the flame retardancy of the environment-resistant functional flame-retardant polymer member of the present invention.

(1-5-1. Photocatalyst Layer (L))

The photocatalyst layer (L) contains a photocatalyst. Although the form of the photocatalyst may be any form, photocatalyst particles are preferred because photocatalyst performance can be sufficiently expressed.

The photocatalyst layer (L) may be a layer formed only from the photocatalyst, or may be a layer formed from the photocatalyst and any appropriate component except the photocatalyst. Examples of the appropriate component except the photocatalyst include additives such as an inorganic binder and a dispersion stabilizer.

Examples of the photocatalyst particles include: metal oxides such as titanium oxide, zinc oxide, tin oxide, lead oxide, ferric oxide, dibismuth trioxide, tungsten trioxide, and strontium titanate; and products obtained by adding metals such as Fe, Co, Ni, Cu, Zn, Ru, Rh, Pd, Ag, Pt, and Au to the metal oxides. Of those, titanium oxide is preferred because it is non-hazardous, chemically stable, and inexpensive. Although any one of anatase type titanium oxide, rutile type titanium oxide, and brookite type titanium oxide can be used as the titanium oxide, titanium oxide that uses the anatase type titanium oxide active for a photocatalytic reaction as a main component is preferred.

The average particle diameter of the photocatalyst particles is preferably 0.005 to 0.1 μm, more preferably 0.01 to 0.1 μm. As long as the average particle diameter of the photocatalyst particles falls within the range, the transparency of the photocatalyst layer (L) can be secured and its photocatalytic activity can be retained at a high level.

The photocatalyst layer (L) may be formed only of one layer, or may be formed of two or more layers.

The thickness of the photocatalyst layer (L) is preferably 0.1 to 100 μm, more preferably 1 to 100 μm. As long as the thickness of the photocatalyst layer (L) falls within the range, the layer can express sufficient photocatalytic activity without impairing the flame retardancy of the environment-resistant functional flame-retardant polymer member of the present invention.

The inorganic binder enhances adhesion between the photocatalyst particles and improves the strength of the layer based on the photocatalyst. Any appropriate inorganic compound can be adopted as the inorganic binder as long as the compound functions as a binder. The inorganic binder is preferably, for example, a silica compound. Tetra-, tri-, and bifunctional alkoxysilanes, and condensates and hydrolysates of these alkoxysilanes, a silicone varnish, and the like can each be used as the silica compound. The tri- and bifunctional alkoxysilanes are generally referred to as “silane coupling agents” in some cases. Specifically, examples of the tetrafunctional alkoxysilane include tetramethoxysilane, tetraethoxysilane, and tetrapropoxysilane, examples of the trifunctional alkoxysilane include methyltrimethoxysilane, methyltriethoxysilane, phenyltrimethoxysilane, phenyltriethoxysilane, vinyltrimethoxysilane, vinyltriethoxysilane, methacryloxypropyltrimethoxysilane, glycidopropoxytrimethoxysilane, glycidopropylmethyldiethoxysilane, aminopropyltriethoxysilane, aminoethylaminopropyltrimethoxysilane, and mercaptopropyltrimethoxysilane, and examples of the difunctional alkoxysilane include dimethyldimethoxysilane, dimethyldiethoxysilane, diphenyldimethoxysilane, and diphenyldiethoxysilane. Examples of the condensates of the alkoxysilanes include condensates of the tetrafunctional alkoxysilane such as Ethyl Silicate 40, Ethyl Silicate 48, and Methyl Silicate 51. Examples of the hydrolysates of the alkoxysilanes include products obtained by hydrolyzing the alkoxysilanes with an organic solvent, water, and a catalyst. Of those silica compounds, in particular, tetramethoxysilane, tetraethoxysilane, Ethyl Silicate 40, Ethyl Silicate 48, Methyl Silicate 51, and alcoholic silica sols as hydrolysates thereof are particularly preferred because each of them can firmly fix the photocatalyst (L) and is relatively inexpensive.

(1-5-2. Antifouling Layer (L))

Any appropriate layer can be adopted as the antifouling layer (L) as long as an antifouling effect is obtained.

The antifouling layer (L) is preferably, for example, a layer containing at least one kind selected from a fluorine-based resin and a silicone-based resin.

The fluorine-based resin is, for example, a fluorine-containing silane compound (general formula (1)) described in Japanese Patent Application Laid-open No. Hei 09-258003. The number of kinds of the fluorine-based resins may be only one, or may be two or more.

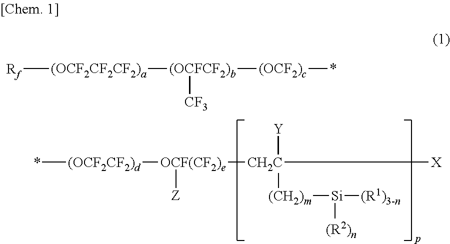

In the general formula (1), R_{f} represents a linear or branched perfluoroalkyl group having 1 to 16 carbon atoms, and preferred examples thereof include CF₃—, C₂F₅—, and C₃F₇—. X represents iodine or hydrogen. Y represents hydrogen or a lower alkyl group. R¹ represents a hydrolyzable group and preferred examples thereof include a halogen, —OR³, —OCOR³, —OC(R³)═C(R⁴)₂, —ON═C(R³)₂, and —ON═CR⁵ (provided that R³ represents an aliphatic hydrocarbon group or an aromatic hydrocarbon group, R⁴ represents hydrogen or a lower aliphatic hydrocarbon group, and R⁵ represents a divalent, aliphatic hydrocarbon group having 3 to 6 carbon atoms). More preferred examples of R¹ include chlorine, —OCH₃, and —OC₂H₅. R² represents hydrogen or an inert, monovalent organic group, preferably, for example, a monovalent hydrocarbon group having 1 to 4 carbon atoms. a, b, c, and d each represent an integer of 0 to 200, preferably 1 to 50. e represents 0 or 1. m and n each represent an integer of 0 to 2, preferably 0. p represents an integer of 1 or more, preferably an integer of 1 to 10.

The molecular weight of the fluorine-containing silane compound represented by the general formula (1) is preferably 5×10² to 1×10⁵, more preferably 5×10² to 1×10⁴.

A preferred structure of the fluorine-containing silane compound represented by the general formula (1) is, for example, a structure represented by a general formula (2). In the general formula (2), q represents an integer of 1 to 50, r represents an integer of 1 or more, preferably an integer of 1 to 10, and the other symbols are the same as those described in the general formula (1).

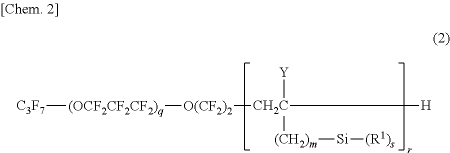

Examples of the silicone-based resin include a dimethylpolysiloxane, a methylhydropolysiloxane, a silicone oil or a silicone varnish, and a silicone-modified acrylic copolymer described in Japanese Patent Application Laid-open No. Hei 09-111185. The number of kinds of the silicone-based resins may be only one, or may be two or more.

The antifouling layer may further contain any appropriate additive depending on purposes.

Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives to be incorporated into the resin composition can be appropriately set depending on purposes.

The antifouling layer (L) may be formed only of one layer, or may be formed of two or more layers.

The thickness of the antifouling layer (L) is preferably 0.1 to 100 μm, more preferably 1 to 100 μm. As long as the thickness of the antifouling layer (L) falls within the range, the layer can express extremely excellent antifouling property without impairing the flame retardancy of the environment-resistant functional flame-retardant polymer member of the present invention.

(1-5-3. Moisture-Conditioning Layer (L))

Any appropriate layer can be adopted as the moisture-conditioning layer (L) as long as a moisture-conditioning effect is obtained.

The moisture-conditioning layer (L) preferably contains a porous substance. The content of the porous substance in the moisture-conditioning layer (L) is preferably 50 to 100 wt %, more preferably 70 to 100 wt %, still more preferably 90 to 100 wt %, particularly preferably 95 to 100 wt %, most preferably substantially 100 wt %.

Any appropriate porous substance can be adopted as the porous substance. Examples of such porous substance include an inorganic oxide, a composite inorganic oxide, and porous carbon. Such porous substance is specifically, for example, at least one kind selected from silica, alumina, magnesia, titania, zirconia, a silica-alumina composite oxide, zeolite, and activated carbon.

The number of kinds of the porous substances in the moisture-conditioning layer (L) may be only one, or may be two or more.

The moisture-conditioning layer (L) may further contain any appropriate additive depending on purposes.

Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives that can be incorporated into the moisture-conditioning layer (L) can be appropriately set depending on purposes.

The moisture-conditioning layer (L) may be formed only of one layer, or may be formed of two or more layers.

The thickness of the moisture-conditioning layer (L) is preferably 0.1 to 100 μm, more preferably 1 to 100 μm. As long as the thickness of the moisture-conditioning layer (L) falls within the range, the layer can express extremely excellent moisture-conditioning property without impairing the flame retardancy of the environment-resistant functional flame-retardant polymer member of the present invention.

(1-5-4. Moisture-Preventing Layer (L))

Any appropriate layer can be adopted as the moisture-preventing layer (L) as long as a moisture-preventing effect is obtained.

The moisture-preventing layer (L) preferably contains a resin having a moisture-preventing effect. Specifically, the moisture-preventing layer (L) preferably contains at least one kind selected from a polyvinylidene chloride-based resin and a polyolefin-based resin. The content of the at least one kind selected from a polyvinylidene chloride-based resin and a polyolefin-based resin in the moisture-preventing layer (L) is preferably 50 to 100 wt %, more preferably 70 to 100 wt %, still more preferably 90 to 100 wt %, particularly preferably 95 to 100 wt %, most preferably substantially 100 wt %.

Any appropriate polyvinylidene chloride-based resin can be adopted as the polyvinylidene chloride-based resin as long as the resin has a constituent unit derived from a polyvinylidene chloride. Specific examples of such polyvinylidene chloride-based resin include a polyvinylidene chloride, a modified body of the polyvinylidene chloride, and a copolymer of vinylidene chloride and any other copolymerizable monomer.

Any appropriate polyolefin-based resin can be adopted as the polyolefin-based resin as long as the resin has a constituent unit derived from an olefin. Specific examples of such polyolefin-based resin include a polyethylene, a copolymer of ethylene and any other copolymerizable monomer, a polypropylene, and a copolymer of propylene and any other copolymerizable monomer.

The number of kinds of the resins each having a moisture-preventing effect in the moisture-preventing layer (L) may be only one, or may be two or more.

The moisture-preventing layer (L) may further contain any appropriate additive depending on purposes.

Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives that can be incorporated into the moisture-preventing layer (L) can be appropriately set depending on purposes.

The moisture-preventing layer (L) may be formed only of one layer, or may be formed of two or more layers.

The thickness of the moisture-preventing layer (L) is preferably 0.1 to 100 μm, more preferably 1 to 100 μm. As long as the thickness of the moisture-preventing layer (L) falls within the range, the layer can express extremely excellent moisture-preventing property without impairing the flame retardancy of the environment-resistant functional flame-retardant polymer member of the present invention.

The moisture-preventing layer (L) may be a layer formed from any appropriate moisture-preventing paint.

(1-5-5. Water-Resistant Layer (L))

Any appropriate layer can be adopted as the water-resistant layer (L) as long as a water-resistant effect is obtained.

The water-resistant layer (L) preferably contains a water-resistant resin. The content of the water-resistant resin in the water-resistant layer (L) is preferably 50 to 100 wt %, more preferably 70 to 100 wt %, still more preferably 90 to 100 wt %, particularly preferably 95 to 100 wt %, most preferably substantially 100 wt %.

Any appropriate water-resistant resin can be adopted as the water-resistant resin. Such water-resistant resin is, for example, at least one kind selected from an epoxy-based resin, a phenol-based resin, a silicone-based resin, and a fluorine-based resin.

The epoxy-based resin is, for example, a cross-linked resin obtained by cross-linking an epoxy group present in an epoxy group-containing monomer or in an epoxy group-containing prepolymer with a curing agent (such as a photopolymerization initiator or a thermal polymerization initiator). Specific examples of the epoxy-based resin include a bisphenol A type epoxy resin, a bisphenol F type epoxy resin, a cresol novolac type epoxy resin, an alicyclic epoxy resin, and a phenol novolac type epoxy resin.

The phenol-based resin is, for example, a cured resin synthesized in the presence of a catalyst by using a phenol (such as phenol or cresol) and formaldehyde as raw materials. Specific examples of the phenol-based resin include a novolac type phenol resin and a resol type phenol resin.

The silicone-based resin is, for example, a resin having a main skeleton having a siloxane bond. Specific examples of the silicone-based resin include a dimethylpolysiloxane, a methylhydropolysiloxane, a silicone oil, a silicone varnish, and a silicone-modified acrylic copolymer described in Japanese Patent Application Laid-open No. Hei 09-111185.

The fluorine-based resin is, for example, a resin obtained by polymerizing an olefin containing fluorine. Specific examples of the fluorine-based resin include polytetrafluoroethylene, polychlorotrifluoroethylene, polyvinyl fluoride, polyvinylidene fluoride, a tetrafluoroethylene/hexafluoropropylene copolymer, and a chlorofluoroethylene/vinylidene fluoride copolymer.

The number of kinds of the waterresistant resins in the water-resistant layer (L) may be only one, or may be two or more.

The water-resistant layer (L) may further contain any appropriate additive depending on purposes.

Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives that can be incorporated into the water-resistant layer (L) can be appropriately set depending on purposes.

The water-resistant layer (L) may be formed only of one layer, or may be formed of two or more layers.

The thickness of the water-resistant layer (L) is preferably 0.1 to 100 μm, more preferably 1 to 100 μm. As long as the thickness of the water-resistant layer (L) falls within the range, the layer can express extremely excellent water resistance without impairing the flame retardancy of the environment-resistant functional flame-retardant polymer member of the present invention, and its surface hardly deteriorates even when exposed to moisture.

(1-5-6. Water-Repellent Layer (L))

Any appropriate layer can be adopted as the water-repellent layer (L) as long as a water-repellent effect is obtained.

The water-repellent layer (L) preferably contains a water-repellent compound. The content of the water-repellent compound in the water-repellent layer (L) is preferably 1 to 100 wt %, more preferably 2 to 100 wt %, still more preferably 3 to 100 wt %.

Any appropriate water-repellent compound can be adopted as the water-repellent compound. Such water-repellent compound is for example, at least one kind selected from a silicone-based compound and a fluorine-based compound.

The silicone-based compound is, for example, a silicone-based compound that can be used as a water-repellent agent. Such silicone-based compound is, for example, a resin having a main skeleton having a siloxane bond. Specific examples of the silicone-based compound include a dimethylpolysiloxane, a methylhydropolysiloxane, a silicone oil, a silicone varnish, and a silicone-modified acrylic copolymer described in Japanese Patent Application Laid-open No. Hei 09-111185.

The fluorine-based compound is, for example, a fluorine-based compound that can be used as a water-repellent agent. Examples of such fluorine-based compound include a compound having a fluorine-containing chain and a resin obtained by polymerizing an olefin containing fluorine. Specific examples of the fluorine-based compound include polytetrafluoroethylene, polychlorotrifluoroethylene, polyvinyl fluoride, polyvinylidene fluoride, a tetrafluoroethylene/hexafluoropropylene copolymer, and a chlorofluoroethylene/vinylidene fluoride copolymer.

The number of kinds of the water-repellent compounds in the water-repellent layer (L) may be only one, or may be two or more.

The water-repellent layer (L) may further contain any appropriate additive depending on purposes.

Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives that can be incorporated into the water-repellent layer (L) can be appropriately set depending on purposes.

The water-repellent layer (L) may be formed only of one layer, or may be formed of two or more layers.

The thickness of the water-repellent layer (L) is preferably 0.1 to 100 μm, more preferably 1 to 100 μm. As long as the thickness of the water-repellent layer (L) falls within the range, the layer can express extremely excellent water repellency without impairing the flame retardancy of the environment-resistant functional flame-retardant polymer member of the present invention, and when its surface is stained with a contaminant, the contaminant can be easily removed with water.

(1-5-7. Hydrophilic Layer (L))

Any appropriate layer can be adopted as the hydrophilic layer (L) as long as a hydrophilic effect is obtained.

The hydrophilic layer (L) preferably contains at least one kind selected from a hydrophilic inorganic compound and a hydrophilic resin. The number of kinds of the hydrophilic inorganic compounds may be only one, or may be two or more. The number of kinds of the hydrophilic resins may be only one, or may be two or more.

When the hydrophilic layer (L) contains the hydrophilic inorganic compound, the content of the hydrophilic inorganic compound in the hydrophilic layer (L) is preferably 1 to 100 wt %, more preferably 2 to 100 wt %, still more preferably 3 to 100 wt %.

When the hydrophilic layer (L) contains the hydrophilic resin, the content of the hydrophilic resin in the hydrophilic layer (L) is preferably 1 to 100 wt %, more preferably 2 to 100 wt %, still more preferably 3 to 100 wt %.

Any appropriate hydrophilic inorganic compound can be adopted as the hydrophilic inorganic compound. Such hydrophilic compound is, for example, at least one kind selected from titanium oxide, silica, and alumina.

Any appropriate hydrophilic resin can be adopted as the hydrophilic resin. Such hydrophilic resin is, for example, at least one kind selected from: cationic polymers obtained from vinyl monomers each containing a cationic group such as an amino group, an ammonium group, a pyridyl group, an imino group, or a betaine structure; nonionic polymers obtained from vinyl monomers each containing a hydrophilic nonionic group such as a hydroxy group, an amide group, an ester group, or an ether group; and anionic polymers obtained from vinyl monomers each containing an anionic group such as a carboxyl group, a sulfonic acid group, or a phosphoric acid group.

Examples of the vinyl monomer containing a cationic group include the following monomers: a(meth)acrylate or(meth)acrylamide having a dialkylamino group having 2 to 44 carbon atoms, such as dimethylaminoethyl(meth)acrylate, diethylaminoethyl(meth)acrylate, dipropylaminoethyl(meth)acrylate, diisopropylaminoethyl(meth)acrylate, dibutylaminoethyl(meth)acrylate, diisobutylaminoethyl(meth)acrylate, di(t-butyl)aminoethyl(meth)acrylate, dimethylaminopropyl(meth)acrylamide, diethylaminopropyl(meth)acrylamide, dipropylaminopropyl(meth)acrylamide, diisopropylaminopropyl(meth)acrylamide, dibutylaminopropyl(meth)acrylamide, diisobutylaminopropyl(meth)acrylamide, or di(t-butyl)aminopropyl(meth)acrylamide; styrene having a dialkylamino group having 2 to carbon atoms, such as dimethylaminostyrene or dimethylaminomethylstyrene; vinylpyridine such as 2- or 4-vinylpyridine; an N-vinyl heterocyclic compound such as N-vinylimidazole; a vinyl ether such as aminoethyl vinyl ether or dimethylaminoethyl vinyl ether; acid-neutralized products of those monomers each having an amino group or products obtained by quaternarizing those monomers each having an amino group with alkyl (having 1 to 22 carbon atoms) halides, benzyl halides, alkyl (having 1 to 18 carbon atoms) or aryl (having 6 to 24 carbon atoms) sulfonic acids, or dialkyl (having 2 to 8 carbon atoms in total) sulfates; diallyl type quaternary ammonium salts such as dimethyldiallylammonium chloride and diethyldiallylammonium chloride; and vinyl monomers each having a betaine structure such as N-(3-sulfopropyl)-N-(meth)acryloyloxyethyl-N,N-dimethylammonium betaine, N-(3-sulfopropyl)-N-(meth)acryloylamidepropyl-N,N-dimethylammonium betaine, N-(3-carboxymethyl)-N-(meth)acryloylamidepropyl-N,N-dimethylammonium betaine, and N-carboxymethyl-N-(meth)acryloyloxyethyl-N,N-dimethylammonium betaine.

Examples of the vinyl monomer containing a nonionic group include: vinyl alcohol; a (meth)acrylate or (meth)acrylamide having a hydroxyalkyl (having 1 to 8 carbon atoms) group, such as N-hydroxypropyl(meth)acrylamide, N-hydroxyethyl(meth)acrylate, or N-hydroxypropyl(meth)acrylamide; a (meth)acrylate of a polyhydric alcohol, such as polyethylene glycol (meth)acrylate (having a degree of polymerization of ethylene glycol of 1 to 30); (meth)acrylamide; an alkyl (having 1 to 8 carbon atoms) (meth)acrylamide such as N-methyl(meth)acrylamide, N-n-propyl(meth)acrylamide, N-isopropyl(meth)acrylamide, N-t-butyl(meth)acrylamide, or N-isobutyl(meth)acrylamide; a dialkyl (having 2 to 8 carbon atoms in total) (meth)acrylamide such as N,N-dimethyl(meth)acrylamide, N,N-diethyl(meth)acrylamide, N,N-dimethylacrylamide, or N,N-diethylacrylamide; diacetone (meth)acrylamide; an N-vinyl cyclic amide such as N-vinylpyrrolidone; a (meth)acrylate having an alkyl (having 1 to carbon atoms) group such as methyl(meth)acrylate, ethyl(meth)acrylate, or n-butyl(meth)acrylate; and a (meth)acrylamide having a cyclic amide group such as N-(meth)acryloylmorpholine.

Examples of the vinyl monomer containing an anionic group include: carboxylic acid monomers each having a polymerizable unsaturated group such as (meth)acrylic acid, maleic acid, and itaconic acid and/or acid anhydrides thereof (in the case where two or more carboxyl groups are present in one monomer); sulfonic acid monomers each having a polymerizable unsaturated group such as styrenesulfonic acid and a 2-(meth)acrylamide-2-alkyl (having 1 to 4 carbon atoms) propanesulfonic acid; vinylphosphonic acid; and phosphoric acid monomers each having a polymerizable unsaturated group such as a (meth)acryloyloxyalkyl (having 1 to 4 carbon atoms) phosphoric acid.

The hydrophilic layer (L) may further contain any appropriate additive depending on purposes.

Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives that can be incorporated into the hydrophilic layer (L) can be appropriately set depending on purposes.

The hydrophilic layer (L) may be formed only of one layer, or may be formed of two or more layers.

The thickness of the hydrophilic layer (L) is preferably 0.1 to 100 μm, more preferably 1 to 100 μm. As long as the thickness of the hydrophilic layer (L) falls within the range, the layer can express extremely excellent hydrophilic property without impairing the flame retardancy of the environment-resistant functional flame-retardant polymer member of the present invention, and when its surface is stained with a contaminant, the contaminant can be easily washed out.

(1-5-8. Oil-Repellent Layer (L))

Any appropriate layer can be adopted as the oil-repellent layer (L) as long as an oil-repellent effect is obtained.

The oil-repellent layer (L) preferably contains an oil-repellent compound. The content of the oil-repellent compound in the oil-repellent layer (L) is preferably 1 to 100 wt %, more preferably 2 to 100 wt %, still more preferably 3 to 100 wt %.

Any appropriate oil-repellent compound can be adopted as the oil-repellent compound. Such oil-repellent compound is, for example, at least one kind selected from a fluorine-based resin and a fluorine-containing silane compound.

The fluorine-based resin is, for example, a fluorine-based resin that can be used as an oil-repellent agent. Examples of such fluorine-based resin include polytetrafluoroethylene, polychlorotrifluoroethylene, polyvinyl fluoride, polyvinylidene fluoride, a tetrafluoroethylene/hexafluoropropylene copolymer, and a chlorofluoroethylene/vinylidene fluoride copolymer.

The fluorine-containing silane compound is, for example, a fluorine-containing silane compound that can be used as an oil-repellent agent. Such fluorine-containing silane compound is, for example, such a fluorine-containing silane compound described in Japanese Patent Application Laid-open No. Hei 09-258003 as represented by the general formula (1). In the general formula (1), R_{f} represents a linear or branched perfluoroalkyl group having 1 to 16 carbon atoms, and preferred examples thereof include CF₃—, C₂F₅—, and C₃F₇—. X represents iodine or hydrogen. Y represents hydrogen or a lower alkyl group. R¹ representsa hydrolyzable group and preferred examples thereof include a halogen, —OR³, —OCOR³, —OC(R³)═C(R⁴)₂, —ON═C(R³)₂, and —ON═CR⁵ (provided that R³ represents an aliphatic hydrocarbon group or an aromatic hydrocarbon group, R⁴ represents hydrogen or a lower aliphatic hydrocarbon group, and R⁵ represents a divalent, aliphatic hydrocarbon group having 3 to 6 carbon atoms). More preferred examples of R¹ include chlorine, —OCH₃, and —OC₂H₅. R² represents hydrogen or an inert, monovalent organic group, preferably, for example, a monovalent hydrocarbon group having 1 to 4 carbon atoms. a, b, c, and d each represent an integer of 0 to 200, preferably 1 to 50. e represents 0 or 1. m and n each represent an integer of 0 to 2, preferably 0. p represents an integer of 1 or more, preferably an integer of 1 to 10. The molecular weight of the fluorine-containing silane compound represented by the general formula (1) is preferably 5×10² to 1×10⁵, more preferably 5×10² to 1×10⁴. A preferred structure of the fluorine-containing silane compound represented by the general formula (1) is, for example, a structure represented by a general formula (2). In the general formula (2), q represents an integer of 1 to 50, r represents an integer of 1 or more, preferably an integer of 1 to 10, and the other symbols are the same as those described in the general formula (1).

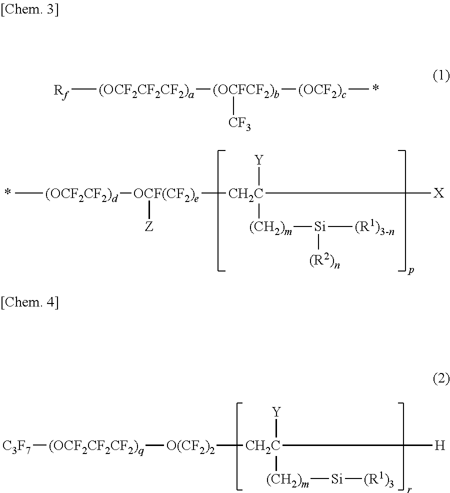

The number of kinds of the oil-repellent compounds in the oil-repellent layer (L) may be only one, or may be two or more.

The oil-repellent layer (L) may further contain any appropriate additive depending on purposes.

Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives that can be incorporated into the oil-repellent layer (L) can be appropriately set depending on purposes.

The oil-repellent layer (L) may be formed only of one layer, or may be formed of two or more layers.

The thickness of the oil-repellent layer (L) is preferably 0.1 to 100 μm, more preferably 1 to 100 μm. As long as the thickness of the oil-repellent layer (L) falls within the range, the layer can express extremely excellent oil-repellent property without impairing the flame retardancy of the environment-resistant functional flame-retardant polymer member of the present invention, and when its surface is stained with an oily contaminant, the oily contaminant can be easily removed.

<1-6. Hygienic Functional Layer (L)>

Any appropriate layer can be adopted as the hygienic functional layer (L) as long as the layer can express hygienic functionality. Preferred examples of such hygienic functional layer (L) include an antibacterial layer (L), an antifungal layer (L), and a deodorant layer (L).

The thickness of the hygienic functional layer: (L) is preferably 0.1 to 100 μm, more preferably 1 to 100 μm. As long as the thickness of the hygienic functional layer (L) falls within the range, the layer can express sufficient hygienic functionality without impairing the flame retardancy of the hygienic functional flame-retardant polymer member of the present invention.

(1-6-1. Antibacterial Layer (L))

Any appropriate layer can be adopted as the antibacterial layer (L) as long as an antibacterial effect is obtained.

The antibacterial layer (L) preferably contains an antibacterial agent. Any appropriate antibacterial agent can be adopted as the antibacterial agent. The content of the antibacterial agent in the antibacterial layer (L) is preferably 0.05 to 20 wt %, more preferably 0.1 to 15 wt %, still more preferably 0.5 to 10 wt %. As long as the content of the antibacterial agent in the antibacterial layer (L) falls within the range, the layer can express extremely excellent antibacterial property without impairing the flame retardancy of the hygienic functional flame-retardant polymer member of the present invention.

The antibacterial agent is preferably such that a metal component is carried on an inorganic powder. The carrying amount of the metal component is preferably 0.1 to 30 wt %, more preferably 0.5 to 20 wt %, still more preferably 1 to 10 wt % in terms of a content in the antibacterial agent. As long as the carrying amount of the metal component falls within the range, the antibacterial layer can express extremely excellent antibacterial property without impairing the flame retardancy of the hygienic functional flame-retardant polymer member of the present invention.

Any appropriate inorganic powder can be adopted as the inorganic powder. The inorganic powder is preferably at least one kind selected from zeolite, silica gel, titanium oxide, and aluminum oxide.

Any appropriate metal component can be adopted as the metal component. The metal component is preferably at least one kind selected from silver, copper, zinc, tin, bismuth, cadmium, chromium, and mercury.

The antibacterial layer (L) is more preferably a resin composition containing an antibacterial agent. A resin in such resin composition is, for example: a thermosetting resin such as a phenol-based resin, a urea-based resin, a melamine-based resin, an alkyd-based resin, a diallyl phthalate-based resin, an epoxy-based resin, a polyurethane-based resin, or a silicon-based resin; a resin such as a polyvinyl chloride-based resin, a polyvinylidene chloride-based resin, a fluorine-based resin, a polyvinyl fluoride-based resin, a polyvinylidene fluoride-based resin, a polyvinyl acetate-based resin, a polyvinyl alcohol-based resin, a polyvinyl formal-based resin, a saturated polyester-based resin, a polyethylene-based resin, a polypropylene-based resin, a polystyrene-based resin, an ABS-based resin, an acrylic resin, a polyamide-based resin, a polyacetal-based resin, a chlorinated polyether-based resin, a polycarbonate-based resin, a polyallylate-based resin, ethylcellulose, cellulose acetate, or cellulose nitrate; or an elastomer or rubber such as a natural rubber, an isoprene-based rubber, an acrylonitrile-based rubber, an acrylic rubber, a butadiene-based rubber, a butyl-based rubber, a styrene-based rubber, a chloroprene-based rubber, a chlorohydrin-based rubber, a polyolefin-based rubber, a urethane-based rubber, a polysulfide rubber, a silicone-based rubber, a fluorine-based rubber, or a fluorosilicone-based rubber.

The antibacterial layer (L) may further contain any appropriate additive depending on purposes.

Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives that can be incorporated into the antibacterial layer (L) can be appropriately set depending on purposes.

The antibacterial layer (L) may be formed only of one layer, or may be formed of two or more layers.

The thickness of the antibacterial layer (L) is preferably 0.1 to 100 μm, more preferably 1 to 100 μm. As long as the thickness of the antibacterial layer (L) falls within the range, the layer can express extremely excellent antibacterial property without impairing the flame retardancy of the hygienic functional flame-retardant polymer member of the present invention.

(1-6-2. Antifungal Layer (L))

Any appropriate layer can be adopted as the antifungal layer (L) as long as an antifungal effect is obtained.

The antifungal layer (L) preferably contains an antifungal agent. Any appropriate antifungal agent can be adopted as the antifungal agent. The content of the antifungal agent in the antifungal layer (L) is preferably 0.05 to 20 wt %, more preferably 0.1 to 15 wt %, still more preferably 0.5 to 10 wt %. As long as the content of the antifungal agent in the antifungal layer (L) falls within the range, the layer can express extremely excellent antifungal property without impairing the flame retardancy of the hygienic functional flame-retardant polymer member of the present invention.

The antifungal agent is preferably at least one kind selected from an organic antifungal agent and an inorganic antifungal agent.

Any appropriate organic antifungal agent can be adopted as the organic antifungal agent. The organic antifungal agent is preferably at least one kind selected from a thiocarbamate-based compound, a dithiocarbamate-based compound, an allylamine-based compound, an imidazole-based compound, a triazole-based compound, a thiazolone-based compound, a tropolone-based compound, and an organic acid-based compound. Examples of the thiocarbamate-based compound and the dithiocarbamate-based compound include tolnaftate, tolciclate, thiram (tetramethylthiuram disulfide), ferbam, ziram, zineb, maneb, and polycarbamate. Examples of the allylamine-based compound include butenafine. Examples of the imidazole-based compound include imidazole compounds each having a substituent (such as benzimidazole having a thiazolyl group, benzimidazole having a thiazolinyl group, and benzimidazole having a thiadiazolinyl group), clotrimazole, econazole, miconazole, tioconazole, bifonazole, sulconazole, croconazole, isoconazole, oxiconazole, and ketoconazole. Examples of the triazole-based compound include fluconazole. Examples of the thiazolone-based compound include 1,2-benzisothiazolin-3-one. Examples of the tropolone-based compound include hinokitiol. Examples of the organic acid-based compound include dehydroacetic acid, sorbic acid, propionic acid, and aromatic carboxylic acids (such as benzoic acid and a pyridonecarboxylic acid-based compound).

Any appropriate inorganic antifungal agent can be adopted as the inorganic antifungalagent. The inorganic antifungal agent is preferably at least one kind selected from a metal ion-based antifungal agent obtained by causing an inorganic compound to carry a metal ion, and a photocatalyst. Examples of the metal ion include silver, copper, and zinc. Examples of the inorganic compound include: silicic acid salts such as zeolite and silica gel; and phosphoric acid salts such as apatite.

The antifungal layer (L) is more preferably a resin composition containing an antifungal agent. A resin in such resin composition is, for example: a thermosetting resin such as a phenol-based resin, a urea-based resin, a melamine-based resin, an alkyd-based resin, a diallyl phthalate-based resin, an epoxy-based resin, a polyurethane-based resin, or a silicon-based resin; a resin such as a polyvinyl chloride-based resin, a polyvinylidene chloride-based resin, a fluorine-based resin, a polyvinyl fluoride-based resin, a polyvinylidene fluoride-based resin, a polyvinyl acetate-based resin, a polyvinyl alcohol-based resin, a polyvinyl formal-based resin, a saturated polyester-based resin, a polyethylene-based resin, a polypropylene-based resin, a polystyrene-based resin, an ABS-based resin, an acrylic resin, a polyamide-based resin, a polyacetal-based resin, a chlorinated polyether-based resin, a polycarbonate-based resin, a polyallylate-based resin, ethylcellulose, cellulose acetate, or cellulose nitrate; or an elastomer or rubber such as a natural rubber, an isoprene-based rubber, an acrylonitrile-based rubber, an acrylic rubber, a butadiene-based rubber, a butyl-based rubber, a styrene-based rubber, a chloroprene-based rubber, a chlorohydrin-based rubber, a polyolefin-based rubber, a urethane-based rubber, a polysulfide rubber, a silicone-based rubber, a fluorine-based rubber, or a fluorosilicone-based rubber.

The antifungal layer (L) may further contain any appropriate additive depending on purposes.

Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives that can be incorporated into the antifungal layer (L) can be appropriately set depending on purposes.

The antifungal layer (L) may be formed only of one layer, or may be formed of two or more layers.

The thickness of the antifungal layer (L) is preferably 0.1 to 100 μm, more preferably 1 to 100 μm. As long as the thickness of the antifungal layer (L) falls within the range, the layer can express extremely excellent antifungal property without impairing the flame retardancy of the hygienic functional flame-retardant polymer member of the present invention.

(1-6-3. Deodorant Layer (L))

Any appropriate layer can be adopted as the deodorant layer (L) as long as a deodorant effect is obtained.

The deodorant layer (L) preferably contains a deodorant. Any appropriate deodorant can be adopted as the deodorant. The content of the deodorant in the deodorant layer (L) is preferably 0.01 to 20 wt %, more preferably 0.1 to 15 wt %, still more preferably 0.5 to 10 wt %. As long as the content of the deodorant in the deodorant layer (L) falls within the range, the layer can express extremely excellent deodorant property without impairing the flame retardancy of the hygienic functional flame-retardant polymer member of the present invention.

The deodorant is preferably such that a metal component is carried on an inorganic powder. The carrying amount of the metal component is preferably 0.1 to 30 wt %, more preferably 0.5 to 20 wt %, still more preferably 1 to 20 wt % in terms of a content in the deodorant. As long as the carrying amount of the metal component falls within the range, the deodorant layer can express extremely excellent deodorant property without impairing the flame retardancy of the hygienic functional flame-retardant polymer member of the present invention.

Any appropriate inorganic powder can be adopted as the inorganic powder. The inorganic powder is preferably at least one kind selected from zeolite, silica gel, titanium oxide, aluminum oxide, and activated carbon.

Any appropriate metal component can be adopted as the metal component. The metal component is preferably at least one kind selected from silver, copper, zinc, tin, lead, bismuth, cadmium, chromium, and mercury.

The deodorant layer (L) may contain a resin. Examples of such resin include: a thermosetting resin such as a phenol-based resin, a urea-based resin, a melamine-based resin, an alkyd-based resin, a diallyl phthalate-based resin, an epoxy-based resin, a polyurethane-based resin, or a silicon-based resin; a resin such as a polyvinyl chloride-based resin, a polyvinylidene chloride-based resin, a fluorine-based resin, a polyvinyl fluoride-based resin, a polyvinylidene fluoride-based resin, a polyvinyl acetate-based resin, a polyvinyl alcohol-based resin, a polyvinyl formal-based resin, a saturated polyester-based resin, a polyethylene-based resin, a polypropylene-based resin, a polystyrene-based resin, an ABS-based resin, an acrylic resin, a polyamide-based resin, a polyacetal-based resin, a chlorinated polyether-based resin, a polycarbonate-based resin, a polyallylate-based resin, ethylcellulose, cellulose acetate, or cellulose nitrate; and an elastomer or rubber such as a natural rubber, an isoprene-based rubber, an acrylonitrile-based rubber, an acrylic rubber, a butadiene-based rubber, a butyl-based rubber, a styrene-based rubber, a chloroprene-based rubber, a chlorohydrin-based rubber, a polyolefin-based rubber, a urethane-based rubber, a polysulfide rubber, a silicone-based rubber, a fluorine-based rubber, or a fluorosilicone-based rubber.

The deodorant layer (L) may further contain any appropriate additive depending on purposes.

Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives that can be incorporated into the deodorant layer (L) can be appropriately set depending on purposes.

The deodorant layer (L) may be formed only of one layer, or may be formed of two or more layers.

The thickness of the deodorant layer (L) is preferably 0.1 to 100 μm, more preferably 1 to 100 μm. As long as the thickness of the deodorant layer (L) falls within the range, the layer can express extremely excellent deodorant property without impairing the flame retardancy of the hygienic functional flame-retardant polymer member of the present invention.

<1-7. Environment-Resistant Functional Flame-Retardant Polymer Member>

The thickness of the entirety of the environment-resistant functional flame-retardant polymer member is preferably 10 to 5,000 μm, more preferably 20 to 4,000 μm, still more preferably 30 to 3,000 μm because of the following reasons. When the thickness is excessively small, the member may not show sufficient flame retardancy. When the thickness is excessively large, the member is hard to wind in a sheet shape and is hence poor in handleability in some cases. It should be noted that the thickness of the entirety of the environment-resistant functional flame-retardant polymer member means the total of the thickness of the flame-retardant layer (A), the thickness of the polymer layer (B), and the thickness of the environment-resistant functional layer (L).

In addition, the ratio of the thickness of the flame-retardant layer (A) to the thickness of the entirety of the environment-resistant functional flame-retardant polymer member (the total of the thickness of the flame-retardant layer (A), the thickness of the polymer layer (B), and the thickness of the environment-resistant functional layer (L)) is preferably 50% or less, more preferably 50 to 0.1%, still more preferably 40 to 1%. When the ratio of the thickness of the flame-retardant layer (A) deviates from the range, its flame retardancy may be problematic or the strength of the flame-retardant layer (A) may be problematic.

<1-8. Hygienic Functional Flame-Retardant Polymer Member>

The thickness of the entirety of the hygienic functional flame-retardant polymer member is preferably 10 to 5,000 μm, more preferably 20 to 4,000 μm, still more preferably 30 to 3,000 μm because of the following reasons. When the thickness is excessively small, the member may not show sufficient flame retardancy. When the thickness is excessively large, the member is hard to wind in a sheet shape and is hence poor in handleability in some cases. It should be noted that the thickness of the entirety of the hygienic functional flame-retardant polymer member means the total of the thickness of the flame-retardant layer (A), the thickness of the polymer layer (B), and the thickness of the hygienic functional layer (L).

In addition, the ratio of the thickness of the flame-retardant layer (A) to the thickness of the entirety of the hygienic functional flame-retardant polymer member (the total of the thickness of the flame-retardant layer (A), the thickness of the polymer layer (B), and the thickness of the hygienic functional layer (L)) is preferably 50% or less, more preferably 50 to 0.1%, still more preferably 40 to 1%. When the ratio of the thickness of the flame-retardant layer (A) deviates from the range, its flame retardancy may be problematic or the strength of the flame-retardant layer (A) may be problematic.

<1-9. Flame Retardancy of Environment-Resistant Functional Flame-Retardant Polymer Member>

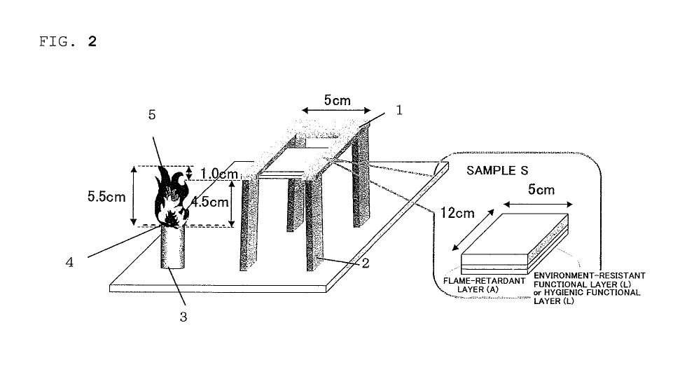

The environment-resistant functional flame-retardant polymer member of the present invention preferably satisfies the following flame retardancy. That is, in a horizontal firing test involving horizontally placing the environment-resistant functional flame-retardant polymer member of the present invention with its side of the environment-resistant functional layer (L) as a lower surface so that the lower surface is in contact with air, placing a Bunsen burner so that the flame port of the Bunsen burner is positioned at a lower portion distant from the lower surface on the side of the environment-resistant functional layer (L) by 45 mm, and bringing the flame of the Bunsen burner having a height of 55 mm from the flame port into contact with the lower surface of the environment-resistant functional layer (L) for 30 seconds, the member has flame retardancy capable of blocking the flame. The horizontal firing test is a test for blocking property against a flame from the side of the environment-resistant functional layer (L) of the oil-repellent flame-retardant polymer member. Therefore, in the horizontal firing test, the flame of the Bunsen burner is brought into contact from the side of the environment-resistant functional layer (L) while being prevented from being in contact with the end portion of the environment-resistant functional flame-retardant polymer member. In ordinary cases, the test is performed by placing the Bunsen burner so that the flame of the Bunsen burner is in contact with a site distant from each of all end portions of the environment-resistant functional flame-retardant polymer member by at least 50 mm or more. Any appropriate size can be adopted as the size of the environment-resistant functional flame-retardant polymer member to be subjected to the horizontal firing test. For example, a rectangle measuring 5 to 20 cm wide by 10 to 20 cm long can be used as the size of the environment-resistant functional flame-retardant polymer member. In FIG. 2 and Examples, a member of a rectangular shape measuring 5 cm by 12 cm is used.

The horizontal firing test is specifically performed as described below. As illustrated in FIG. 2, both sides of a rectangular, environment-resistant functional flame-retardant polymer member S are each horizontally fixed by two upper and lower supporting plates 1 with the side of the environment-resistant functional layer (L) of the rectangle as a lower surface. With regard to the supporting plates 1, both sides in the lengthwise direction of the lower supporting plate 1 are provided with columns 2 so that the lower surface of the environment-resistant functional flame-retardant polymer member S is in contact with air and a Bunsen burner 3 can be placed. In FIG. 2, the rectangular, environment-resistant functional flame-retardant polymer member S measuring 5 cm by 12 cm is used, and each side of the member having a length of 12 cm is fixed by the supporting plates 1 (each having a width of 10 cm). The Bunsen burner 3 is placed so that a distance between its flame port 4 and the lower surface of the environment-resistant functional flame-retardant polymer member S is 45 mm. In addition, the flame port 4 of the Bunsen burner 3 is positioned below the center of the environment-resistant functional flame-retardant polymer member S. The height of the flame of the Bunsen burner 3 from the flame port is adjusted to 55 mm. Although the Bunsen burner 3 is positioned below the flame-retardant polymer member S, the Bunsen burner 3 is illustrated outside the supporting plates 1 in FIG. 2 for convenience.

The test for flame retardancy can evaluate the flame-blocking property of the environment-resistant functional flame-retardant polymer member and the shape-maintaining property of the flame-retardant polymer member when the flame of the Bunsen burner having a size of 1 cm (a difference between the height of the flame from the flame port 4 of the Bunsen burner 3, i.e., 55 mm, and a distance between the lower surface on the side of the environment-resistant functional layer (L) and the flame port 4 of the Bunsen burner 3, i.e., 45 mm) is brought into contact for 30 seconds. A propane gas is used as the gas of the Bunsen burner and the test is performed in the air.

As described in Examples, the environment-resistant functional flame-retardant polymer member can be evaluated for its flame-blocking property by: placing a White Economy 314-048 (manufactured by Biznet) as copy paper at a position 3 mm above the environment-resistant functional flame-retardant polymer member S (above the upper supporting plate 1 on both sides); and observing the presence or absence of the combustion of the copy paper in the horizontal firing test.

<1-10. Flame Retardancy of Hygienic Functional Flame-Retardant Polymer Member>

The hygienic functional flame-retardant polymer member of the present invention preferably satisfies the following flame retardancy. That is, in a horizontal firing test involving horizontally placing the hygienic functional flame-retardant polymer member of the present invention with its side of the hygienic functional layer (L) as a lower surface so that the lower surface is in contact with air, placing a Bunsen burner so that the flame port of the Bunsen burner is positioned at a lower portion distant from the lower surface on the side of the hygienic functional layer (L) by 45 mm, and bringing the flame of the Bunsen burner having a height of 55 mm from the flame port into contact with the lower surface of the hygienic functional layer (L) for 30 seconds, the member has flame retardancy capable of blocking the flame. The horizontal firing test is a test for blocking property against a flame from the side of the hygienic functional layer (L) of the oil-repellent flame-retardant polymer member. Therefore, in the horizontal firing test, the flame of the Bunsen burner is brought into contact from the side of the hygienic functional layer (L) while being prevented from being in contact with the end portion of the hygienic functional flame-retardant polymer member. In ordinary cases, the test is performed by placing the Bunsen burner so that the flame of the Bunsen burner is in contact with a site distant from each of all end portions of the hygienic functional flame-retardant polymer member by at least 50 mm or more. Any appropriate size can be adopted as the size of the hygienic functional flame-retardant polymer member to be subjected to the horizontal firing test. For example, a rectangle measuring 5 to 20 cm wide by 10 to 20 cm long can be used as the size of the hygienic functional flame-retardant polymer member. In FIG. 2 and Examples, a member of a rectangular shape measuring 5 cm by 12 cm is used.

The horizontal firing test is specifically performed as described below. As illustrated in FIG. 2, both sides of a rectangular, hygienic functional flame-retardant polymer member S are each horizontally fixed by two upper and lower supporting plates 1 with the side of the hygienic functional layer (L) of the rectangle as a lower surface. With regard to the supporting plates 1, both sides in the lengthwise direction of the lower supporting plate 1 are provided with columns 2 so that the lower surface of the hygienic functional flame-retardant polymer member S is in contact with air and a Bunsen burner 3 can be placed. In FIG. 2, the rectangular, hygienic functional flame-retardant polymer member S measuring 5 cm by 12 cm is used, and each side of the member having a length of 12 cm is fixed by the supporting plates 1 (each having a width of 10 cm). The Bunsen burner 3 is placed so that a distance between its flame port 4 and the lower surface of the hygienic functional flame-retardant polymer member S is 45 mm. In addition, the flame port 4 of the Bunsen burner 3 is positioned below the center of the hygienic functional flame-retardant polymer member S. The height of the flame of the Bunsen burner 3 from the flame port is adjusted to 55 mm. Although the Bunsen burner 3 is positioned below the flame-retardant polymer Member S, the Bunsen burner 3 is illustrated outside the supporting plates 1 in FIG. 2 for convenience.

The test for flame retardancy can evaluate the flame-blocking property of the hygienic functional flame-retardant polymer member and the shape-maintaining property of the flame-retardant polymer member when the flame of the Bunsen burner having a size of 1 cm (a difference between the height of the flame from the flame port 4 of the Bunsen burner 3, i.e., 55 mm, and a distance between the lower surface on the side of the hygienic functional layer (L) and the flame port 4 of the Bunsen burner 3, i.e., 45 mm) is brought into contact for 30 seconds. A propane gas is used as the gas of the Bunsen burner and the test is performed in the air.

As described in Examples, the hygienic functional flame-retardant polymer member can be evaluated for its flame-blocking property by: placing a White Economy 314-048 (manufactured by Biznet) as copy paper at a position 3 mm above the hygienic functional flame-retardant polymer member S (above the upper supporting plate 1 on both sides); and observing the presence or absence of the combustion of the copy paper in the horizontal firing test.

<1-11. Transparency>

Each of the environment-resistant functional flame-retardant polymer member of the present invention and the hygienic functional flame-retardant polymer member of the present invention is preferably substantially transparent, and has a total light transmittance of preferably 60% or more, more preferably 70% or more, still more preferably 80% or more, particularly preferably 90% or more. Further, its haze is preferably 20% or less, more preferably 10% or less, still more preferably 5% or less.

<1-12. Flexibility>

Each of the environment-resistant functional flame-retardant polymer member of the present invention and the hygienic functional flame-retardant polymer member of the present invention has flexibility peculiar to plastic. For example, in the case where no flaw or crack occurs even when both ends of aside having a length of 5 cm of the environment-resistant functional flame-retardant polymer member or hygienic functional flame-retardant polymer member measuring 5 cm by 10 cm are repeatedly brought into contact with each other 50 times by bending the side in a mountain fold manner and in a valley fold manner, the member can be judged to have good flexibility. In addition, in the case where no flaw or crack occurs in the environment-resistant functional flame-retardant polymer member or hygienic functional flame-retardant polymer member measuring 5 cm by 10 cm when the environment-resistant functional flame-retardant polymer member or hygienic functional flame-retardant polymer member measuring 5 cm by 10 cm is wound around a rod having a diameter of 1 cm and then the wound flame-retardant polymer member is peeled, the member can be judged to have good flexibility.

<1-13. Photocatalytic Property>

When the environment-resistant functional layer (L) is the photocatalyst layer (L), the environment-resistant functional flame-retardant polymer member of the present invention has excellent photocatalytic property. For example, as described in Examples, an evaluation for the photocatalytic property can be performed by measuring a degree of reduction in concentration due to photoirradiation in the case where the environment-resistant functional flame-retardant polymer member of the present invention is placed in an acetaldehyde gas atmosphere. As the photocatalytic flame-retardant polymer member of the present invention has excellent photocatalytic property, when the member is used for, for example, a building member such as glass or an outer wall or inner wall of a building, a side mirror of an automobile or an automobile coating, a sound-proof wall for an expressway, an antibacterial tile, or an air cleaner, the member can express high antifouling property, high dust-proof property, high cleaning property, high antibacterial property, or high organic matter degradability.

<1-14. Antifouling Property>

When the environment-resistant functional layer (L) is the antifouling layer (L), the environment-resistant functional flame-retardant polymer member of the present invention has excellent antifouling property. For example, as described in Examples, an evaluation for the antifouling property can be performed by causing a stain to adhere to the member, leaving the member to stand for a predetermined period of time, followed by washing with water, and visually observing its surface for a degree of contamination.

<1-15. Moisture-Conditioning Property>

When the environment-resistant functional layer (L) is the moisture-conditioning layer (L), the environment-resistant functional flame-retardant polymer member of the present invention has excellent moisture-conditioning property. For example, as described in Examples, an evaluation for the moisture-conditioning property can be performed by evaluating a degree of dew condensation in the case where the member is exposed to such an environment that dew condensation can occur.

<1-16. Moisture-Preventing Property>

When the environment-resistant functional layer (L) is the moisture-preventing layer (L), the environment-resistant functional flame-retardant polymer member of the present invention has excellent moisture-preventing property. For example, as described in Examples, an evaluation for the moisture-preventing property can be performed by evaluating a water vapor transmission rate using a water vapor transmission rate measuring apparatus.

<1-17. Water Resistance>

When the environment-resistant functional layer (L) is the water-resistant layer (L), the environment-resistant functional flame-retardant polymer member of the present invention has excellent water resistance, and hence its surface hardly deteriorates even when exposed to moisture. For example, as described in Examples, an evaluation for the water resistance can be performed by evaluating a degree of surface deterioration in the case where the member is placed under such an environment that the member is exposed to moisture.

<1-18. Water Repellency>

When the environment-resistant functional layer (L) is the water-repellent layer (L), the environment-resistant functional flame-retardant polymer member of the present invention has excellent water repellency, and hence when its surface is stained with a contaminant, the contaminant can be easily removed with water. For example, as described in Examples, an evaluation for the water repellency can be performed by evaluating the external appearance of the member that has been washed in the case where its surface is stained with a contaminant and the member is washed with water.

<1-19. Hydrophilicity>

When the environment-resistant functional layer (L) is the hydrophilic layer (L), the environment-resistant functional flame-retardant polymer member of the present invention has excellent hydrophilicity, and hence when its surface is stained with a contaminant, the contaminant can be easily washed out. For example, as described in Examples, an evaluation for the hydrophilicity can be performed by evaluating the external appearance of the member that has been washed in the case where its surface is stained with a contaminant and the member is washed with water.

<1-20. Oil Repellency>

When the environment-resistant functional layer (L) is the oil-repellent layer (L), the environment-resistant functional flame-retardant polymer member of the present invention has excellent oil repellency, and hence when its surface is stained with an oily contaminant, the oily contaminant can be easily removed. For example, as described in Examples, an evaluation for the oil repellency can be performed by evaluating a surface contact angle in the case where an oily liquid substance is placed on the surface of the member.

<1-21. Antibacterial Property>

When the hygienic functional layer (L) is the antibacterial layer (L), the hygienic functional flame-retardant polymer member of the present invention has excellent antibacterial property. For example, as described in Examples, an evaluation for the antibacterial property can be performed by measuring a bacterial count a predetermined time period after various bacteria have been caused to adhere to the member.

<1-22. Antifungal Property>

When the hygienic functional layer (L) is the antifungal layer (L), the hygienic functional flame-retardant polymer member of the present invention has excellent antifungal property. For example, as described in Examples, an evaluation for the antifungal property can be performed by the test for fungus resistance specified in JIS.

<1-23. Deodorant Property>

When the hygienic functional layer (L) is the deodorant layer (L), the hygienic functional flame-retardant polymer member of the present invention has excellent deodorant property. Hence, the member can make various adherends flame-retardant, and at the same time, can impart deodorant properties to the various adherends, by being flexibly attached to the various adherends. For example, as described in Examples, an evaluation for the deodorant property can be performed by measuring a gas concentration for a degree of reduction in odor in the case where the hygienic functional flame-retardant polymer member of the present invention is exposed to an acetic acid odor.

<<2. Production of Environment-Resistant Functional Flame-Retardant Polymer Member or Hygienic Functional Flame-Retardant Polymer Member>>

Any appropriate production method can be adopted as a method of producing the environment-resistant functional flame-retardant polymer member or hygienic functional flame-retardant polymer member of the present invention as long as, for example, a construction including the polymer layer (B), the flame-retardant layer (A), and the environment-resistant functional layer (L) or the hygienic functional layer (L) in the stated order is obtained. In the following description, the environment-resistant functional flame-retardant polymer member or hygienic functional flame-retardant polymer member of the present invention is sometimes referred to as “flame-retardant polymer member of the present invention”.

<2-1. Flame-Retardant Polymer Member Production Method (1)>

A production method (1) is preferably adopted as a method of producing the flame-retardant polymer member of the present invention because good flame retardancy is obtained. In the production method (1), the flame-retardant polymer member of the present invention is produced by a production method including the step of laminating a syrupy polymerizable composition layer (a) formed of a polymerizable composition (α) containing a polymerizable monomer (m) and the layered inorganic compound (f), and a solid monomer-absorbing layer (b) containing a polymer (p) and capable of absorbing the polymerizable monomer (m), followed by the performance of polymerization, and the step of producing the environment-resistant functional layer (L) or the hygienic functional layer (L).

According to the production method (1), the flame-retardant layer (A) and the polymer layer (B) can be obtained by: laminating the polymerizable composition layer (a) formed of the polymerizable composition (α) containing the polymerizable monomer (m) and the layered inorganic compound (f) incompatible with a polymer obtained by polymerizing the polymerizable monomer on at least one surface of the solid monomer-absorbing layer (b) containing the polymer (p) and capable of absorbing the polymerizable monomer (m); and then polymerizing the polymerizable monomer.

In the production method (1), as a result of the lamination, part of the polymerizable monomer (m) in the polymerizable composition layer (a) is absorbed by the monomer-absorbing layer (b), and at the same time, the layered inorganic compound (f) moves in the polymerizable composition layer (a). Accordingly, an unevenly distributed polymerizable composition layer (a1) is obtained, in which the layered inorganic compound (f) is unevenly distributed toward the side opposite to the monomer-absorbing layer (b). Then, the polymerizable monomer (m) in the unevenly distributed polymerizable composition layer (a1) and the polymerizable monomer (m) in the monomer-absorbing layer (b) are polymerized and cured. Thus, the flame-retardant layer (A) and the polymer layer (B) are obtained. An unevenly distributed portion (a21) of the layered inorganic compound (f) in an unevenly distributed polymer layer (a2) obtained by curing the unevenly distributed polymerizable composition layer (a1) corresponds to the flame-retardant layer (A). A non-unevenly distributed portion (a22) of the layered inorganic compound (f) in the unevenly distributed polymer layer (a2) and a cured monomer-absorbing layer (b2) formed by polymerizing a monomer-absorbing layer (b1) obtained by the absorption of the polymerizable monomer (m) by the monomer-absorbing layer (b) correspond to the polymer layer (B). In other words, a portion obtained by combining the non-unevenly distributed portion (a22) and the cured monomer-absorbing layer (b2) corresponds to the polymer layer (B).

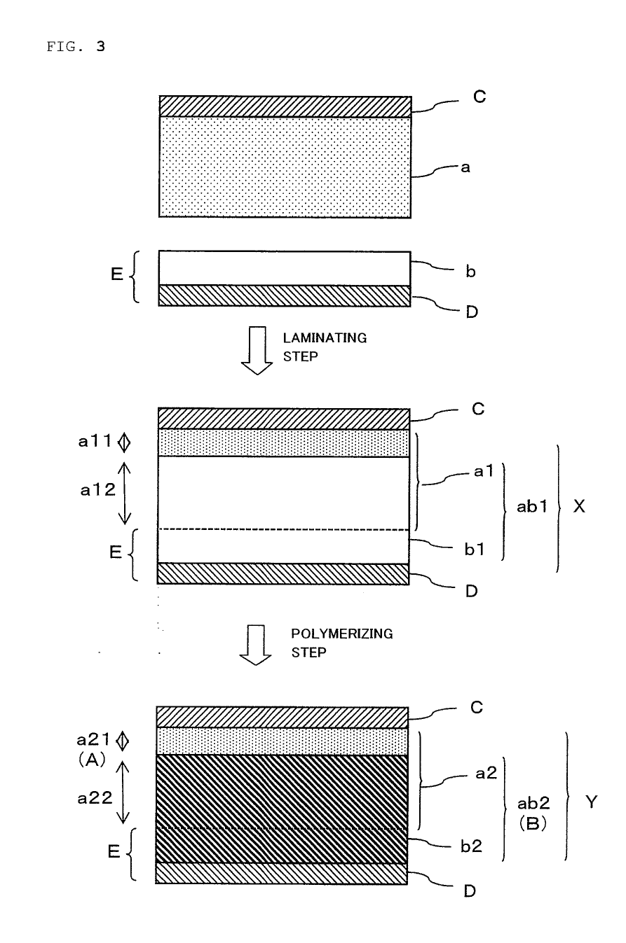

Hereinafter, the “step of laminating the syrupy polymerizable composition layer (a) formed of the polymerizable composition (α) containing the polymerizable monomer (m) and the layered inorganic compound (f), and the solid monomer-absorbing layer (b) containing the polymer (p) and capable of absorbing the polymerizable monomer (m), followed by the performance of polymerization” in the flame-retardant polymer member production method (1) is described with reference to FIG. 3.

First, in a laminating step (1), a laminate (X) is obtained by laminating the polymerizable composition layer (a) and the monomer-absorbing layer (b). The polymerizable composition layer (a) contains the layered inorganic compound (f) and the polymerizable monomer (m) (not shown). Although the polymerizable composition layer (a) can be laminated on at least one side of the monomer-absorbing layer (b), FIG. 3 illustrates the case where the layer is laminated only on one side of the monomer-absorbing layer (b). In FIG. 3, a cover film (C) is provided on the side of the polymerizable composition layer (a) not laminated on the monomer-absorbing layer (b). In addition, in FIG. 3, the monomer-absorbing layer (b) is provided on a base material film (D) and then the entirety is used as a monomer-absorbable sheet (E) with a base material.

In the laminate (X) obtained by the laminating step (1), part of the polymerizable monomer (m) in the polymerizable composition layer (a) is absorbed by the monomer-absorbing layer (b) (not shown). Meanwhile, in the polymerizable composition layer (a), the layered inorganic compound (f) moves, and the layered inorganic compound (f) is unevenly distributed toward the side opposite to the monomer-absorbing layer (b). Thus, the unevenly distributed polymerizable composition layer (a1) having an unevenly distributed portion (a11) and a non-unevenly distributed portion (a12) of the layered inorganic compound (f) is obtained. That is, as a result of the lamination of the polymerizable composition layer (a) and the monomer-absorbing layer (b), the polymerizable monomer (m) in the polymerizable composition layer (a) is absorbed by the monomer-absorbing layer (b), and the layered inorganic compound (f) is unevenly distributed toward the side opposite to the monomer-absorbing layer (b). Thus, the unevenly distributed polymerizable composition layer (a1) is obtained.

The phenomenon of the uneven distribution of the layered inorganic compound (f) in the unevenly distributed polymerizable composition layer (a1) is assumed to be caused by the swelling of the monomer-absorbing layer (b). That is, the monomer-absorbing layer (b) absorbs the polymerizable monomer (m) to swell. Meanwhile, the layered inorganic compound (f) is free of being absorbed by the monomer-absorbing layer (b). Accordingly, the layered inorganic compound (f) may be unevenly distributed in such a manner as to remain in the polymerizable composition layer (a). Therefore, when a base material that does not absorb the polymerizable monomer (m) is used as the monomer-absorbing layer (b), the base material does not swell with respect to the polymerizable monomer (m). Accordingly, even when the polymerizable composition layer (a) is laminated on the base material, the layered inorganic compound (f) is not unevenly distributed and hence the unevenly distributed polymerizable composition layer (a1) is not obtained.

In the flame-retardant polymer member production method (1), the laminate (X) can be subjected to a heating step. The unevenly distributed polymerizable composition layer (a1) including the unevenly distributed portion (a11) in which the layered inorganic compound (f) is unevenly distributed at a high density is obtained by the heating step. A heating temperature and a heating time for the laminate (X) are controlled in the heating step. When such heating step is performed, the monomer-absorbing layer (b) of the laminate (X) absorbs a larger amount of the polymerizable monomer (m) in the polymerizable composition layer (a) than that in the case where the laminating step (1) is merely performed, and hence high-density uneven distribution of the layered inorganic compound (f) becomes significant. As described above, the unevenly distributed portion (a11) in which the layered inorganic compound (f) is unevenly distributed at a high density is obtained by the heating step. Accordingly, even when the unevenly distributed polymerizable composition layer (a1) and the unevenly distributed polymer layer (a2) are thin layers, the layered inorganic compound (f) can be unevenly distributed with efficiency and hence a laminate (Y) having the thin-layered unevenly distributed polymer layer (a2) can be obtained.

The polymerizable monomer (m) in the polymerizable composition layer (a) is subjected to a polymerizing step (2) after part thereof has been absorbed by the monomer-absorbing layer (b). Accordingly, adhesiveness between the unevenly distributed polymer layer (a2) and the cured monomer-absorbing layer (b2) is excellent in the laminated structure of the unevenly distributed polymer layer (a2) and the cured monomer-absorbing layer (b2).

The monomer-absorbing layer (b1) in the laminate (X) is in a swollen state as a result of the absorption of the polymerizable monomer (m) by the monomer-absorbing layer (b). Accordingly, an interface between the non-unevenly distributed portion (a12) of the layered inorganic compound (f) in the unevenly distributed polymerizable composition layer (a1) and the monomer-absorbing layer (b1) cannot be observed (a composite site of these layers is represented as ab1 in FIG. 3). In FIG. 3, the interface is indicated by a broken line for convenience.

Next, the polymerizable monomer (m) in the unevenly distributed polymerizable composition layer (a1) is polymerized by subjecting the laminate (X) to a polymerizing step (2). Thus, the laminate (Y) including the unevenly distributed polymer layer (a2) is obtained. The unevenly distributed polymer layer (a2) is obtained by curing the unevenly distributed polymerizable composition layer (a1) while maintaining the unevenly distributed structure in the layer. The unevenly distributed polymer layer (a2) has the unevenly distributed portion (a21) of the layered inorganic compound (f) and the non-unevenly distributed portion (a22) of the layered inorganic compound (f).

The monomer-absorbing layer (b1) is turned into the cured monomer-absorbing layer (b2) by the polymerizing step (2). Although an interface between the non-unevenly distributed portion (a22) of the layered inorganic compound (f) in the unevenly distributed polymer layer (a2) and the cured monomer-absorbing layer (b2) cannot be observed in the laminate (Y) (a composite site of these layers is represented as ab2 in FIG. 3), the interface is indicated by a broken line in FIG. 3 for convenience.

The production method (1) includes the step of producing the environment-resistant functional layer (L) or the hygienic functional layer (L). The step of producing the environment-resistant functional layer (L) or the hygienic functional layer (L) (environment-resistant functional layer (L) or hygienic functional layer (L)-producing step (3)) can be performed at any appropriate timing in the production method (1).

(2-1-1. Laminating Step (1))

In the laminating step (1), a laminate having a structure “polymerizable composition layer (a)/monomer-absorbing layer (b)” is produced by laminating the polymerizable composition layer (a) on at least one side of the monomer-absorbing layer (b). The polymerizable composition layer (a) is a layer formed of the polymerizable composition (α).

(2-1-1-1. Polymerizable Composition (α))

The polymerizable composition (α) contains at least the polymerizable monomer (m) and the layered inorganic compound (f).

The polymerizable composition (α) may be a partially polymerized composition obtained by polymerizing part of the polymerizable monomer (m) in terms of, for example, handleability and application property.

The description of the polymerizable monomer in the section <1-1. Polymer layer (B)> can be cited as specific description of the polymerizable monomer (m).

When the flame-retardant polymer member is used in an application where pressure-sensitive adhesive property is demanded of the unevenly distributed polymer layer (a2), the content of an alkyl(meth)acrylate is preferably 70 wt % or more, more preferably 80 wt % or more with respect to the total amount of the polymerizable monomer (m).

When an oil-repellent flame-retardant polymer member is used in an application where hard physical property is demanded of the unevenly distributed polymer layer (a2) (e.g., a film application), the content of an alkyl(meth)acrylate is preferably 95 wt % or less, more preferably 0.01 to 95 wt %, still more preferably 1 to 70 wt % with respect to the total amount of the polymerizable monomer (m).

When the flame-retardant polymer member is used in an application where pressure-sensitive adhesive property is demanded of the unevenly distributed polymer layer (a2), the content of a polyfunctional monomer is preferably 2 wt % or less, more preferably 0.01 to 2 wt %, still more preferably 0.02 to 1 wt % with respect to the total amount of the polymerizable monomer (m). When the content of the polyfunctional monomer exceeds 2 wt % with respect to the total amount of the polymerizable monomer (m), there may arise a problem in that the cohesive strength of a flame-retardant polymer member to be obtained becomes excessively high and the member becomes excessively brittle. In addition, when the content of the polyfunctional monomer is less than 0.01 wt % with respect to the total amount of the polymerizable monomer (m), the purpose of the use of the polyfunctional monomer may not be achieved.

When the flame-retardant polymer member is used in an application where hard physical property is demanded of the unevenly distributed polymer layer (a2), the content of a polyfunctional monomer is preferably 95 wt % or less, more preferably 0.01 to 95 wt %, still more preferably 1 to 70 wt % with respect to the total amount of the polymerizable monomer (m). When the content of the polyfunctional monomer exceeds 95 wt % with respect to the total amount of the polymerizable monomer (m), curing shrinkage at the time of polymerization increases. Accordingly, it may become impossible to obtain a flame-retardant polymer member having a uniform film shape or sheet shape, or a flame-retardant polymer member to be obtained may become excessively brittle. In addition, when the content of the polyfunctional monomer is less than 0.01 wt % with respect to the total amount of the polymerizable monomer (m), it may become impossible to obtain a flame-retardant polymer member having sufficient solvent resistance and heat resistance.

When the flame-retardant polymer member is used in an application where pressure-sensitive adhesive property is demanded of the unevenly distributed polymer layer (a2), the content of a polar group-containing monomer is preferably 30 wt % or less, more preferably 1 to 30 wt %, still more preferably 2 to 20 wt % with respect to the total amount of the polymerizable monomer (m). When the content of the polar group-containing monomer exceeds 30 wt % with respect to the total amount of the polymerizable monomer (m), the cohesive strength of a polymer to be obtained may become excessively high, for example, the unevenly distributed polymer layer (a2) may become excessively hard, and the adhesiveness may reduce. In addition, when the content of the polar group-containing monomer is less than 1 wt % with respect to the total amount of the polymerizable monomer (m), the cohesive strength of a polymer to be obtained may reduce and a high shearing force may not be obtained.

When the flame-retardant polymer member is used in an application where hard physical property is demanded of the unevenly distributed polymer layer (a2), the content of a polar group-containing monomer is preferably 95 wt % or less, more preferably 0.01 to 95 wt %, still more preferably 1 to 70 wt % with respect to the total amount of the polymerizable monomer (m). When the content of the polar group-containing monomer exceeds 95 wt % with respect to the total amount of the polymerizable monomer (m), for example, environment-resistant functionality or hygienic functionality may become insufficient, which increases a change in quality of the flame-retardant polymer member due to a use environment (such as humidity or moisture). In addition, when the usage ratio of the polar group-containing monomer is 0.01 wt % or less with respect to the total amount of the polymerizable monomer (m), the addition amount of a (meth)acrylate having a high glass transition temperature (Tg) (such as isobornyl acrylate), a polyfunctional monomer, or the like is increased in the case of obtaining hard physical property, and a flame-retardant polymer member to be obtained may become excessively brittle.

The description in the section <1-3. Layered inorganic compound (f)> can be cited as specific description of the layered inorganic compound (f).

The polymerizable composition (α) may contain any appropriate additive. The description in the section <1-4. Additive> can be cited as specific description of such additive.

The polymerizable composition (α) can contain any appropriate polymerization initiator. Examples of the polymerization initiator include a photopolymerization initiator and a thermal polymerization initiator. The number of kinds of the polymerization initiators may be only one, or may be two or more.

As the photopolymerization initiator, any appropriate photopolymerization initiator may be adopted. Examples of the photopolymerization initiator include a benzoin ether-based photopolymerization initiator, an acetophenone-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzyl-based photopolymerization initiator, a benzophenone-based photopolymerization initiator, a ketal-based photopolymerization initiator, and a thioxanthone-based photopolymerization initiator. The number of kinds of the photopolymerization initiators may be only one, or may be two or more.

An example of the ketal-based photopolymerization initiator is 2,2-dimethoxy-1,2-diphenylethan-1-one (such as “Irgacure 651” (trade name; manufactured by Ciba Speciality Chemicals Inc.)). Examples of the acetophenone-based photopolymerization initiator include 1-hydroxycyclohexyl phenyl ketone (such as “Irgacure 184” (trade name; manufactured by Ciba Speciality Chemicals Inc.)), 2,2-diethoxyacetophenone, 2,2-dimethoxy-2-phenylacetophenone, 4-phenoxydichloroacetophenone, and 4-(t-butyl)dichloroacetophenone. Examples of the benzoin ether-based photopolymerization initiator include benzoin methyl ether, benzoin ethyl ether, benzoin propyl ether, benzoin isopropyl ether, and benzoin isobutyl ether. An example of the acylphosphine oxide-based photopolymerization initiator is “Lucirin TPO” (trade name; manufactured by BASF Japan Ltd.). Examples of the α-ketol-based photopolymerization initiator include 2-methyl-2-hydroxy propiophenone and 1-[4-(2-hydroxyethyl)phenyl]-2-methylpropan-1-one. An example of the aromatic sulfonyl chloride-based photopolymerization initiator is 2-naphthalenesulfonyl chloride. An example of the photoactive oxime-based photopolymerization initiator is 1-phenyl-1,1-propanedione-2-(o-ethoxycarbonyl)-oxime. An example of the benzoin-based photopolymerization initiator is benzoin. An example of the benzyl-based photopolymerization initiator is benzyl. Examples of the benzophenone-based photopolymerization initiator include benzophenone, benzoylbenzoic acid, 3,3′-dimethyl-4-methoxybenzophenone, polyvinyl benzophenone, and α-hydroxycyclohexyl phenyl ketone. Examples of the thioxanthone-based photopolymerization initiator include thioxanthone, 2-chlorothioxanthone, 2-methylthioxanthone, 2,4-dimethylthioxanthone, isopropylthioxanthone, 2,4-diisopropylthioxanthone, and dodecylthioxanthone.

The usage of the photopolymerization initiator is, for example, preferably 5 parts by weight or less, more preferably 0.01 to 5 parts by weight, still more preferably 0.05 to 3 parts by weight with respect to 100 parts by weight of the polymerizable monomer (m) in the polymerizable composition (α).

Examples of the thermal polymerization initiator include an azo-based polymerization initiator (such as 2,2′-azobisisobutyronitrile, 2,2′-azobis-2-methylbutyronitrile, 2,2′-azobis(2-methylpropionate)dimethyl, 4,4′-azobis-4-cyanovaleric acid, azobisisovaleronitrile, 2,2′-azobis(2-amidinopropane)dihydrochloride, 2,2′-azobis[2-(5-methyl-2-imidazolin-2-yl)propane]dihydrochlor ide, 2,2′-azobis(2-methylpropionamidine) disulfate, or 2,2′-azobis(N,N′-dimethyleneisobutylamidine)dihydrochloride), a peroxide-basedpolymerizationinitiator (suchasdibenzoylperoxide or tert-butyl permaleate), and a redox-based polymerization initiator (such as a combination of: an organic peroxide and a vanadium compound; an organic peroxide and dimethylaniline; or a metal naphthenate and butylaldehyde, aniline, or acetylbutyrolactone).

The usage of the thermal polymerization initiator is, for example, preferably 5 parts by weight or less, more preferably 0.01 to 5 parts by weight, still more preferably 0.05 to 3 parts by weight with respect to 100 parts by weight of the polymerizable monomer (m) in the polymerizable composition (α).

The use of a redox-based polymerization initiator as the thermal polymerization initiator enables the polymerization of the composition at normal temperature.

Whether or not a substance is a substance incompatible with a polymer can be judged by means of visual observation, an optical microscope, a scanning electron microscope (SEM), a transmission electron microscope (TEM), X-ray diffraction, or the like on the basis of the size of the substance or an aggregate thereof dispersed in the polymer in a general method (such as: a method involving dissolving the substance in a polymerizable monomer, polymerizing the polymerizable monomer to provide a polymer, and performing the judgment; a method involving dissolving the polymer in a solvent that dissolves the polymer, adding the substance to the solution, stirring the mixture, removing the solvent after the stirring, and performing the judgment; or a method involving heating the polymer, when the polymer is a thermoplastic polymer, to dissolve the polymer, compounding the substance into the dissolved polymer, cooling the mixture, and performing the judgment after the cooling). Criteria for the judgment are as described below. When the substance or the aggregate thereof can be approximated as a spherical shape such as a sphere, a cube, or an amorphous shape, the substance or the aggregate thereof should have a diameter of 5 nm or more. In addition, when the substance or the aggregate thereof can be approximated as a cylindrical shape such as a rod-like shape, a thin-layer shape, or a rectangular parallelepiped shape, the length of its longest side should be 10 nm or more.

Upon dispersion of the substance in the polymer, when the substance or the aggregate thereof in the polymer can be approximated as a spherical shape such as a sphere, a cube, or an amorphous shape, and the substance or the aggregate thereof which is of a spherical shape has a diameter of 5 nm or more, the substance can be regarded as being incompatible with the polymer. In addition, when the substance or the aggregate thereof in the polymer can be approximated as a cylindrical shape such as a rod-like shape, a thin-layer shape, or a rectangular parallelepiped shape, and the length of the longest side of the substance or the aggregate thereof which is of a cylindrical shape is 10 nm or more, the substance can be regarded as being incompatible with the polymer.

A method of dispersing the layered inorganic compound (f) in the polymerizable composition (α) is, for example, a method involving mixing the polymerizable monomer (m), the layered inorganic compound (f), and as required, any other component (such as a polymerization initiator), and uniformly dispersing the contents by means of ultrasonic dispersion or the like.

The content of the layered inorganic compound (f) in the polymerizable composition (α) is preferably 1 to 300 parts by weight, more preferably 3 to 200 parts by weight, still more preferably 5 to 100 parts by weight with respect to 100 parts by weight of the polymerizable monomer (m). When the content of the layered inorganic compound (f) exceeds 300 parts by weight with respect to 100 parts by weight of the polymerizable monomer (m), it may become difficult to produce the flame-retardant polymer member or a problem in that the strength of the flame-retardant polymer member after the production reduces may arise. When the content of the layered inorganic compound (f) is less than 1 part by weight with respect to 100 parts by weight of the polymerizable monomer (m), it may become hard to obtain the unevenly distributed polymerizable composition layer (a1) or the unevenly distributed polymer layer (a2) after the laminate has been obtained in the laminating step (1), or the unevenly distributed polymer layer (a2) may not have any flame retardancy.

Any appropriate content can be adopted as the content of the layered inorganic compound (f) in the polymerizable composition (α) depending on, for example, the kind of the layered inorganic compound (f). For example, when particles are used as the layered inorganic compound (f), the content of the layered inorganic compound (f) is preferably 0.001 to 70 parts by weight, more preferably 0.01 to 60 parts by weight, still more preferably 0.1 to 50 parts by weight with respect to 100 parts by weight of the polymerizable monomer (m). When the content of the layered inorganic compound (f) as particles is less than 0.001 part by weight with respect to the polymerizable monomer (m), it may become difficult to provide the entirety of the surface to be utilized of a surface uneven sheet with an uneven structure in an average manner. When the content of the layered inorganic compound (f) as particles exceeds 70 parts by weight with respect to the polymerizable Monomer (m), the particles may drop during the production of the surface uneven sheet or a problem in that the strength of the surface uneven sheet reduces may arise.

The polymerizable composition (α) is preferably provided with a moderate viscosity suitable for an application operation because the composition is typically formed into a sheet shape by, for example, being applied onto a base material. The viscosity of the polymerizable composition (α) can be adjusted by, for example, compounding any one of the various polymers such as an acrylic rubber and a thickening additive, or polymerizing part of the polymerizable monomer (m) in the polymerizable composition (a) through photoirradiation, heating, or the like. It should be noted that a desired viscosity is as described below. A viscosity set with a BH viscometer under the conditions of a rotor of a No. 5 rotor, a rotational frequency of 10 rpm, and a measurement temperature of 30° C. is preferably 5 to 50 Pa·s, more preferably 10 to 40 Pa·s. When the viscosity is less than 5 Pa·s, the liquid may flow when applied onto the base material. When the viscosity exceeds 50 Pa·s, the viscosity is so high that it may become difficult to apply the liquid.

(2-1-1-2. Polymerizable Composition Layer (a))

The polymerizable composition layer (a) is a layer formed of the polymerizable composition (α).

The polymerizable composition layer (a) is obtained by, for example, applying the polymerizable composition (α) onto a base material such as a PET film to form the composition into a sheet shape.

For the application of the polymerizable composition (α), any appropriate coater may be used, for example. Examples of such coater include a comma roll coater, a die roll coater, a gravure roll coater, a reverse roll coater, a kiss roll coater, a dip roll coater, a bar coater, a knife coater, and a spray coater.

The thickness of the polymerizable composition layer (a) is, for example, preferably 3 to 3,000 μm, more preferably 10 to 1,000 μm, still more preferably 20 to 500 μm. When the thickness of the polymerizable composition layer (a) is less than 3 μm, it may be unable to perform uniform application or the unevenly distributed polymer layer (a2) may not have any flame retardancy. On the other hand, when the thickness of the polymerizable composition layer (a) exceeds 3,000 μm, there is a possibility that waviness occurs in the flame-retardant polymer member and hence a smooth oil-repellent flame-retardant polymer member is not obtained.

(2-1-1-3. Monomer-Absorbing Layer (b))

The monomer-absorbing layer (b) is a layer capable of absorbing part of the polymerizable monomer (m) from the polymerizable composition layer (a). It is preferred that the monomer-absorbing layer (b) have a high affinity for the polymerizable monomer (m) and be capable of absorbing the polymerizable monomer (m) at a high rate. It should be noted that a surface provided by the monomer-absorbing layer (b) is referred to as “monomer-absorbing surface.”

The absorption of the polymerizable monomer (m) in the monomer-absorbing layer (b) occurs at the time point when a laminate having a structure “polymerizable composition layer (a)/monomer-absorbing layer (b)” is formed by the laminating step (1). The absorption of the polymerizable monomer (m) in the monomer-absorbing layer (b) occurs more effectively when the heating step is performed. It should be noted that the time point when the absorption of the polymerizable monomer (m) in the monomer-absorbing layer (b) occurs is not limited to any stage prior to the polymerizing step (2) and the absorption may occur at the stage of the polymerizing step (2).

The monomer-absorbing layer (b) can be such a sheet-shaped structure including that the monomer-absorbing surface of the monomer-absorbing layer (b) can be in contact with the polymerizable composition layer (a) (hereinafter, referred to as “monomer-absorbable sheet”).

Examples of the monomer-absorbable sheet include a monomer-absorbable sheet constituted only of the monomer-absorbing layer (b) (hereinafter, referred to as “base material-less monomer-absorbable sheet”) and a monomer-absorbable sheet obtained by providing the monomer-absorbing layer (b) on a base material (hereinafter, referred to as “monomer-absorbable sheet with a base material”). It should be noted that when the monomer-absorbable sheet is a base material-less monomer-absorbable sheet, each surface of the sheet may be used as a monomer-absorbing surface. In addition, when the monomer-absorbable sheet is a monomer-absorbable sheet with a base material, the surface on the side of the monomer-absorbing layer (b) serves as a monomer-absorbing surface.

The monomer-absorbing layer (b) contains the polymer (p). The content of the polymer (p) in the monomer-absorbing layer (b) is preferably 80 wt % or more, more preferably 90 wt % or more, still more preferably 95 wt % or more, particularly preferably 98 wt % or more, most preferably substantially 100 wt %. The number of kinds of the polymers (p) in the monomer-absorbing layer (b) may be only one, or may be two or more.

The description of the polymerizable monomer in the section <1-1. Polymer layer (B)> can be cited as specific description of a monomer component to be used for obtaining the polymer (p).

At least one of the monomer components to be used for obtaining the polymer (p) is preferably common to at least one of the polymerizable monomers (m) in the polymerizable composition (α).

The polymer (p) is preferably an acrylic resin obtained by polymerizing a monomer component containing an acrylic monomer.

The polymer (p) can be obtained by any appropriate polymerization method as long as the monomer component to be used for obtaining the polymer (p) can be polymerized by the method. The description of a polymerization method in a section (2-1-3. Polymerizing step (2)) to be described later can be cited as specific description of a preferred polymerization method.

The polymer (p) may be a polymer obtained by polymerizing a polymerizable composition having the same composition as that of the polymerizable composition (α) except that the layered inorganic compound (f) is removed from the polymerizable composition (α).

The monomer-absorbing layer (b) may contain any appropriate additive. The description in the section <1-4. Additive> can be cited as specific description of such additive.

The monomer-absorbing layer (b) may contain a flame retardant as in the polymer layer (B).

The monomer-absorbing layer (b1) in the laminate (X) preferably shows a weight 1.1 or more times as large as the weight of the monomer-absorbing layer (b) to be used in the laminating step (1) as a result of the absorption of the polymerizable monomer (m) in the polymerizable composition layer (a) by the monomer-absorbing layer (b). When the weight increase ratio as a result of the absorption of the polymerizable monomer (m) by the monomer-absorbing layer (b) becomes 1.1 or more, the layered inorganic compound (f) can be unevenly distributed in an effective manner. The weight increase ratio is more preferably 2 or more, still more preferably 3 or more, particularly preferably 4 or more. The weight increase ratio is preferably 50 or less in terms of the maintenance of the smoothness of the monomer-absorbing layer (b).

The weight increase ratio can be calculated as described below. After a lapse of the same time period as the time period from the immersion of the monomer-absorbing layer (b) in the polymerizable monomer (m) through the lamination of the polymerizable composition layer (a) on the monomer-absorbing layer (b) to the performance of the polymerizing step (2), and at the same temperature as the temperature at which the foregoing process is performed, the weight of the monomer-absorbing layer (b) is measured and then the ratio is calculated as a ratio of the weight after the absorption of the polymerizable monomer (m) to the weight before the absorption of the polymerizable monomer (m).

The volume of the monomer-absorbing layer (b) after the absorption of the polymerizable monomer (m) may be constant as compared with that before the absorption, or may change as compared with that before the absorption.

Any appropriate value can be adopted as the gel fraction of the monomer-absorbing layer (b). The flame-retardant polymer member of the present invention can be obtained irrespective of whether cross-linking has progressed to attain a gel fraction of about 98 wt % in the monomer-absorbing layer (b) or nearly no cross-linking has occurred in the layer (e.g., the gel fraction is 10 wt % or less).

Sufficient heat resistance and sufficient solvent resistance can be imparted to the polymer layer (B) in the flame-retardant polymer member to be obtained by providing the monomer-absorbing layer (b) with a high degree of cross-linking (such as a gel fraction of 90 wt % or more). Sufficient flexibility and sufficient stress-relaxing property can be imparted to the polymer layer (B) in the flame-retardant polymer member to be obtained by providing the monomer-absorbing layer (b) with a low degree of cross-linking (such as a gel fraction of 10 wt % or less).

The gel fraction can be calculated from, for example, a weight change amount when a measuring object is wrapped with a TEMISH (manufactured by, for example, Nitto Denko Corporation) as a mesh made of tetrafluoroethylene, the wrapped product is immersed in ethyl acetate for 1 week, and then the measuring object is dried.

The flame-retardant polymer member of the present invention can be obtained irrespective of whether the monomer-absorbing layer (b) is a hard layer or a soft layer. When a hard layer (such as a layer having a 100% modulus of 100 N/cm² or more) is used as the monomer-absorbing layer (b), the monomer-absorbing layer (b) can be used as a support (base material). When a soft layer (such as a layer having a 100% modulus of 30 N/cm² or less) is used as the monomer-absorbing layer (b), the monomer-absorbing layer (b) can be used as a pressure-sensitive adhesive layer.

Any appropriate thickness can be adopted as the thickness of the monomer-absorbing layer (b) before the absorption of the polymerizable monomer (m). The thickness of the monomer-absorbing layer (b) before the absorption of the polymerizable monomer (m) is, for example, preferably 1 to 3,000 μm, more preferably 2 to 2,000 μm, still more preferably 5 to 1,000 μm. When the thickness of the monomer-absorbing layer (b) before the absorption of the polymerizable monomer (m) is less than 1 μm, the monomer-absorbing layer (b) may deform in the case where the layer has absorbed a large amount of the polymerizable monomer (m), or the absorption of the polymerizable monomer (m) may not be sufficiently performed. When the thickness of the monomer-absorbing layer (b) before the absorption of the polymerizable monomer (m) exceeds 3,000 μm, there is a possibility that the flame-retardant polymer member to be finally obtained is hard to wind in a sheet shape and is hence poor in handleability.

The monomer-absorbing layer (b) may be a single layer, or may be a laminate of two or more layers.

The monomer-absorbing layer (b) can be produced by applying a composition as a material for forming the monomer-absorbing layer (b) (hereinafter, referred to as “monomer-absorbing layer (b)-forming composition”) onto a predetermined surface of any appropriate support such as a release-treated surface of a base material or cover film to be described later with any appropriate coater or the like. The monomer-absorbing layer (b)-forming composition applied onto the support is subjected to drying and/or curing (such as curing with light) as required.

The viscosity of the monomer-absorbing layer (b)-forming composition may be adjusted so as to be suitable for the application by any appropriate method.

Examples of the base material used when the monomer-absorbing layer (b) is a monomer-absorbable sheet with a base material (base material for a monomer-absorbable sheet) include: a paper-based base material such as paper; a fiber-based base material such as cloth, non-woven fabric, or net; a metal-based base material such as a metal foil or a metal plate; a plastic-based base material such as a plastic film or sheet; a rubber-based base material such as a rubber sheet; a foam body such as a foamed sheet; and a laminate thereof (such as a laminate of a plastic-based base material and any other base material or a laminate of plastic films (or sheets)). Such base material is preferably a plastic-based base material such as a plastic film or sheet. Examples of such plastic include: an olefin-based resin containing α-olefin as a monomer component such as a polyethylene (PE), a polypropylene (PP), an ethylene-propylene copolymer, or an ethylene-vinyl acetate copolymer (EVA); a polyester-based resin such as a polyethylene terephthalate (PET), a polyethylene naphthalate (PEN), or a polybutylene terephthalate (PBT); a polyvinyl chloride (PVC); a vinyl acetate-based resin; a polyphenylene sulfide (PPS); an amide-based resin such as a polyamide (nylon) or an all-aromatic polyamide (aramid); a polyimide-based resin; and a polyether ether ketone (PEEK). The number of kinds of such plastics may be only one, or may be two or more.

When the monomer-absorbing layer (b) is curable with an active energy ray, the base material for a monomer-absorbable sheet is preferably a sheet that does not inhibit the transmission of the active energy ray.

The surface of the base material for a monomer-absorbable sheet is preferably subjected to any appropriate surface treatment for improving its adhesiveness with the monomer-absorbing layer (b). Examples of such surface treatment include: an oxidation treatment by a chemical or physical method such as a corona treatment, a chromic acid treatment, ozone exposure, flame exposure, high-voltage electric shock exposure, or an ionizing radiation treatment; and a coating treatment with an undercoating agent, a releasing agent, or the like.

Any appropriate thickness can be adopted as the thickness of the base material for a monomer-absorbable sheet depending on, for example, its strength, flexibility, and intended use. The thickness of the base material for a monomer-absorbable sheet is, for example, preferably 400 μm or less, more preferably 1 to 350 μm, still more preferably 10 to 300 μm.

The base material for a monomer-absorbable sheet may be a single layer, or may be a laminate of two or more layers.

(2-1-1-4. Laminate (X))

The laminate (X) is obtained by laminating the polymerizable composition layer (a) and the monomer-absorbing layer (b). A method of obtaining the laminate (X) is, for example, a method involving applying the polymerizable composition (α) to the monomer-absorbing surface of the monomer-absorbing layer (b) to form the polymerizable composition layer (a), or a method involving applying the polymerizable composition (α) onto any appropriate support to form the syrupy polymerizable composition layer (a) and then transferring the polymerizable composition layer (a) onto the monomer-absorbing layer (b).

The ratio of the thickness of the polymerizable composition layer (a) to the thickness of the monomer-absorbing layer (b) is preferably 300% or less, more preferably 200% or less, still more preferably 100% or less. When the ratio of the thickness of the polymerizable composition layer (a) to the thickness of the monomer-absorbing layer (b) exceeds 300%, it may become difficult to produce the flame-retardant polymer member or a problem in that the strength of the flame-retardant polymer member after the production reduces may arise. As the ratio of the thickness of the polymerizable composition layer (a) to the thickness of the monomer-absorbing layer (b) reduces, the ease with which the layered inorganic compound (f) is unevenly distributed is improved, and hence the layered inorganic compound (f) can be unevenly distributed in the unevenly distributed polymerizable composition layer (a1) at a higher density. It should be noted that the ratio of the thickness of the polymerizable composition layer (a) to the thickness of the monomer-absorbing layer (b) is preferably set to 1% or more because the layer can be uniformly produced.

(2-1-1-5. Cover Film)

Upon production of the laminate (X), a cover film can be used as the support of the polymerizable composition layer (a). The cover film may have peelability. It should be noted that when a photopolymerization reaction is used in the polymerizing step (2), oxygen in the air is preferably blocked with the cover film in the polymerizing step (2) because the reaction is inhibited by oxygen in the air.

As the cover film, any appropriate cover film may be adopted as long as the cover film is a thin sheet which has low oxygen permeation. When a photopolymerization reaction is used, a preferred cover film is a transparent film such as any appropriate release paper. Specific examples of the cover film include a base material having a layer release-treated (peel-treated) with a release treatment agent (a peel treatment agent) on at least one of its surfaces, a low-adhesive base material formed of a fluorine-based polymer (such as a polytetrafluoroethylene, a polychlorotrifluoroethylene, a polyvinyl fluoride, a polyvinylidene fluoride, a copolymer of tetrafluoroethylene and hexafluoropropylene, or a copolymer of chlorofuluoroethylene and vinylidene fluoride), and a low-adhesive base material formed of a non-polar polymer (such as an olefin-based resin such as a polyethylene or a polypropylene). The surface of a release-treated layer of the base material having the release-treated layer on at least one of its surfaces may be used as a release surface. Each of both surfaces of the low-adhesive base material may be used as a release surface.

Examples of the base material that can be used in the base material having a release-treated layer on at least one of its surfaces include: a plastic-based base material film such as a polyester film (such as a polyethylene terephthalate film), an olefin-based resin film (such as a polyethylene film or a polypropylene film), a polyvinyl chloride film, a polyimide film, a polyamide film (nylon film), and a rayon film; papers (such as woodfree paper, Japanese paper, kraft paper, glassine paper, synthetic paper, and top coated paper); and a multi-layered laminate obtained by lamination or co-extrusion thereof (laminate of 2 to 3 layers). As such base material, a plastic-based base material film having high transparency is preferred, and a polyethylene terephthalate film is particularly preferred.

A release treatment agent that can be used in the base material having a release-treated layer on at least one of its surfaces is, for example, a silicone-based release treatment agent, a fluorine-based release treatment agent, or a long-chain alkyl-based release treatment agent. Only one kind of the release treatment agents may be used, or two or more kinds thereof may be used.

Any appropriate thickness can be adopted as the thickness of the cover film. The thickness of the cover film is, for example, preferably 12 to 250 μm, more preferably 20 to 200 μm in terms of handleability and economical efficiency.

The cover film may be a single layer, or may be a laminate of two or more layers.

(2-1-2. Heating Step)

In the production method (1), the laminate (X) obtained by laminating the polymerizable composition layer (a) and the monomer-absorbing layer (b) can be subjected to a heating step before being subjected to the polymerizing step (2). As a result of the heating step, the layered inorganic compound (f) can be unevenly distributed in the unevenly distributed polymerizable composition layer (a1) at an additionally high density, and hence such a flame-retardant polymer member that the distribution of the layered inorganic compound (f) in the unevenly distributed polymer layer (a2) is made additionally dense can be obtained.

The heating temperature is preferably 25° C. or more and 100° C. or less, more preferably 30° C. or more and 90° C. or less, still more preferably 40° C. or more and 80° C. or less, particularly preferably 50° C. or more and 80° C. or less. The time for the heating step is preferably 1 second or more and 120 minutes or less, more preferably 10 seconds or more and 60 minutes or less, still more preferably 1 minute or more and 30 minutes or less. In particular, a flame-retardant polymer member having a higher density can be obtained as the temperature increases in the heating temperature range or as the time for the heating step lengthens in the range of the time for the heating step. When the heating temperature is less than 25° C., the polymerizable monomer (m) may not be sufficiently absorbed by the monomer-absorbing layer (b). When the heating temperature exceeds 100° C., the polymerizable monomer (m) may volatilize or the cover filmmay deform. When the time for the heating step is less than 1 second, it may become difficult to perform the step. When the time for the heating step exceeds 120 minutes, there is a possibility that waviness occurs in the flame-retardant polymer member and hence a smooth flame-retardant polymer member is not obtained.

The polymerizable composition layer (a) and the monomer-absorbing layer (b) may be exposed to the temperature condition before the laminating step (1). The polymerizable composition (α) may also be exposed to the temperature condition.

Any appropriate heating method can be adopted as a method of heating the laminate (X) in the heating step. Examples of the method of heating the laminate (X) in the heating step include a heating method involving using an oven, a heating method involving using an electrothermal heater, and a heating method involving using an electromagnetic wave such as an infrared ray.

As a result of the laminating step (1) and the heating step to be performed as required, in the laminate (X), the layered inorganic compound (f) moves in the polymerizable composition layer (a), and the layered inorganic compound (f) is substantially absent at an interface between the polymerizable composition layer (a) and monomer-absorbing layer (b) immediately after the lamination. Thus, the unevenly distributed polymerizable composition layer (a1) is obtained, in which the layered inorganic compound (f) is unevenly distributed toward the side opposite to the monomer-absorbing layer (b). Meanwhile, the monomer-absorbing layer (b) absorbs the polymerizable monomer (m) and hence the monomer-absorbing layer (b1) is obtained.

(2-1-3. Polymerizing Step (2))

A laminate (Y) of the unevenly distributed polymer layer (a2) and the cured monomer-absorbing layer (b2) is obtained by performing the polymerizing step (2) of polymerizing the polymerizable monomer (m) in the unevenly distributed polymerizable composition layer (a1) and the polymerizable monomer (m) in the monomer-absorbing layer (b1).

The polymerizing step (2) can be performed by, for example, photoirradiation. Any appropriate condition can be adopted as a condition such as a light source, irradiation energy, an irradiation method, or an irradiation time.

An active energy ray to be used in the photoirradiation is, for example, an ionizing radiation such as an α-ray, a β-ray, a γ-ray, a neutron beam, or an electron beam, or UV light. Of those, UV light is preferred.

Irradiation with the active energy ray is performed by using, for example, a black-light lamp, a chemical lamp, a high-pressure mercury lamp, or a metal halide lamp.

Heating may be performed in the polymerizing step (2). Any appropriate heating method can be adopted as a heating method. Examples of the heating method include a heating method involving using an electrothermal heater and a heating method involving using an electromagnetic wave such as an infrared ray.

The thickness of the unevenly distributed portion (a21) of the layered inorganic compound (f) in the unevenly distributed polymer layer (a2) in the laminate (Y) is preferably 80% or less, more preferably 60% or less, still more preferably 50% or less with respect to the thickness of the polymerizable composition layer (a) (before the lamination). When the ratio of the thickness of the unevenly distributed portion (a21) of the layered inorganic compound (f) to the thickness of the polymerizable composition layer (a) (before the lamination) exceeds 80%, adhesiveness between the unevenly distributed polymer layer (a2) and the cured monomer-absorbing layer (b2) may be problematic, or the strength of the unevenly distributed polymer layer (a2) may be problematic.

The thickness of the unevenly distributed portion (a21) of the layered inorganic compound (f) can be controlled by adjusting the amount of the layered inorganic compound (f).

The unevenly distributed portion (a21) of the layered inorganic compound (f) and the non-unevenly distributed portion (a22) of the layered inorganic. compound (f) can be clearly distinguished from each other because the unevenly distributed portion (a21) of the layered inorganic compound (f) has a layer shape.

A trace amount of the layered inorganic compound (f) may be dispersed in the non-unevenly distributed portion (a22) depending on a combination of the monomer-absorbing layer (b) and the polymerizable monomer (m). However, the layered inorganic compound (f) dispersed in a trace amount in the non-unevenly distributed portion (a22) does not affect any characteristic of the flame-retardant polymer member.

The unevenly distributed portion (a21) of the layered inorganic compound (f) corresponds to the flame-retardant layer (A).

In the unevenly distributed portion (a21) of the layered inorganic compound (f), the layered inorganic compound (f) and a polymer component of the unevenly distributed polymer layer (a2) are mixed. Accordingly, the unevenly distributed portion (a21) of the layered inorganic compound (f) can exert a characteristic based on the polymer component of the unevenly distributed polymer layer (a2), a characteristic of the layered inorganic compound (f), and a characteristic based on the uneven distribution of the layered inorganic compound (f) in the unevenly distributed polymer layer (a2).

Examples of the characteristic based on the polymer component of the unevenly distributed polymer layer (a2) include flexibility, hard-coat property, pressure-sensitive adhesive property, stress-relaxing property, and impact resistance. The pressure-sensitive adhesive property is, for example, pressure-sensitive adhesive property upon use of a pressure-sensitive adhesive component as the polymer component.

The characteristic of the layered inorganic compound (f) is, for example, a specific function (such as expansivity, shrink property, absorbability, divergence, or conductivity) upon use of the layered inorganic compound (f) having the specific function.

Examples of the characteristic based on the uneven distribution of the layered inorganic compound (f) in the unevenly distributed polymer layer (a2) include: the control of pressure-sensitive adhesive property by the adjustment of the content of the layered inorganic compound upon use of a pressure-sensitive adhesive component as the polymer component; design such as coloring; and the provision of surface unevenness upon use of particles as the layered inorganic compound (f) and a characteristic based on the surface unevenness (such as re-peelability, anti-blocking property, an antiglare characteristic, design, and light-scattering property).

When the polymer component of the unevenly distributed polymer layer (a2) is a pressure-sensitive adhesive component and the layered inorganic compound (f) is particulate, unevenness is formed on the surface of the unevenly distributed polymer layer (a2) by the particulate, layered inorganic compound (f), and hence a flame-retardant polymer member capable of exerting pressure-sensitive adhesive property (tackiness) and releasability (anti-blocking property) on the surface of the unevenly distributed polymer layer (a2) can be obtained. In such flame-retardant polymer member, the pressure-sensitive adhesive property (tackiness) and releasability (anti-blocking property) of the surface of the unevenly distributed polymer layer (a2) can be controlled by adjusting the amount of the particulate, layered inorganic compound (f) to be incorporated.

The particulate, layered inorganic compound (f) in the unevenly distributed portion (a21) may exist in such a manner that the entirety of the particulate, layered inorganic compound (f) is included in the unevenly distributed portion (a21), or may exist in such a manner that part of the particulate, layered inorganic compound (f) is exposed to the outside of the unevenly distributed polymer layer (a2).

(2-1-4. Environment-Resistant Functional Layer (L) or Hygienic Functional Layer (L)-Producing Step (3))

The environment-resistant functional layer (L) or the hygienic functional layer (L) can be produced by any appropriate method. Preferred examples of the method of producing the environment-resistant functional layer (L) or the hygienic functional layer (L) include: a method involving forming the environment-resistant functional layer (L) or the hygienic functional layer (L) described in the section <1-5. Environment-resistant functional layer (L)> or <1-6. Hygienic functional layer (L)> (which may contain an additive described in the section <1-5. Environment-resistant functional layer (L)> or <1-6. Hygienic functional layer (L)>) on the flame-retardant layer (A); and a method involving transferring the environment-resistant functional layer (L) or the hygienic functional layer (L) (which may contain an additive described in the section <1-5. Environment-resistant functional layer (L)> or <1-6. Hygienic functional layer (L) >) formed on any appropriate base material onto the flame-retardant layer (A). In addition, the environment-resistant functional layer (L) or the hygienic functional layer (L) may be formed by using any appropriate paint.

The environment-resistant functional layer (L) or hygienic functional layer (L)-producing step (3) can be performed at any appropriate timing in the production method (1).

(2-1-4-1. Photocatalyst Layer-Producing Step (3))

The photocatalyst layer (L) can be produced by any appropriate method. The photocatalyst layer can be preferably produced by applying a photocatalyst coating liquid containing the photocatalyst and drying the liquid as required. The photocatalyst coating liquid can be prepared by mixing the photocatalyst and any appropriate solvent. The photocatalyst is preferably photocatalyst particles. The solvent is preferably, for example, an organic solvent or water. Only one kind of solvent may be used as the solvent, or a mixed solvent of two or more kinds of solvents may be used as the solvent. When the photocatalyst and the solvent are mixed, the photocatalyst may be mixed in a powder state, or may be mixed in a slurry state or a sol state.

When the photocatalyst particles are used, a dispersion stabilizer may be caused to co-exist in the photocatalyst coating liquid in order that a change in particle diameter and sedimentation due to the aggregation of the photocatalyst particles may be prevented. The dispersion stabilizer may be caused to co-exist at the time of the preparation of the photocatalyst particles, or may be added upon preparation of the photocatalyst coating liquid.

Any appropriate dispersion stabilizer can be used as the dispersion stabilizer. For example, titanium oxide is liable to aggregate at a circumneutral pH and hence an acidic or alkaline dispersion stabilizer is preferred.

Examples of the acidic dispersion stabilizer include: mineral acids such as nitric acid and hydrochloric acid; carboxylic acids such as acetic acid, oxalic acid, glycolic acid, lactic acid, tartaric acid, malic acid, and citric acid; oxycarboxylic acids; and polycarboxylic acids. Examples of the alkaline dispersion stabilizer include: alkali metal salts of carboxylic acids, polycarboxylic acids, and the like; ammonia; primary to quaternary amines; and alkanolamines each obtained by adding a hydroxy group to an amine.

The photocatalyst coating liquid may contain an inorganic binder. The inorganic binder enhances adhesion between the photocatalyst particles and improves the strength of the layer based on the photocatalyst. Any appropriate inorganic compound can be adopted as the inorganic binder as long as the compound functions as a binder. Examples of the inorganic binder include those described in the section <1-5. Environment-resistant functional layer (L)>.

The photocatalyst coating liquid may contain any appropriate other additive depending on purposes and necessity. Such other additive is, for example, a thickener. The thickener is, for example, a water-soluble polymer.

Any appropriate content can be adopted as each of the content of the photocatalyst in the photocatalyst coating liquid and the content of any other component (such as the inorganic binder) therein as long as the photocatalyst layer to be obtained can express photocatalytic performance.

Any appropriate means can be adopted as means for applying the photocatalyst coating liquid. Examples of such means include gravure coating, spray coating, and dip coating.

After the application of the photocatalyst coating liquid containing the photocatalyst, the applied product can be dried as required. A heating temperature for the drying is preferably 80 to 180° C. A heating time for the drying is preferably 10 seconds to 10 minutes.

After the performance of the drying, aging may be performed for a necessary time period. The aging can improve the peel strength of the coating film with which the flame-retardant layer (A) is coated.

(2-1-4-2. Antifouling Layer-Producing Step (3))

The antifouling layer (L) can be produced by any appropriate method. The antifouling layer can be preferably produced by: applying a resin composition (such as a resin composition containing at least one kind of resin selected from a fluorine-based resin and a silicone-based resin) as a formation material; and drying the composition as required. Any appropriate solvent may be added as required upon application of the resin composition as a formation material.

Any appropriate means can be adopted as means for applying the resin composition. Examples of such means include gravure coating, spray coating, and dip coating.

When the resin composition is dried after its application, a heating temperature for the drying is preferably 30 to 180° C., more preferably 50 to 150° C. A heating time for the drying is preferably 10 seconds to 10 minutes.

After the application of the resin composition, the antifouling layer may be cured by, for example, UV irradiation or heating as required. For example, when a resin composition containing a UV-curable resin is used, the layer is preferably cured by UV irradiation, and when a resin composition containing a thermosetting resin is used, the layer is preferably cured by heating.

After its production, the antifouling layer may be aged for a necessary time period. The aging can improve the peel strength of the coating film with which the flame-retardant layer (A) is coated.

(2-1-4-3. Moisture-Conditioning Layer-Producing Step (3))

The moisture-conditioning layer (L) can be produced by any appropriate method. The moisture-conditioning layer (L) can be produced by, for example, applying a moisture-conditioning paint essentially containing a porous substance described in the section <1-5. Environment-resistant functional layer (L)> and drying the paint as required. Any appropriate solvent may be added as required upon application of the moisture-conditioning paint. Examples of the method involving applying the moisture-conditioning paint to form the moisture-conditioning layer (L) on the flame-retardant layer (A) include: a method involving directly applying the moisture-conditioning paint onto the flame-retardant layer (A) to form the moisture-conditioning layer (L); and a method involving transferring the moisture-conditioning layer (L), which has been formed by applying the moisture-conditioning paint onto any appropriate base material, onto the flame-retardant layer (A).

Any appropriate means can be adopted as means for applying the moisture-conditioning paint. Examples of such means include gravure coating, spray coating, and dip coating.

When the moisture-conditioning paint is dried after its application, a heating temperature for the drying is preferably 30 to 180° C., more preferably 50 to 150° C. A heating time for the drying is preferably 10 seconds to 10 minutes.

(2-1-4-4. Moisture-Preventing Layer-Producing Step (3))

The moisture-preventing layer (L) can be produced by any appropriate method. The moisture-preventing layer (L) can be produced by, for example, applying a moisture-preventing paint essentially containing a resin having a moisture-preventing effect described in the section <1-5. Environment-resistant functional layer (L)> and drying the paint as required. Any appropriate solvent may be added as required upon application of the moisture-preventing paint. Examples of the method involving applying the moisture-preventing paint to form the moisture-preventing layer (L) on the flame-retardant layer (A) include: a method involving directly applying the moisture-preventing paint onto the flame-retardant layer (A) to form the moisture-preventing layer (L); and a method involving transferring the moisture-preventing layer (L), which has been formed by applying the moisture-preventing paint onto any appropriate base material, onto the flame-retardant layer (A).

Any appropriate means can be adopted as means for applying the moisture-preventing paint. Examples of such means include gravure coating, spray coating, and dip coating.

When the moisture-preventing paint is dried after its application, a heating temperature for the drying is preferably 30 to 180° C., more preferably 50 to 150° C. A heating time for the drying is preferably 10 seconds to 10 minutes.

(2-1-4-5. Water-Resistant Layer-Producing Step (3))

The water-resistant layer (L) can be produced by any appropriate method. Examples of the method of producing the water-resistant layer (L) include: a method involving forming the water-resistant resin described in the section <1-5. Environment-resistant functional layer (L)> on the flame-retardant layer (A); and a method involving transferring the water-resistant resin formed on any appropriate base material onto the flame-retardant layer (A). In addition, the water-resistant layer (L) may be formed by using any appropriate water-resistant paint.

(2-1-4-6. Water-Repellent Layer-Producing Step (3))

The water-repellent layer (L) can be produced by any appropriate method. Examples of the method of producing the water-repellent layer (L) include: a method involving forming the water-repellent layer containing the water-repellent compound described in the section <1-5. Environment-resistant functional layer (L)> on the flame-retardant layer (A); and a method involving transferring the water-repellent layer containing the water-repellent compound and formed on any appropriate base material onto the flame-retardant layer (A). In addition, the water-repellent layer (L) may be formed by using any appropriate water-repellent paint.

(2-1-4-7. Hydrophilic Layer-Producing Step (3))

The hydrophilic layer (L) can be produced by any appropriate method. Examples of the method of producing the hydrophilic layer (L) include: a method involving forming the hydrophilic layer containing the hydrophilic inorganic compound and/or hydrophilic resin described in the section <1-5. Environment-resistant functional layer (L)> on the flame-retardant layer (A); and a method involving transferring the hydrophilic layer containing the hydrophilic inorganic compound and/or the hydrophilic resin and formed on any appropriate base material onto the flame-retardant layer (A). In addition, the hydrophilic layer (L) may be formed by using any appropriate hydrophilic paint.

(2-1-4-8. Oil-Repellent Layer-Producing Step (3))

The oil-repellent layer (L) can be produced by any appropriate method. Examples of the method of producing the oil-repellent layer (L) include: a method involving forming the oil-repellent layer containing the oil-repellent compound described in the section <1-5. Environment-resistant functional layer (L) > on the flame-retardant layer (A); and a method involving transferring the oil-repellent layer containing the oil-repellent compound and formed on any appropriate base material onto the flame-retardant layer (A). In addition, the oil-repellent layer (L) may be formed by using any appropriate oil-repellent paint.

(2-1-4-9. Antibacterial Layer-Producing Step (3))

The antibacterial layer (L) can be produced by any appropriate method. The antibacterial layer can be preferably produced by: applying a resin composition (such as a resin composition containing an antibacterial agent) as a formation material; and drying the composition as required. Any appropriate solvent may be added as required upon application of the resin composition as a formation material.

Any appropriate means can be adopted as means for applying the resin composition. Examples of such means include gravure coating, spray coating, and dip coating.

When the resin composition is dried after its application, a heating temperature for the drying is preferably room temperature to 150° C., more preferably 40 to 100° C. A heating time for the drying is preferably 10 seconds to 10 minutes.

After the application of the resin composition, the antibacterial layer may be cured by, for example, UV irradiation or heating as required. For example, when a resin composition containing a UV-curable resin is used, the layer is preferably cured by UV irradiation, and when a resin composition containing a thermosetting resin is used, the layer is preferably cured by heating.

After its production, the antibacterial layer may be aged for a necessary time period. The aging can improve the peel strength of the coating film with which the flame-retardant layer (A) is coated.

(2-1-4-10. Antifungal Layer-Producing Step (3))

The antifungal layer (L) can be produced by any appropriate method. The antifungal layer can be preferably produced by: applying a resin composition (such as a resin composition containing an antifungal agent) as a formation material; and drying the composition as required. Any appropriate solvent may be added as required upon application of the resin composition as a formation material.

Any appropriate means can be adopted as means for applying the resin composition. Examples of such means include gravure coating, spray coating, and dip coating.

When the resin composition is dried after its application, a heating temperature for the drying is preferably room temperature to 150° C., more preferably 40 to 100° C. A heating time for the drying is preferably 10 seconds to 10 minutes.

After the application of the resin composition, the antifungal layer may be cured by, for example, UV irradiation or heating as required. For example, when a resin composition containing a UV-curable resin is used, the layer is preferably cured by UV irradiation, and when a resin composition containing a thermosetting resin is used, the layer is preferably cured by heating.

After its production, the antifungal layer may be aged for a necessary time period. The aging can improve the peel strength of the coating film with which the flame-retardant layer (A) is coated.

(2-1-4-11. Deodorant Layer-Producing Step (3))

The deodorant layer (L) can be produced by any appropriate method. Examples of the method of producing the deodorant layer (L) include: a method involving coating the top of the flame-retardant layer (A) with a material for the deodorant layer (L) to form the layer; and a method involving depositing the material for the deodorant layer (L) from the vapor (e.g., vacuum deposition) onto the flame-retardant layer (A) to form the layer. In addition, the deodorant layer (L) may be formed on the flame-retardant layer (A) by laminating the deodorant layer (L) on the flame-retardant layer (A). Further, the deodorant layer (L) may be formed on the flame-retardant layer (A) by transferring the deodorant layer onto the flame-retardant layer (A) after its formation on any appropriate base material.

<2-2. Flame-Retardant Polymer Member Production Method (2)>

In addition to the production method (1), a production method (2) is preferably adopted as the method of producing the flame-retardant polymer member of the present invention. In the production method (2), the flame-retardant polymer member of the present invention is produced by a production method including the step of laminating a solid layered inorganic compound-containing polymer layer (aₚ), which is obtained by polymerizing a polymerizable composition layer (a) formed of a polymerizable composition (α) containing a polymerizable monomer (m) and the layered inorganic compound (f), and a solid monomer-absorbing layer (b) containing a polymer (p) and capable of absorbing the polymerizable monomer (m) and the step of producing the environment-resistant functional layer (L) or the hygienic functional layer (L).

The solid layered inorganic compound-containing polymer layer (aₚ) can be obtained by: producing the polymerizable composition layer (a) by the same method as the method described in the production method (1); and then performing the polymerization of the polymerizable composition layer (a) by the same method as that in the polymerizing step (2) described in the production method (1). Although the solid layered inorganic compound-containing polymer layer (aₚ) contains a polymer component formed by the polymerization of the polymerizable monomer (m), the polymerizable monomer (m) that has not been polymerized may remain in the layer.

The solid monomer-absorbing layer (b) can be obtained by the same method as the method described in the production method (1).

The lamination of the solid layered inorganic compound-containing polymer layer (aₚ) and the solid monomer-absorbing layer (b) can be performed by any appropriate lamination method. A method for the lamination of the solid layered inorganic compound-containing polymer layer (aₚ) and the solid monomer-absorbing layer (b) is, for example, a method involving producing the solid layered inorganic compound-containing polymer layer (aₚ) on any appropriate base material, separately preparing the monomer-absorbing layer (b) to be provided as a monomer-absorbable sheet, and laminating the layers.

The step of producing the environment-resistant functional layer (L) or the hygienic functional layer (L) is, for example, the same step as that described in (2-1-4. Environment-resistant functional layer (L) or hygienic functional layer (L)-producing step (3)). It should be noted that the environment-resistant functional layer (L) or hygienic functional layer (L)-producing step (3) can be performed at any appropriate timing in the production method (2).

<2-3. Flame-Retardant Polymer Member Production Method (3)>

In addition to the production methods (1) and (2), a production method (3) is preferably adopted as the method of producing the flame-retardant polymer member of the present invention. In the production method (3), the flame-retardant polymer member of the present invention is produced by a production method including the step of laminating a syrupy polymerizable composition layer (a′) formed of a polymerizable composition (α) containing a polymerizable monomer (m1) and the layered inorganic compound (f), and a syrupy polymerizable composition layer (b′) containing a polymerizable monomer (m2) and a polymer (p2), followed by the performance of polymerization, and the step of producing the environment-resistant functional layer (L) or the hygienic functional layer (L).

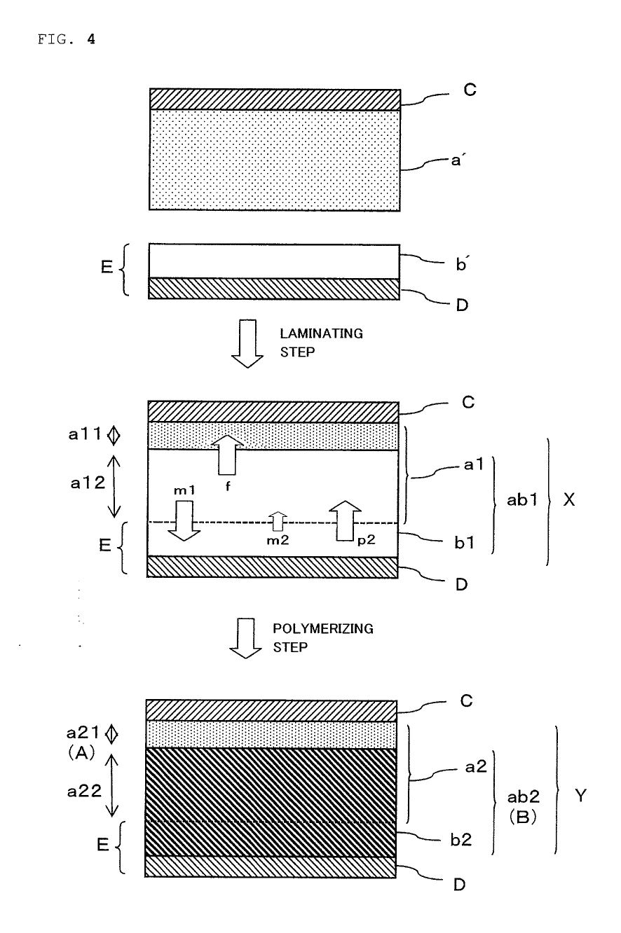

Hereinafter, the “step of laminating the syrupy polymerizable composition layer (a′) formed of the polymerizable composition (α) containing the polymerizable monomer (m1) and the layered inorganic compound (f), and the syrupy polymerizable composition layer (b′) containing the polymerizable monomer (m2) and the polymer (p2), followed by the performance of polymerization” in the flame-retardant polymer member production method (3) is described with reference to FIG. 4.

First, in a laminating step (1), a laminate (X) is obtained by laminating the polymerizable composition layer (a′) and the polymerizable composition layer (b′). The polymerizable composition layer (a′) contains the polymerizable monomer (m1) and the layered inorganic compound (f). The polymerizable composition layer (b′) contains the polymerizable monomer (m2) and the polymer (p2). Although the polymerizable composition layer (a′) can be laminated on at least one surface of the polymerizable composition layer (b′), FIG. 4 illustrates the case where the layer is laminated only on one surface of the polymerizable composition layer (b′). In FIG. 4, a cover film (C) is provided on the side of the polymerizable composition layer (a′) not laminated on the polymerizable composition layer (b′). In addition, in FIG. 4, the polymerizable composition layer (b′) is provided on a base material film (D).

It is preferred that the polymerizable monomer (m1) in the polymerizable composition layer (a′), and the polymerizable monomer (m2) and the polymer (p2) in the polymerizable composition layer (b′). substantially show compatibility. Thus, in the laminate (X), part of the polymerizable monomer (m1) and part of the polymerizable monomer (m2) can each diffuse in the other layer interactively on the lamination surface of the polymerizable composition layer (a′) and the polymerizable composition layer (b′). Here, when a concentration (c1) of the polymerizable monomer (m1) in the polymerizable composition layer (a′) is higher than a concentration (c2) of the polymerizable monomer (m2) in the polymerizable composition layer (b′), the extent to which the polymerizable monomer (m1) diffuses in the polymerizable composition layer (b′) enlarges, and in accordance therewith, the extent to which the polymer (p2) in the polymerizable composition layer (b′) diffuses in the polymerizable composition layer (a′) enlarges. On the other hand, in the polymerizable composition layer (a′), the unevenly distributed polymerizable composition layer (a1) is obtained, in which the layered inorganic compound (f) is unevenly distributed toward the side opposite to the polymerizable composition layer (b′), and which has, as a result of the distribution, the unevenly distributed portion (a11) and non-unevenly distributed portion (a12) of the layered inorganic compound (f).

The concentration (c1) of the polymerizable monomer (m1) in the polymerizable composition layer (a′) is preferably higher than the concentration (c2) of the polymerizable monomer (m2) in the polymerizable composition layer (b′). A concentration difference between the concentration (c1) and the concentration (c2) is preferably 15 wt % or more, more preferably 20 wt % or more, still more preferably 30 wt % or more. When the concentration difference between the concentration (c1) and the concentration (c2) is set to 15 wt % or more, the layered inorganic compound (f) in the polymerizable composition layer (a′) can be unevenly distributed in an effective manner. It should be noted that when the concentration (c2) is higher than the concentration (c1), there is a possibility that the layered inorganic compound (f) in the polymerizable composition layer (a′) cannot be unevenly distributed in a sufficient manner.

The phenomenon of the uneven distribution of the layered inorganic compound (f) in the unevenly distributed polymerizable composition layer (a1) is assumed to be caused by the diffusion of the polymer (p2) from the polymerizable composition layer (b′). The polymerizable monomer (m1) diffuses in the polymerizable composition layer (b′), and in the meantime, the polymer (p2) dif fuses in the polymerizable composition layer (a′). Thus, the layered inorganic compound (f) that cannot diffuse toward the polymerizable composition layer (b′) may be unevenly distributed in such a manner as to remain in the polymerizable composition layer (a′). The polymerizable composition layer (b′) absorbs the polymerizable monomer (m1) to turn into the monomer-absorbing layer (b1).

Each component of the polymerizable composition layer (a′) and each component of the polymerizable composition layer (b′) diffuse interactively in the laminate (X). Accordingly, an interface between the non-unevenly distributed portion (a12) of the layered inorganic compound (f) in the unevenly distributed polymerizable composition layer (a1) and the monomer-absorbing layer (b1) cannot be observed (a composite site of these layers is represented as ab1 in FIG. 4). In FIG. 4, the interface is indicated by a broken line for convenience.

Next, the polymerizable monomer (m1) and the polymerizable monomer (m2) in the unevenly distributed polymerizable composition layer (a1) and the monomer-absorbing layer (b1) are polymerized by subjecting the laminate (X) to the polymerizing step (2). Thus, the laminate (Y) in which the unevenly distributed polymer layer (a2), which has been cured while the unevenly distributed structure has been maintained, and the cured monomer-absorbing layer (b2) are laminated is obtained. The unevenly distributed polymer layer (a2) has the unevenly distributed portion (a21) of the layered inorganic compound (f) and the non-unevenly distributed portion (a22) of the layered inorganic compound (f). It should be noted that the monomer-absorbing layer (b1) is turned into the monomer-absorbing layer (b2), in which the polymerizable monomer (m1) and the polymerizable monomer (m2) have been cured, by the polymerizing step (2) because the polymerizable monomer (m1) and the polymerizable monomer (m2) are absorbed by the monomer-absorbing layer (b1). Although an interface between the non-unevenly distributed portion (a22) of the layered inorganic compound (f) in the unevenly distributed polymer layer (a2) and the cured monomer-absorbing layer (b2) cannot be observed in the laminate (Y) (a composite site of these layers is represented as ab2 in FIG. 4), the interface is indicated by a broken line in FIG. 4 for convenience.

Details about the laminating step (1) and details about the polymerizing step (2) are identical to those described in the production method (1). In addition, the heating step described in the production method (1) may be included.

The step of producing the environment-resistant functional layer (L) or the hygienic functional layer (L) is, for example, the same step as the environment-resistant functional layer (L) or hygienic functional layer (L)-producing step (3) described in the production method (1). It should be noted that the environment-resistant functional layer (L) or hygienic functional layer (L)-producing step (3) can be performed at any appropriate timing in the production method (3).

<<3. Shape of Flame-Retardant Polymer Member>>

Any appropriate shape can be adopted as the shape of the flame-retardant polymer member of the present invention. Examples of the shape of the flame-retardant polymer member of the present invention include a sheet shape and a tape shape. When the shape of the flame-retardant polymer member of the present invention is a sheet shape, the member can be used as a flame-retardant sheet. The flame-retardant polymer member of the present invention may have such a shape that the member of a sheet shape or a tape shape is wound in a roll shape. Alternatively, the flame-retardant polymer member of the present invention may have such a shape that members of sheet shapes or tape shapes are laminated.

When the outermost layer of the flame-retardant polymer member of the present invention is a pressure-sensitive adhesive layer, the flame-retardant polymer member of the present invention can be used as a pressure-sensitive adhesive tape or a pressure-sensitive adhesive sheet. It should be noted that the “pressure-sensitive adhesive tape” and the “pressure-sensitive adhesive sheet” may be collectively referred to as “tape” or “sheet” in a simple manner.

The flame-retardant polymer member of the present invention can also be used as a pressure-sensitive adhesive tape or a pressure-sensitive adhesive sheet by further providing the flame-retardant polymer member of the present invention with a pressure-sensitive adhesive layer formed of any appropriate pressure-sensitive adhesive (such as an acrylic pressure-sensitive adhesive, a rubber-based pressure-sensitive adhesive, a vinyl alkyl ether-based pressure-sensitive adhesive, a silicone-based pressure-sensitive adhesive, a polyester-based pressure-sensitive adhesive, a polyamide-based pressure-sensitive adhesive, a urethane-based pressure-sensitive adhesive, a fluorine-based pressure-sensitive adhesive, or an epoxy-based pressure-sensitive adhesive).

The flame-retardant polymer member of the present invention may have any other layer (such as an intermediate layer or an undercoat layer) to such an extent that the effect of the present invention is not impaired.

In the flame-retardant polymer member of the present invention, the surface of the environment-resistant functional layer (L) or the hygienic functional layer (L) may be protected with a cover film. The cover film can be peeled upon use of the flame-retardant polymer member of the present invention.

<<4. Flame-Retardant Article>>

A flame-retardant article is obtained by attaching the flame-retardant polymer member of the present invention to an adherend. For example, paper, lumber, a plastic material, a metal, a plaster board, glass, or a composite containing two or more thereof can be used as the adherend. The flame-retardant polymer member of the present invention is attached to at least part of the adherend. It should be noted that the adherend may be a printed matter provided with a pattern layer or the like, or may be an adherend having design.

Examples of the paper as the adherend include woodfree paper, Japanese paper, kraft paper, glassine paper, synthetic paper, and top-coated paper.

Examples of the lumber as the adherend include: broadleaf trees such as oak, paulownia wood, keyaki, teak, and rosewood; coniferous trees such as Japanese cedar, Japanese cypress, pine, and hiba false arborvitae; assembles; and plywood.

Examples of the plastic material as the adherend include an acrylic resin, a polyester (such as a polyethylene terephthalate), an olefin-based resin (such as a polyethylene, a polypropylene, or a polystyrene), a vinyl chloride resin, an epoxy resin, a vinyl ether-based resin, and a urethane-based resin.

Upon lamination of the flame-retardant polymer member of the present invention and the adherend, the member and the adherend may be attached to each other by applying any appropriate pressure-sensitive adhesive by any appropriate application method. When the outermost layer of the flame-retardant polymer member is a pressure-sensitive adhesive layer, the member may be attached to the adherend without being treated. A method of attaching the flame-retardant polymer member and the adherend is, for example, a method involving attaching the member and the adherend with a laminator. The flame-retardant-treated adherend thus obtained can be attached to a wall surface or glass surface of a railway vehicle or the like, or to a wall surface, decorative laminate, glass surface, or the like of a housing or the like through an attachment layer, the attachment layer being provided on the surface opposite to the surface on which the flame-retardant polymer member of the present invention is laminated.

The flame-retardant polymer member of the present invention can be suitably used as a building material in, for example, a wall material, ceiling material, roofing material, flooring material, partitioning material, or curtain of a housing, edifice, or public facility, in particular, a wall material or ceiling material of a kitchen, or a partition of a clean room. In addition, the member can be used in, for example, a surface trim material for fire preventive equipment such as an exhaust duct, a fire door, or a fire shutter, a surface trim material for furniture such as a table, a surface trim material for a door, a surface trim material for window glass, a surface trim material for a signboard or digital signage, or a roll screen. In addition, the member can be used in a wall material, ceiling material, roofing material, or flooring material inside or outside a ship, aircraft, automobile, or railway vehicle, a surface protective material or inkjet media material for a printed matter to be attached to a glass portion inside or outside a railway vehicle, a solar cell member, a cell protective material, or an electrical and electric equipment member such as a partition inside an electrical apparatus. Further, the member can be used as a peripheral tool for an ash tray, a surface trim material for a garbage box, or a protective material for the front panel of a pachinko machine.

### EXAMPLES

Hereinafter, the present invention is described in more detail by way of examples, but the present invention is not limited to these examples.

It should be noted that a biaxially stretched polyethylene terephthalate film having a thickness of 38 μm (trade name: “MRN38,” manufactured by Mitsubishi Chemical Polyester Film) one surface of which had been subjected to a silicone-based release treatment was used as each of cover films and base material films used in the following respective examples.

<Flame Retardancy>

A polymer sheet was evaluated for the following flame retardancy.

An evaluation for flame retardancy was performed by the horizontal firing test illustrated in FIG. 2. FIG. 2 illustrates a measurement method. Each polymer sheet was cut into a piece measuring 5 cm by 12 cm and then the piece was subjected to the evaluation. It should be noted that the cover films on both surfaces of each polymer sheet were peeled.

In each of the environment-resistant functional flame-retardant polymer sheets and hygienic functional flame-retardant polymer sheets obtained in Examples, the side of the environment-resistant functional layer or hygienic functional layer was defined as a lower surface, and in a flame-retardant polymer sheet (C1) obtained in Comparative Example, the side of the flame-retardant layer was defined as a lower surface.

A Bunsen burner was placed so that the flame port of the Bunsen burner was positioned at a lower portion distant from the central portion of the lower surface of a polymer sheet by 45 mm, and then the flame of the Bunsen burner having a height of 55 mm from the flame port was brought into contact for 30 seconds. A propane gas was used as the gas of the Bunsen burner and the test was performed in the air.

<<Flame Retardancy: *1>>

A polymer sheet was evaluated for its flame retardancy on the basis of the following criteria by subjecting the polymer sheet to the horizontal firing test and observing the presence or absence of the combustion of the polymer sheet.

∘: The polymer sheet does not ignite even after 30 seconds from the flame contact, and maintains its shape.
Δ: The polymer sheet ignites within 30 seconds from the flame contact, but maintains its shape.
x: The polymer sheet ignites within 30 seconds from the flame contact, and does not maintain its shape.

<<Flame-Blocking Property: *2>>

A polymer sheet was evaluated for its flame-blocking property by: placing a White Economy 314-048 (manufactured by Biznet) as copy paper at a position 3 mm above the polymer sheet; and observing the presence or absence of the combustion of the copy paper through the same horizontal firing test as that described above.

∘: The copy paper 3 mm above the polymer sheet does not ignite even after 30 seconds from the flame contact.
Δ: The copy paper 3 mm above the polymer sheet ignites within 30 seconds from the flame contact, but does not ignite within 10 seconds therefrom.
x: The copy paper 3 mm above the polymer sheet ignites within 10 seconds from the flame contact.

Photocatalyst Performance: *3>>

An evaluation for photocatalyst performance was performed with an acetaldehyde gas. Gas concentrations (an initial concentration and a concentration after 60 minutes) in a detector tube were measured on the basis of the following evaluation test method.

### (Evaluation Test Method)

Pre-irradiation of sample: 1 mW/cm²×6 hr
Sample dimensions: 5 cm×5 cm
Gas bag volume: A Tedlar bag having a volume of 5 L
Initial gas concentration: 20 ppm
Light source: A fluorescent lamp (10,000 lux)

<<Antifouling Property: *3>>

A paste formed of a mixture containing carbon black and kerosene at a weight ratio of 1/2 was smeared on a polymer sheet, and then the resultant was left to stand at room temperature for 24 hours. After that, water washing was performed with a sponge, and then the contaminated state of the surface of the polymer sheet was visually observed and evaluated in accordance with the following criteria.

∘: No contamination
Δ: Slight contamination
x: Remarkable contamination

<Moisture-Conditioning Property: *3>

In a thermostatic chamber having an outside temperature of 20° C., 200 ml of ion-exchange water kept at 40° C. were loaded into a 300-ml beaker, and a polymer sheet was provided on the top of the beaker while the side opposite to a polymer layer faced the inside. 10 Minutes later, the dew condensation state of the inner surface was visually observed and evaluated on the basis of the following criteria.

∘: There was no water droplet adhering to the surface of the film.
Δ: There were water droplets each having a diameter of 2 to 10 mm and adhering to the entire surface of the film.
x: There were many wafer droplets each having a diameter of less than 2 mm and adhering to the entire surface of the film.

<Moisture-Preventing Property: *3>

A water vapor transmission rate was measured with a water vapor transmission rate measuring apparatus (manufactured by MOCON, Inc.) under the conditions of 40° C. and 80% RH. It should be noted that the method of measuring the water vapor transmission rate was performed in conformity with JIS-K-7129 or the MOCON method.

<Water Resistance: *3>

A polymer sheet was immersed in tap water at 23° C. for 3 days, and then the degree of deterioration of the surface of the polymer sheet was visually observed and evaluated on the basis of the following criteria.

∘: The surface of the polymer sheet shows no change.
x: The surface of the polymer sheet has a wrinkle or a blister.

<Water Repellency: *3>

0.1 Gram of oleic acid was smeared on the surface of a polymer sheet, and then the sheet was washed with a Kimwipe while ion-exchange water was poured thereon. The external appearance of the polymer sheet that had been washed was visually observed and evaluated on the basis of the following criteria.

⊚: A stain is completely removed.
∘: A slight stain remains.
Δ: A conspicuous stain remains.
x: A stain is spread over the entire surface and can be hardly removed.

<Hydroliphicity: *3>

0.1 Gram of oleic acid was smeared on the surface of a polymer sheet, and then the sheet was washed with a Kimwipe while ion-exchange water was poured thereon. The external appearance of the polymer sheet that had been washed was visually observed and evaluated on the basis of the following criteria.

⊚: A stain is completely removed.
∘: A slight stain remains.
Δ: A conspicuous stain remains.
x: A stain is spread over the entire surface and can be hardly removed.

<Oil Repellency: *3>

0.2 Gram of a silicone oil was placed on the surface of a polymer sheet placed horizontally, and then a surface contact angle with respect to the silicone oil was evaluated by measuring an angle formed between the liquid droplet and the surface of the polymer sheet.

<Antibacterial Performance: *3>

### (1) Test Bacterial Strains

Escherichia coli (Escherichia coli IFO3301) Staphylococcus aureus

### (2) Preparation of Test Bacterial Liquid

A culture of test bacteria which had been subjected to shaking culture in a broth medium at 35° C. for 20 hours was diluted 20.000-fold with a sterile phosphate buffer. The resultant was used as a bacterial liquid. In addition, a bacterial count in the bacterial liquid was separately measured.

### (3) Test for Antibacterial Property

1 Milliliter of the bacterial liquid was dropped onto the antibacterial layer of a specimen (antibacterial flame-retardant polymer member), and the resultant was left to stand at 25° C. for 24 hours. After that, a bacterial count was measured, and the antibacterial performance of the specimen was evaluated. It should be noted that 1 mL of the bacterial liquid was dropped onto a petri dish as a control sample, and the resultant was subjected to the same test.

### (4) Measurement of Bacterial Count

The specimen and control sample which had been stored for 24 hours were each washed with 10 mL of an SCDLP medium (manufactured by NIHON PHARMACEUTICAL CO., LTD.). The washing liquid was measured for its bacterial count with standard plate count agar, and then the bacterial count of each of the specimen and the control sample was calculated.

<Antifungal Property: *3>

An evaluation was performed in conformity with Attachment A of JIS Z 2911.

<Deodorant Property: *3>

Deodorant property was evaluated with acetic acid. That is, gas concentrations (an initial concentration and a concentration after 60 minutes) in a detector tube were measured on the basis of the following evaluation test method.

Sample dimensions: 15 cm×25 cm
Gas bag volume: A Tedlar bag having a volume of 5 L
Initial gas concentration: 20 ppm

### Synthesis Example 1

### Preparation of Syrup (b-1)

50 Parts by weight of isobornyl acrylate, 50 parts by weight of lauryl acrylate, 0.1 part by weight of a photopolymerization initiator (trade name: “IRGACURE 651,” manufactured by Ciba Specialty Chemicals Inc.), and 0.1 part by weight of a photopolymerization initiator (trade name: “IRGACURE 184,” manufactured by Ciba Specialty Chemicals Inc.) were stirred in a four-necked separable flask provided with a stirring machine, a temperature gauge, a nitrogen gas-introducing tube, and a cooling tube until the mixture became uniform. After that, bubbling was performed with a nitrogen gas for 1 hour to remove dissolved oxygen. After that, UV light was applied from the outside of the flask by using a black-light lamp to perform polymerization. At the time point when a moderate viscosity was obtained, the lamp was turned off and the blowing of nitrogen was stopped. Thus, a syrupy composition having a rate of polymerization of 7% part of which had been polymerized was prepared (hereinafter, the composition is referred to as “syrup (b-1)”).

### Synthesis Example 2

### Preparation of Syrup (a-1) Containing Layered Inorganic Compound

30 Parts by weight of a layered clay mineral (trade name: “Lucentite SPN,” manufactured by Co-op Chemical Co., Ltd., shape: flat plate-like shape) were added to a monomer mixture formed of 100 parts by weight of cyclohexyl acrylate, 0.2 part by weight of 1,6-hexanediol diacrylate, 0.2 part by weight of a photopolymerization initiator (trade name: “IRGACURE 651,” manufactured by Ciba Specialty Chemicals Inc.), and 0.2 part by weight of a photopolymerization initiator (trade name: “IRGACURE 184,” manufactured by Ciba Specialty Chemicals Inc.), and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-1) containing a layered inorganic compound was prepared. It should be noted that the monomer mixture to which the layered clay mineral had been added became transparent as a result of the ultrasonic treatment.

### Synthesis Example 3

### Production of Monomer-Absorbable Sheet (B-1) with Base Material

A syrup composition prepared by uniformly mixing 100 parts by weight of the syrup (b-1) prepared in Synthesis Example 1 with 0.5 part by weight of a photopolymerization initiator (trade name: “IRGACURE 651,” manufactured by Ciba Specialty Chemicals Inc.) was applied to the peel-treated surface of the base material film so as to have a thickness of 100 μm after its curing. Thus, a syrup composition layer was formed. Then, the cover film was attached onto the layer in such a manner that its release-treated surface was in contact with the layer, and then both surfaces of the resultant were simultaneously irradiated with UV light (illuminance: 5 mW/cm²) by using a black-light lamp for 5 minutes. As a result, the layer was cured to form a monomer-absorbing layer. Thus, a monomer-absorbable sheet (B-1) with a base material in which the surface of the monomer-absorbing layer was protected with the cover film was produced.

### Synthesis Example 4

### Production of Flame-Retardant Polymer Sheet (P-1)

A polymerizable composition layer (thickness: 100 μm) was formed by applying the syrup (a-1) to the release-treated surface of the cover film. The resultant was attached to the monomer-absorbable sheet (B-1) with a base material, the monomer-absorbing layer of which had been exposed by peeling the cover film, in such a manner that the monomer-absorbing layer and the polymerizable composition layer were in contact with each other. Thus, a laminate was formed.

Next, the laminate was left to stand at room temperature for minutes. Thus, an unevenly distributed polymerizable composition layer was obtained. After that, both of its surfaces were irradiated with UV light (illuminance: 5 mW/cm²) by using a black-light lamp as a light source for 5 minutes. As a result, the unevenly distributed polymerizable composition layer was photo-cured to form an unevenly distributed polymer layer. Thus, a flame-retardant polymer sheet (P-1) was produced.

### Synthesis Example 5

### Preparation of Syrup (a-2) Containing Layered Inorganic Compound

30 Parts by weight of a layered clay mineral (trade name: “Lucentite SPN,” manufactured by Co-op Chemical Co., Ltd., shape: flat plate-like shape) were added to a monomer mixture formed of 100 parts by weight of 1,6-hexanediol diacrylate and 0.5 part by weight of a photopolymerization initiator (trade name: “IRGACURE 819,” manufactured by Ciba Specialty Chemicals Inc.), and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-2) containing a layered inorganic compound was prepared.

### Synthesis Example 6

### Preparation of Acrylic Oligomer (A)

70 Parts by weight of isobornyl acrylate, 30 parts by weight of lauryl acrylate, and 3.8 parts by weight of thioglycolic acid were stirred in a four-necked separable flask provided with a stirring machine, a temperature gauge, a nitrogen gas-introducing tube, and a cooling tube until the mixture became uniform. After that, bubbling was performed with a nitrogen gas for 1 hour to remove dissolved oxygen. After that, the temperature was increased to 70° C., and the mixture was stirred at 70° C. for 30 minutes. Then, 0.05 part by weight of a thermal polymerization initiator (trade name: “PERHEXYL 0,” manufactured by NOF CORPORATION) and 0.02 part by weight of a thermal polymerization initiator (trade name: “PERHEXYL D,” manufactured by NOF CORPORATION) were added. The temperature was further increased to 100° C., the mixture was stirred at 100° C. for 60 minutes, and then the temperature was increased to 140° C. After that, the mixture was stirred at 140° C. for 60 minutes, the temperature was then increased to 180° C., and the mixture was stirred at 180° C. for 60 minutes. Thus, an acrylic oligomer (A) was prepared. It should be noted that the weight-average molecular weight of the resultant acrylic oligomer (A) was 5,000.

### Synthesis Example 7

### Preparation of Syrup (b-2)

20 Parts by weight of cyclohexyl acrylate, 80 parts by weight of the acrylic oligomer (A) prepared in Synthesis Example 6, and 0.5 part by weight of a photopolymerization initiator (trade name: “IRGACURE 819,” manufactured by Ciba Specialty Chemicals Inc.) were stirred in a flask provided with a stirring machine until the mixture became uniform. Thus, a syrupy composition was prepared (hereinafter, the composition is referred to as “syrup (b-2)”).

### Synthesis Example 8

### Production of Flame-Retardant Polymer Sheet (P-2)

The syrup (a-2) was applied onto a supporting base material so that its thickness after curing was 50 p.m. Thus, the polymerizable composition layer (a′) was formed. The syrup (b-2) was applied onto another supporting base material so that its thickness after curing was 50 μm. Thus, the polymerizable composition layer (b′) was formed. The polymerizable composition layer (a′) and the polymerizable composition layer (b′) were attached to each other in such a manner that no air bubble was included while the layers were brought into contact with each other, and 5 minutes after the attachment, the resultant was irradiated with UV light (illuminance: 9 mW/cm², light quantity: 1,200 mJ/cm²) by using a black-light lamp and a metal halide lamp to cure the polymerizable composition layer (a′) and the polymerizable composition layer (b′). Thus, a flame-retardant polymer sheet (P-2) having the supporting base materials on both sides thereof was produced.

### Example 1-1

### Production of photocataltic Flame-Retardant Polymer Sheet (1)

100 Parts by weight of a photocatalytic coating agent (manufactured by TAYCA CORPORATION, trade name: “TKC-303,” photocatalyst: titanium oxide, dry solid content: 13%, titanium oxide particle diameter=6 nm, acidic, aqueous medium) were applied onto the flame-retardant layer of the flame-retardant polymer sheet (P-1) obtained in Synthesis Example 4, and were then dried at 120° C. for 1 minute to form a photocatalyst layer. Thus, a photocatalytic flame-retardant polymer sheet (1) was produced.

In the resultant photocatalytic flame-retardant polymer sheet (1), the thickness of the polymer layer (B) was 175 μm, the thickness of the flame-retardant layer (A) was 25 μm, and the thickness of the photocatalyst layer (L) was 5 μm.

### Example 1-2

### Production of Photocatalytic Flame-Retardant Polymer Sheet (2)

100 Parts by weight of a photocatalytic coating agent (manufactured by TAYCA CORPORATION, trade name: “TKC-303,” photocatalyst: titanium oxide, dry solid content: 13%, titanium oxide particle diameter=6 nm, acidic, aqueous medium) were applied onto the flame-retardant layer of the flame-retardant polymer sheet (P-2) obtained in Synthesis Example 8, and were then dried at 120° C. for 1 minute to form a photocatalyst layer. Thus, a photocatalytic flame-retardant polymer sheet (2) was produced.

In the resultant photocatalytic flame-retardant polymer sheet (2), the thickness of the polymer layer (B) was 85 μm, the thickness of the flame-retardant layer (A) was 15 μm, and the thickness of the photocatalyst layer (L) was 5 μm.

### Comparative Example 1

### Production of Flame-Retardant Polymer Sheet (C1)

The cover film on the flame-retardant layer side of the flame-retardant polymer sheet (P-1) obtained in Synthesis Example was peeled to expose the flame-retardant layer. Thus, a flame-retardant polymer sheet (C1) was obtained.

In the resultant flame-retardant polymer sheet (C1), the thickness of the polymer layer (B) was 175 μm and the thickness of the flame-retardant layer (A) was 25 μm.

The polymer sheets of the examples and the comparative example were subjected to the evaluations. Table 1 shows the results.

TABLE l

| | | | Photocatalytic property*³ | |
|---|---|---|---|---|
| | | | Initial | Concentration |
| | | | concen- | after 60 |
| | Flame | Flame-blocking | tration | minutes |
| | retardancy*¹ | property*² | (ppm) | (ppm) |
| Example 1-1 | ◯ | ◯ | 20 | 3 |
| Example 1-2 | ◯ | ◯ | 20 | 4 |
| Comparative | ◯ | ◯ | 20 | 19 |
| Example 1 | | | | |

Each of the photocatalytic flame-retardant polymer sheet (1) obtained in Example 1-1 and the photocatalytic flame-retardant polymer sheet (2) obtained in Example 1-2 has excellent photocatalytic property, and at the same time, has high transparency and a high level of flame retardancy.

### Example 2-1

### Production of Antifouling Flame-Retardant Polymer Sheet (1)

100 Parts by weight of an antifouling paint (fluorine-based resin-containing aqueous top coat, trade name: “Silvia WF-400,” manufactured by NIHON TOKUSHU TORYO CO., LTD.) were applied onto the flame-retardant layer of the flame-retardant polymer sheet (P-1) obtained in Synthesis Example 4, and were then dried at 120° C. for 1 minute to form an antifouling layer (L). Thus, an antifouling flame-retardant polymer sheet (1) was produced.

In the resultant antifouling flame-retardant polymer sheet (1), the thickness of the polymer layer (B) was 175 μm, the thickness of the flame-retardant layer (A) was 25 μm, and the thickness of the antifouling layer (L) was 5 μm.

### Example 2-2

### Production of Antifouling Flame-Retardant Polymer Sheet (2)

100 Parts by weight of an antifouling paint (fluorine-based resin-containing aqueous top coat, trade name: “Silvia WF-400,” manufactured by NIHON TOKUSHU TORYO CO., LTD.) were applied onto the flame-retardant layer of the flame-retardant polymer sheet (P-2) obtained in Synthesis Example 8, and were then dried at 120° C. for 1 minute to form an antifouling layer (L). Thus, an antifouling flame-retardant polymer sheet (2) was produced.

In the resultant antifouling flame-retardant polymer sheet (2), the thickness of the polymer layer (B) was 85 μm, the thickness of the flame-retardant layer (A) was 15 μm, and the thickness of the antifouling layer (L) was 5 μm.

The polymer sheets of the examples and the comparative example were subjected to the evaluations. Table 2 shows the results.

TABLE 2

| | Flame | Flame-blocking | Antifouling |
|---|---|---|---|
| | retardancy*¹ | property*² | property*³ |
| Example 2-1 | ◯ | ◯ | ◯ |
| Example 2-2 | ◯ | ◯ | ◯ |
| Comparative | ◯ | ◯ | X |
| Example 1 | | | |

Each of the antifouling flame-retardant polymer sheet (1) obtained in Example 2-1 and the antifouling flame-retardant polymer sheet (2) obtained in Example 2-2 has excellent antifouling property, and at the same time, has a high level of flame retardancy.

### Example 3-1

### Production of Moisture-Conditioning Flame-Retardant Polymer Sheet (1)

A moisture-conditioning paint (trade name: “Suzukabouro,” manufactured by SUZUKA FINE CO., LTD.) was applied onto the flame-retardant layer of the flame-retardant polymer sheet (P-1) obtained in Synthesis Example 4, and was then dried at 100° C. for 5 minutes to form the moisture-conditioning layer (L). Thus, a moisture-conditioning flame-retardant polymer sheet (1) was produced.

In the resultant moisture-conditioning flame-retardant polymer sheet (1), the thickness of the polymer layer (B) was 175 μm, the thickness of the flame-retardant layer (A) was 25 μm, and the thickness of the moisture-conditioning layer (L) was 10 μm.

### Example 3-2

### Production of Moisture-Conditioning Flame-Retardant Polymer Sheet (2)

A moisture-conditioning paint (trade name: “Suzukabouro,” manufactured by SUZUKA FINE CO., LTD.) was applied onto the flame-retardant layer of the flame-retardant polymer sheet (P-2) obtained in Synthesis Example 8, and was then dried at 100° C. for 5 minutes to form the moisture-conditioning layer (L). Thus, a moisture-conditioning flame-retardant polymer sheet (2) was produced.

In the resultant moisture-conditioning flame-retardant polymer sheet (2), the thickness of the polymer layer (B) was 85 μm, the thickness of the flame-retardant layer (A) was 15 μm, and the thickness of the moisture-conditioning layer (L) was 10 μm.

The polymer sheets of the examples and the comparative example were subjected to the evaluations. Table 3 shows the results.

TABLE 3

| | Flame | Flame-blocking | Moisture-conditioning |
|---|---|---|---|
| | retardancy* | property | property*³ |
| Example 3-1 | ◯ | ◯ | ◯ |
| Example 3-2 | ◯ | ◯ | ◯ |
| Comparative | ◯ | ◯ | X |
| Example 1 | | | |

Each of the moisture-conditioning flame-retardant polymer sheet (1) obtained in Example 3-1 and the moisture-conditioning flame-retardant polymer sheet (2) obtained in Example 3-2 has excellent moisture-conditioning property, and at the same time, has a high level of flame retardancy.

### Example 4-1

### Production of Moisture-Preventing Flame-Retardant Polymer Sheet (1)

A polyvinylidene chloride aqueous dispersion prepared by diluting a polyvinylidene chloride emulsion (trade name: “Saran Latex L536B,” manufactured by Asahi Kasei Chemicals Corporation) with distilled water to 5 wt % was applied onto the flame-retardant layer of the flame-retardant polymer sheet (P-1) obtained in Synthesis Example 4, and was then dried at 130° C. for 5 minutes to form the moisture-preventing layer (L). Thus, a moisture-preventing flame-retardant polymer sheet (1) was produced.

In the resultant moisture-preventing flame-retardant polymer sheet (1), the thickness of the polymer layer (B) was 175 μm, the thickness of the flame-retardant layer (A) was 25 μm, and the thickness of the moisture-preventing layer (L) was 10 μm.

### Example 4-2

### Production of Moisture-Preventing Flame-Retardant Polymer Sheet (2)

A polyvinylidene chloride aqueous dispersion prepared by diluting a polyvinylidene chloride emulsion (trade name: “Saran Latex L536B,” manufactured by Asahi Kasei Chemicals Corporation) with distilled water to 5 wt % was applied onto the flame-retardant layer of the flame-retardant polymer sheet (P-2) obtained in Synthesis Example 8, and was then dried at 130° C. for 5 minutes to form the moisture-preventing layer (L). Thus, a moisture-preventing flame-retardant polymer sheet (2) was produced.

In the resultant moisture-preventing flame-retardant polymer sheet (2), the thickness of the polymer layer (B) was 85 μm, the thickness of the flame-retardant layer (A) was 15 μm, and the thickness of the moisture-preventing layer (L) was 10 μm.

The polymer sheets of the examples and the comparative example were subjected to the evaluations. Table 4 shows the results.

TABLE 4

| | | | Moisture-conditioning |
|---|---|---|---|
| | | | property*³ |
| | | | Water vapor |
| | Flame | Flame-blocking | transmission rate |
| | retardancy*¹ | property*² | (g/m² · day) |
| Example 4-1 | ◯ | ◯ | 10 |
| Example 4-2 | ◯ | ◯ | 12 |
| Comparative | ◯ | ◯ | 50 |
| Example 1 | | | |

Each of the moisture-preventing flame-retardant polymer sheet (1) obtained in Example 4-1 and the moisture-preventing flame-retardant polymer sheet (2) obtained in Example 4-2 has a high level of water vapor barrier property and excellent moisture-preventing property, and at the same time, has a high level of flame retardancy.

### Example 5-1

### Production of Water-Resistant Flame-Retardant Polymer Sheet (1)

A syrup composition obtained by uniformly mixing 100 parts by weight of epoxy acrylate (trade name: “Hitaloid 7851,” manufactured by Hitachi Chemical Company, Ltd.) and 0.5 part by weight of a photopolymerization initiator (trade name: “IRGACURE 819,” manufactured by Ciba Specialty Chemicals Inc.) was applied onto the peel-treated surface of the base material film so that its thickness after curing was 5 μm. Thus, a syrup composition layer was formed. Then, the flame-retardant layer side of the flame-retardant polymer sheet (P-1) obtained in Synthesis Example 4 was attached onto the layer, and then both surfaces of the resultant were simultaneously irradiated with UV light (illuminance: 5 mW/cm²) by using a black-light lamp for 10 minutes. As a result, the layer was cured to form the water-resistant layer (L). Thus, a water-resistant flame-retardant polymer sheet (1) was produced.

In the resultant water-resistant flame-retardant polymer sheet (1), the thickness of the polymer layer (B) was 175 μm, the thickness of the flame-retardant layer (A) was 25 μm, and the thickness of the water-resistant layer (L) was 5 μm.

### Example 5-2

### Production of Water-Resistant Flame-Retardant Polymer Sheet (2)

A syrup composition obtained by uniformly mixing 100 parts by weight of epoxy acrylate (trade name: “Hitaloid 7851,” manufactured by Hitachi Chemical Company, Ltd.) and 0.5 part by weight of a photopolymerization initiator (trade name: “IRGACURE 819,” manufactured by Ciba Specialty Chemicals Inc.) was applied onto the peel-treated surface of the base material film so that its thickness after curing was 5 μm. Thus, a syrup composition layer was formed. Then, the flame-retardant layer side of the flame-retardant polymer sheet (P-2) obtained in Synthesis Example 8 was attached onto the layer, and then both surfaces of the resultant were simultaneously irradiated with UV light (illuminance: 5 mW/cm²) by using a black-light lamp for 10 minutes. As a result, the layer was cured to form the water-resistant layer (L). Thus, a water-resistant flame-retardant polymer sheet (2) was produced.

In the resultant water-resistant flame-retardant polymer sheet (2), the thickness of the polymer layer (B) was 85 μm, the thickness of the flame-retardant layer (A) was 15 μm, and the thickness of the water-resistant layer (L) was 5 μm.

The polymer sheets of the examples and the comparative example were subjected to the evaluations. Table 5 shows the results.

TABLE 5

| | Flame | Flame-blocking | Water |
|---|---|---|---|
| | retardancy*¹ | property*² | resistance*³ |
| Example 5-1 | ◯ | ◯ | ◯ |
| Example 5-2 | ◯ | ◯ | ◯ |
| Comparative | ◯ | ◯ | X |
| Example 1 | | | |

Each of the water-resistant flame-retardant polymer sheet (1) obtained in Example 5-1 and the water-resistant flame-retardant polymer sheet (2) obtained in Example 5-2 has excellent water resistance, and at the same time, a high level of flame retardancy.

### Example 6-1

### Production of Water-Repellent Flame-Retardant Polymer Sheet (1)

A syrup composition obtained by uniformly mixing 95 parts by weight of a polyfunctional acrylate (trade name: “Beam Set 575,” manufactured by ARAKAWA CHEMICAL INDUSTRIES, LTD.), 5 parts by weight of a fluorine-based compound (trade name: “OPTOOL DAC,” manufactured by DAIKIN INDUSTRIES, LTD.), and 0.5 part by weight of a photopolymerization initiator (trade name: “IRGACURE 819,” manufactured by Ciba Specialty Chemicals Inc.) was applied to the peel-treated surface of the base material film so that its thickness after curing was 5 μm. Thus, a syrup composition layer was formed. Then, the flame-retardant layer side of the flame-retardant polymer sheet (P-1) obtained in Synthesis Example 4 was attached onto the layer, and then both surfaces of the resultant were simultaneously irradiated with UV light (illuminance: 5 mW/cm²) by using a black-light lamp for 5 minutes. As a result, the layer was cured to form a water-repellent layer (L). Thus, a water-repellent flame-retardant polymer sheet (1) was produced.

In the resultant water-repellent flame-retardant polymer sheet (1), the thickness of the polymer layer (B) was 175 μm, the thickness of the flame-retardant layer (A) was 25 μm, and the thickness of the water-repellent layer (L) was 5 μm.

### Example 6-2

### Production of Water-Repellent Flame-Retardant Polymer Sheet (2)

A syrup composition obtained by uniformly mixing 95 parts by weight of a polyfunctional acrylate (trade name: “Beam Set 575,” manufactured by ARAKAWA CHEMICAL INDUSTRIES, LTD.), 5 parts by weight of a fluorine-based compound (trade name: “OPTOOL DAC,” manufactured by DAIKIN INDUSTRIES, LTD.), and 0.5 part by weight of a photopolymerization initiator (trade name: “IRGACURE 819,” manufactured by Ciba Specialty Chemicals Inc.) was applied to the peel-treated surface of the base material film so that its thickness after curing was 5 μm. Thus, a syrup composition layer was formed. Then, the flame-retardant layer side of the flame-retardant polymer sheet (P-2) obtained in Synthesis Example 8 was attached onto the layer, and then both surfaces of the resultant were simultaneously irradiated with UV light (illuminance: 5 mW/cm²) by using a black-light lamp for 5 minutes. As a result, the layer was cured to form a water-repellent layer (L). Thus, a water-repellent flame-retardant polymer sheet (2) was produced.

In the resultant water-repellent flame-retardant polymer sheet (2), the thickness of the polymer layer (B) was 85 μm, the thickness of the flame-retardant layer (A) was 15 μm, and the thickness of the water-repellent layer (L) was 5 μm.

The polymer sheets of the examples and the comparative example were subjected to the evaluations. Table 6 shows the results.

TABLE 6

| | Flame | Flame-blocking | Water |
|---|---|---|---|
| | retardancy*¹ | property*² | repellency*³ |
| Example 6-1 | ◯ | ◯ | ⊚ |
| Example 6-2 | ◯ | ◯ | ⊚ |
| Comparative | ◯ | ◯ | X |
| Example 1 | | | |

Each of the water-repellent flame-retardant polymer sheet (1) obtained in Example 6-1 and the water-repellent flame-retardant polymer sheet (2) obtained in Example 6-2 has excellent water repellency, and at the same time, has a high level of flame retardancy.

### Example 7-1

### Production of Hydrophilic Flame-Retardant Polymer Sheet (1))

100 Parts by weight of an inorganic coating agent (manufactured by AGTEX CO., LTD., trade name: “Hydrophilic Coat F,” main component: titanium dioxide/silica/platinum) were applied onto the flame-retardant layer of the flame-retardant polymer sheet (P-1) obtained in Synthesis Example 4, and were then dried at 120° C. for 1 minute to form a hydrophilic layer. Thus, a hydrophilic flame-retardant polymer sheet (1) was produced.

In the resultant hydrophilic flame-retardant polymer sheet (1), the thickness of the polymer layer (B) was 175 μm, the thickness of the flame-retardant layer (A) was 25 μm, and the thickness of the hydrophilic layer (L) was 5 μm.

### Example 7-2

### Production of Hydrophilic Flame-Retardant Polymer Sheet (2)

100 Parts by weight of an inorganic coating agent (manufactured by AGTEX CO., LTD., trade name: “Hydrophilic Coat F,” main component: titanium dioxide/silica/platinum) were applied onto the flame-retardant layer of the flame-retardant polymer sheet (P-2) obtained in Synthesis Example 8, and were then dried at 120° C. for 1 minute to form a hydrophilic layer. Thus, a hydrophilic flame-retardant polymer sheet (2) was produced.

In the resultant hydrophilic flame-retardant polymer sheet (2), the thickness of the polymer layer (B) was 85 μm, the thickness of the flame-retardant layer (A) was 15 μm, and the thickness of the hydrophilic layer (L) was 5 μm.

### Example 7-3

### Production of Hydrophilic Flame-Retardant Polymer Sheet (3)

0.1 Part by weight of a water-soluble organic titanium compound (trade name: “TC310,” manufactured by Matsumoto Pharmaceutical Manufacture Co., Ltd.) was added to 100 parts by weight of an aqueous solution of PVA obtained by dissolving a polyvinyl alcohol (trade name: “PVA205,” manufactured by KURARAY CO., LTD.) in distilled water at 10 wt %, and the mixture was stirred with a DISPER Model disperser (trade name: “TK ROBOMIX,” manufactured by PRIMIX Corporation) at 2,000 rpm for 5 minutes. The uniformly mixed hydrophilic polymer syrup was applied onto the flame-retardant layer of the flame-retardant polymer sheet (P-1) obtained in Synthesis Example 4, and was then dried at 120° C. for 1 minute to form a hydrophilic layer. Thus, a hydrophilic flame-retardant polymer sheet (3) was produced.

In the resultant hydrophilic flame-retardant polymer sheet (3), the thickness of the polymer layer (B) was 175 μm, the thickness of the flame-retardant layer (A) was 25 μm, and the thickness of the hydrophilic layer (L) was 5 μm.

### Example 7-4

### Production of Hydrophilic Flame-Retardant Polymer Sheet (4)

0.1 Part by weight of a water-soluble organic titanium compound (trade name: “TC310,” manufactured by Matsumoto Pharmaceutical Manufacture Co., Ltd.) was added to 100 parts by weight of an aqueous solution of PVA obtained by dissolving a polyvinyl alcohol (trade name: “PVA205,” manufactured by KURARAY CO., LTD.) in distilled water at 10 wt %, and the mixture was stirred with a DISPER Model disperser (trade name: “TK ROBOMIX,” manufactured by PRIMIX Corporation) at 2,000 rpm for 5 minutes. The uniformly mixed hydrophilic polymer syrup was applied onto the flame-retardant layer of the flame-retardant polymer sheet (P-2) obtained in Synthesis Example 8, and was then dried at 120° C. for 1 minute to form a hydrophilic layer. Thus, a hydrophilic flame-retardant polymer sheet (4) was produced.

In the resultant hydrophilic flame-retardant polymer sheet (4), the thickness of the polymer layer (B) was 85 μm, the thickness of the flame-retardant layer (A) was 15 μm, and the thickness of the hydrophilic layer (L) was 5 μm.

The polymer sheets of the examples and the comparative example were subjected to the evaluations. Table 7 shows the results.

TABLE 7

| | Flame | Flame-blocking | |
|---|---|---|---|
| | retardancy*¹ | property*² | Hydrophilicity*³ |
| Example 7-1 | ◯ | ◯ | ⊚ |
| Example 7-2 | ◯ | ◯ | ⊚ |
| Example 7-3 | ◯ | ◯ | ⊚ |
| Example 7-4 | ◯ | ◯ | ⊚ |
| Comparative | ◯ | ◯ | X |
| Example 1 | | | |

Each of the hydrophilic flame-retardant polymer sheets (1) to (4) obtained in Examples 7-1 to 7-4 has excellent hydrophilic property, and at the same time, has a high level of flame retardancy.

### Example 8-1

### Production of Oil-Repellent Flame-Retardant Polymer Sheet (1)

A fluorine-based oil-repellent coating agent obtained by uniformly mixing 10 parts by weight of a fluorine-based oil-repellent agent (trade name: “FS-6130,” manufactured by Fluoro Technology) and 90 parts by weight of distilled water was applied onto the flame-retardant layer side of the flame-retardant polymer sheet (P-1) obtained in Synthesis Example 4 to form the oil-repellent layer (L). Thus, an oil-repellent flame-retardant polymer sheet (1) was produced.

In the resultant oil-repellent flame-retardant polymer sheet (1), the thickness of the polymer layer (B) was 175 μm, the thickness of the flame-retardant layer (A) was 25 μm, and the thickness of the oil-repellent layer (L) was 5 μm.

### Example 8-2

### Production of Oil-Repellent Flame-Retardant Polymer Sheet (2)

A fluorine-based oil-repellent coating agent obtained by uniformly mixing 10 parts by weight of a fluorine-based oil-repellent agent (trade name: “FS-6130,” manufactured by Fluoro Technology) and 90 parts by weight of distilled water was applied onto the flame-retardant layer side of the flame-retardant polymer sheet (P-2) obtained in Synthesis Example 8 to form the oil-repellent layer (L). Thus, an oil-repellent flame-retardant polymer sheet (2) was produced.

In the resultant oil-repellent flame-retardant polymer sheet (2), the thickness of the polymer layer (B) was 85 μm, the thickness of the flame-retardant layer (A) was 15 μm, and the thickness of the oil-repellent layer (L) was 5 μm.

The polymer sheets of the examples and the comparative example were subjected to the evaluations. Table 8 shows the results.

TABLE 8

| | Flame | Flame-blocking | Oil repellency*³ |
|---|---|---|---|
| | retardancy*¹ | property*² | Contact angle (degree) |
| Example 8-1 | ◯ | ◯ | 100 |
| Example 8-2 | ◯ | ◯ | 101 |
| Comparative | ◯ | ◯ | 73 |
| Example 1 | | | |

Each of the oil-repellent flame-retardant polymer sheet (1) obtained in Example 8-1 and the oil-repellent flame-retardant polymer sheet (2) obtained in Example 8-2 has excellent oil repellency, and at the same time, has a high level of flame retardancy.

### Example 9-1

### Production of Antibacterial Flame-Retardant Polymer Sheet (1)

An antibacterial paint containing 5 wt % of a silver ion-based zeolite antibacterial agent (particle diameter distribution: 2 to 5 μm, silver content: 2.5 wt %, zinc content: 14.5 wt %) as an antibacterial agent, 5 wt % of microsilica (average primary particle diameter: 16 nm, specific surface area: 110 m²/g) as an extender pigment, and 90 wt % of a two-component curable urethane resin formed of an acrylic polyol and hexamethylene diisocyanate as a binder was applied onto the flame-retardant layer of the flame-retardant polymer sheet (P-1) obtained in Synthesis Example 4, and was then dried at 80° C. for 5 minutes to form the antibacterial layer (L). Thus, an antibacterial flame-retardant polymer sheet (1) was produced.

In the resultant antibacterial flame-retardant polymer sheet (1), the thickness of the polymer layer (B) was 175 μm, the thickness of the flame-retardant layer (A) was 25 μm, and the thickness of the antibacterial layer (L) was 5 μm.

### Example 9-2

### Production of Antibacterial Flame-Retardant Polymer Sheet (2)

An antibacterial paint containing 5 wt % of a silver ion-based zeolite antibacterial agent (particle diameter distribution: 2 to 5 μm, silver content: 2.5 wt %, zinc content: 14.5 wt %) as an antibacterial agent, 5 wt % of microsilica (average primary particle diameter: 16 nm, specific surface area: 110 m²/g) as an extender pigment, and 90 wt % of a two-component curable urethane resin formed of an acrylic polyol and hexamethylene diisocyanate as a binder was applied onto the flame-retardant layer of the flame-retardant polymer sheet (P-2) obtained in Synthesis Example 8, and was then dried at 80° C. for 5 minutes to form the antibacterial layer (L). Thus, an antibacterial flame-retardant polymer sheet (2) was produced.

In the resultant antibacterial flame-retardant polymer sheet (2), the thickness of the polymer layer (B) was 85 μm, the thickness of the flame-retardant layer (A) was 15 μm, and the thickness of the antibacterial layer (L) was 5 μm.

The polymer sheets of the examples and the comparative example were subjected to the evaluations. Table 9 shows the results.

TABLE 9

| | | | Antibacterial performance*³ | | | |
|---|---|---|---|---|---|---|
| | | | Escherichia coli | | Staphylococcus aureus | |
| | Flame | Flame-blocking | Immediately | After | Immediately | After |
| | retardancy*¹ | property*² | after test | 24 hours | after test | 24 hours |
| Example 9-1 | ∘ | ∘ | 1.2 × 10⁶ | <10 | 1.7 × 10⁵ | <10 |
| Example 9-2 | ∘ | ∘ | 1.2 × 10⁶ | <10 | 1.7 × 10⁵ | <10 |
| Comparative | ∘ | ∘ | 1.2 × 10⁶ | 1.2 × 10⁶ | 1.7 × 10⁵ | 1.2 × 10⁶ |
| Example 1 | | | | | | |

Each of the antibacterial flame-retardant polymer sheet (1) obtained in Example 9-1 and the antibacterial flame-retardant polymer sheet (2) obtained in Example 9-2 has excellent antibacterial property, and at the same time, has a high level of flame retardancy.

### Example 10-1

### Production of Antifungal Flame-Retardant Polymer Sheet (1)

An antifungal paint (acrylic resin emulsion-based paint, trade name: “Biotight #10,” manufactured by SK KAKEN Co., Ltd.) as an antifungal agent was applied onto the flame-retardant layer of the flame-retardant polymer sheet (P-1) obtained in Synthesis Example 4, and was then dried at 80° C. for 5 minutes to form the antifungal layer (L). Thus, an antifungal flame-retardant polymer sheet (1) was produced.

In the resultant antifungal flame-retardant polymer sheet (1), the thickness of the polymer layer (B) was 175 μm, the thickness of the flame-retardant layer (A) was 25 μm, and the thickness of the antifungal layer (L) was 5 μm.

### Example 10-2

### Production of Antifungal Flame-Retardant Polymer Sheet (2)

An antifungal paint (acrylic resin emulsion-based paint, trade name: “Biotight #10,” manufactured by SK KAKEN Co., Ltd.) as an antifungal agent was applied onto the flame-retardant layer of the flame-retardant polymer sheet (P-2) obtained in Synthesis Example 8, and was then dried at 80° C. for 5 minutes to form the antifungal layer (L). Thus, an antifungal flame-retardant polymer sheet (2) was produced.

In the resultant antifungal flame-retardant polymer sheet (2), the thickness of the polymer layer (B) was 85 μm, the thickness of the flame-retardant layer (A) was 15 μm, and the thickness of the antifungal layer (L) was 5 μm.

### Example 10-3

### Production of Antifungal Flame-Retardant Polymer Sheet (3)

An antifungal paint containing 2 wt % of 2-(4-thiazolyl)benzimidazole as an antifungal agent and 98 wt % of a two-component curable urethane resin formed of an acrylic polyol and hexamethylene diisocyanate as a binder was applied onto the flame-retardant layer of the flame-retardant polymer sheet (P-1) obtained in Synthesis Example 4, and was then dried at 80° C. for 5 minutes to form the antifungal layer (L). Thus, an antifungal flame-retardant polymer sheet (3) was produced.

In the resultant antifungal flame-retardant polymer sheet (3), the thickness of the polymer layer (B) was 175 μm, the thickness Of the flame-retardant layer (A) was 25 μm, and the thickness of the antifungal layer (L) was 5 μm.

The polymer sheets of the examples and the comparative example were subjected to the evaluations. Table 10 shows the results.

TABLE 10

| | Flame | Flame-blocking | Antifungal |
|---|---|---|---|
| | retardancy*¹ | property*² | property*³ |
| Example 10-1 | ◯ | ◯ | 3 |
| Example 10-2 | ◯ | ◯ | 3 |
| Example 10-3 | ◯ | ◯ | 3 |
| Comparative | ◯ | ◯ | 4 |
| Example 1 | | | |

Each of the antifungal flame-retardant polymer sheet (1) obtained in Example 10-1, the antifungal flame-retardant polymer sheet (2) obtained in Example 10-2, and the antifungal flame-retardant polymer sheet (3) obtained in Example 10-3 has excellent antifungal property, and at the same time, has a high level of flame retardancy.

### Example 11-1

### Production of Deodorant Flame-Retardant Polymer Sheet (1)

A deodorant paint containing 5 wt % of a silver ion-based zeolite deodorant (particle diameter distribution: 2 to 5 μm, silver content: 2.5 wt %, zinc content: 14.5 wt %) as a deodorant, 5 wt % of microsilica (average primary particle diameter: 16 nm, specific surface area: 110 m²/g) as an extender pigment, and 90 wt % of a two-component curable urethane resin formed of an acrylic polyol and hexamethylene diisocyanate as a binder was applied onto the flame-retardant layer side of the flame-retardant polymer sheet (P-1) obtained in Synthesis Example 4, and was then dried at 130° C. for 1 minute to form the deodorant layer (L). Thus, a deodorant flame-retardant polymer sheet (1) was produced.

In the resultant deodorant flame-retardant polymer sheet (1), the thickness of the polymer layer (B) was 175 μm, the thickness of the flame-retardant layer (A) was 25 μm, and the thickness of the deodorant layer (L) was 5 μm.

### Example 11-2

### Production of Deodorant Flame-Retardant Polymer Sheet (2)

A deodorant paint containing 5 wt % of a silver ion-based zeolite deodorant (particle diameter distribution: 2 to 5 μm, silver content: 2.5 wt %, zinc content: 14.5 wt %) as a deodorant, 5 wt % of microsilica (average primary particle diameter: 16 nm, specific surface area: 110 m²/g) as an extender pigment, and 90 wt % of a two-component curable urethane resin formed of an acrylic polyol and hexamethylene diisocyanate as a binder was applied onto the flame-retardant layer side of the flame-retardant polymer sheet (P-2) obtained in Synthesis Example 8, and was then dried at 130° C. for 1 minute to form the deodorant layer (L). Thus, a deodorant flame-retardant polymer sheet (2) was produced.

In the resultant deodorant flame-retardant polymer sheet (2), the thickness of the polymer layer (B) was 85 μm, the thickness of the flame-retardant layer (A) was 15 μm, and the thickness of the deodorant layer (L) was 5 μm.

The polymer sheets of the examples and the comparative example were subjected to the evaluations. Table 11 shows the results.

TABLE 11

| | | | Deodorant property*³ | |
|---|---|---|---|---|
| | | | Initial | Concentration |
| | | | concen- | after 60 |
| | Flame | Flame-blocking | tration | minutes |
| | retardancy*¹ | property*² | (ppm) | (ppm) |
| Example 11-1 | ◯ | ◯ | 20 | 8 |
| Example 11-2 | ◯ | ◯ | 20 | 9 |
| Comparative | ◯ | ◯ | 20 | 19 |
| Example 1 | | | | |

Each of the deodorant flame-retardant polymer sheet (1) obtained in Example 11-1 and the deodorant flame-retardant polymer sheet (2) obtained in Example 11-2 has excellent deodorant property, and at the same time, has a high level of flame retardancy.

### INDUSTRIAL APPLICABILITY

The environment-resistant functional flame-retardant polymer member and hygienic functional flame-retardant polymer member of the present invention can make various adherends flame-retardant, and at the same time, can impart environment-resistant functionality or hygienic functionality to the various adherends, by being attached to the various adherends.

### REFERENCE SIGNS LIST

A flame-retardant layer
B polymer layer
L environment-resistant functional layer or hygienic functional layer
a polymerizable composition layer
a′ polymerizable composition layer
a1 unevenly distributed polymerizable composition layer
a2 unevenly distributed polymer layer
a11, a21 unevenly distributed portion of layered inorganic compound
a12, a22 non-unevenly distributed portion of layered inorganic compound
b monomer-absorbing layer
b′ polymerizable composition layer
b1 monomer-absorbing layer
b2 cured monomer-absorbing layer
C cover film
D base material film
E monomer-absorbable sheet with base material
X laminate
f immiscible layered inorganic compound
m1 polymerizable monomer
m2 polymerizable monomer
p2 polymer

1. An environment-resistant functional flame-retardant polymer member, comprising a polymer layer (B), a flame-retardant layer (A), and an environment-resistant functional layer (L) in the stated order, wherein the flame-retardant layer (A) comprises a layer containing a layered inorganic compound (f) in a polymer.

2. An environment-resistant functional flame-retardant polymer member according to claim 1, wherein the environment-resistant functional layer (L) has a thickness of 0.1 to 100 μm.

3. An environment-resistant functional flame-retardant polymer member according to claim 1, wherein in a horizontal firing test involving horizontally placing the flame-retardant polymer member with its side of the environment-resistant functional layer (L) as a lower surface so that the lower surface is in contact with air, placing a Bunsen burner so that a flame port of the Bunsen burner is positioned at a lower portion distant from the lower surface on the side of the environment-resistant functional layer (L) by 45 mm, and bringing a flame of the Bunsen burner having a height of 55 mm from the flame port into contact with the lower surface of the environment-resistant functional layer (L) for 30 seconds while preventing the flame from being in contact with an end portion of the flame-retardant polymer member, the flame-retardant polymer member has flame retardancy capable of blocking the flame.

4. An environment-resistant functional flame-retardant polymer member according to claim 1, wherein the environment-resistant functional layer (L) comprises a photocatalyst layer (L).

5. An environment-resistant functional flame-retardant polymer member according to claim 1, wherein the environment-resistant functional layer (L) comprises an antifouling layer (L).

6. An environment-resistant functional flame-retardant polymer member according to claim 1, wherein the environment-resistant functional layer (L) comprises a moisture-conditioning layer (L).

7. An environment-resistant functional flame-retardant polymer member according to claim 1, wherein the environment-resistant functional layer (L) comprises a moisture-preventing layer (L).

8. An environment-resistant functional flame-retardant polymer member according to claim 1, wherein the environment-resistant functional layer (L) comprises a water-resistant layer (L).

9. An environment-resistant functional flame-retardant polymer member according to claim 1, wherein the environment-resistant functional layer (L) comprises a water-repellent layer (L).

10. An environment-resistant functional flame-retardant polymer member according to claim 1, wherein the environment-resistant functional layer (L) comprises a hydrophilic layer (L).

11. An environment-resistant functional flame-retardant polymer member according to claim 1, wherein the environment-resistant functional layer (L) comprises an oil-repellent layer (L).

12. A hygienic functional flame-retardant polymer member, comprising a polymer layer (B), a flame-retardant layer (A), and a hygienic functional layer (L) in the stated order, wherein the flame-retardant layer (A) comprises a layer containing a layered inorganic compound (f) in a polymer.

13. A hygienic functional flame-retardant polymer member according to claim 12, wherein the hygienic functional layer (L) has a thickness of 0.1 to 100 μm.

14. A hygienic functional flame-retardant polymer member according to claim 12, wherein in a horizontal firing test involving horizontally placing the flame-retardant polymer member with its side of the hygienic functional layer (L) as a lower surface so that the lower surface is in contact with air, placing a Bunsen burner so that a flame port of the Bunsen burner is positioned at a lower portion distant from the lower surface on the side of the hygienic functional layer (L) by 45 mm, and bringing a flame of the Bunsen burner having a height of 55 mm from the flame port into contact with the lower surface of the hygienic functional layer (L) for 30 seconds while preventing the flame from being in contact with an end portion of the flame-retardant polymer member, the flame-retardant polymer member has flame retardancy capable of blocking the flame.

15. A hygienic functional flame-retardant polymer member according to claim 12, wherein the hygienic functional layer (L) comprises an antifungal layer (L).

16. A hygienic functional flame-retardant polymer member according to claim 12, wherein the hygienic functional layer (L) comprises an antibacterial layer (L).

17. A hygienic functional flame-retardant polymer member according to claim 12, wherein the hygienic functional layer (L) comprises a deodorant layer (L).
